(19) United States
(12) Patent Application Publication
(10) Pub. No.: US 2005/0254094 A1
(43) Pub. Date: Nov. 17, 2005

(54) Image processing method and program for processing image

(76) Inventors: Yasuhiro Kuwahara, Osaka-shi (JP); Toshiharu Kurosawa, Yokohama-shi (JP)

Correspondence Address: MCDERMOTT WILL & EMERY LLP, 600 13TH STREET, N.W., WASHINGTON, DC, 20005-3096, US

(21) Appl. No.: 10/466,603

(22) PCT Filed: Jan. 22, 2002
(86) PCT No.: PCT/JP02/00440

§ 371 Date: Apr. 7, 2005

(30) Foreign Application Priority Data
Jan. 22, 2001 (JP) 2001-012755
Sep. 19, 2001 (JP) 2001-285469

(51) Int. Cl. H04N 1/405; H04N 1/409; H04N 1/52; H04N 1/58

(52) U.S. Cl. 358/2.1; 358/3.26; 358/3.27; 358/3.05; 358/3.04

(57) ABSTRACT

The invention relates to error distribution processing used for two-valued or multi-valued reproduction on a system recording or displaying a gradation image with several levels. The texture by error distribution processing is suppressed and the granularity of an image is controlled minutely. An accumulation error for the target pixel position is separated into first correction accumulation error and second correction accumulation error, the first correction accumulation error is added to data level of target pixel to generate correction level, multi-valuation level of correction level is determined, difference between correction level and multi-valued level is calculated, multi-valuation error is added to the second correction accumulation error to calculate correction multi-valuation error, error distribution value corresponding to unprocessed pixel adjacent to the target pixel is computed from correction multi-valuation error using a specific distribution coefficient, and the results and the accumulation error are added together to update the accumulation error.

### TECHNICAL FIELD

The present invention relates to an image processing method, image processing apparatus, image processing system, and image processing program for two-valued or multi-valued reproduction in a system recording or displaying a gradation image with several levels.

### BACKGROUND ART

In recent years, with the spread of personal computers, the demand for printers has increase greatly and the print quality has been improved. In the ink jet printer, the full colors used to be each expressed with two values but now have come to be done with three or more values, so that a higher picture quality is obtained. To express multi-gradation with a few recording values, the expression is generally made with quasi-gradation by digital halftone processing, and the dither method or the error diffusion method are often used.

FIG. 53 is a diagram to explain a common error diffusion method. On a density level, that is, a data level for each pixel sampled from the original image (on assumption that the image processing system is a recording system, the error diffusion method will be explained with the density level as the data level), input correction unit Z1 generates a correction level I′xy by adding an accumulation error Sxy to a density level Ixy of the notice pixel. Two valuation unit Z2 compares the correction level I′xy with a specific threshold value Th. If the correction level I′xy is larger than the value Th, an output level Pxy of the two valuation unit Z2 becomes “1,” otherwise, the output becomes “0.” In the description that follows, it is to be understood that the output level “1” is equal to the density level “255,” and the output level “0” is equal to “0.” Differential operation unit Z3 generates a two-valued error Exy, a value obtained by deducting the output level (density level) Pxy from the correction level I′xy. The two-valued error Exy is inputted into error distribution unit Z4. The error distribution unit Z4 distributes the two-valued error on the basis of distribution coefficients of the error, adds the distributed errors to corresponding accumulation errors on error storing unit Z5 and stores the results. FIG. 54 A is a well-known example of distribution coefficients. The figures in the filter of these coefficients represent distribution ratios.

The error diffusion method has excellent characteristics with regard to graduation property and resolving power, and with this method, the occurrence of moire pattern is very low, but the problem is that a peculiar texture is caused. To solve this problem, techniques are proposed in Japanese patent publicized gazettes 6-66873 and 6-81257. The block diagram of the image signal processing apparatus disclosed in Japanese patent publicized gazette 6-66873 is shown in FIG. 55. A big difference between this technique and the error diffusion method described with reference to FIG. 53 is that in the former technique the distribution coefficients of the two-valued error are changed in a specific cycle by distribution coefficient generating unit Z14. The distribution ratios of the two-valued error corresponding to the pixels around the notice pixel are not fixed, and a plurality of distribution coefficients for the positions of the adjacent pixels are selected at random from sets of distribution coefficients along with pixel processing and is utilized, whereby texture observed in the ordinary error diffusion method can be greatly curbed.

The block diagram of the image signal processing apparatus disclosed in Japanese patent publicized gazette 6-81257 is shown in FIG. 56. A big difference between that apparatus and the apparatus disclosed in Japanese patent publicized gazette 6-66873 (FIG. 55) is that the latter is provided with density addition unit Z20. The density addition unit Z20 adds a density level different from the density level of the original image to the density level of each pixel in the original image. That reduces greatly the texture observed in the conventional error diffusion method even on images with small changes in density and on image signals of a uniform density generated by the computer.

In the techniques disclosed in Japanese patent publicized gazettes 6-66873 and 6-81257, the texture can be kept down, while all density levels and images are processed the same way, and the granularity in an area where the processing is usually not needed is raised, and the picture quality will be degraded. Another problem is that that arrangement could not sufficiently curb overlapping of color dots with poor granularity. Still another problem is that in half-tone area, too, the granularity is different from area to area and continuity of the granularity is lacking.

### DISCLOSURE OF INVENTION

This invention adopts the following configuration for solving the aforementioned problems.

In the (first) image processing method of this invention, for representing tone data sampled from an original image in pixels by multi-valued data, an accumulation error for a position of a target pixel is separated into a first correction accumulation error and a second correction accumulation error. A correction level is generated by adding the first correction accumulation error to a data level of the target pixel. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a predetermined distribution coefficient. The error distribution value is added to an accumulation error for a position of the unprocessed pixel to update the accumulation error.

As set forth above, the accumulation error for the target pixel position is separated into first and second correction accumulation errors, and added the first correction accumulation error to the density level of the original image. Then, the data level of the target pixel can be made not larger than the original image when another color dot is presented as long as the error is not accumulated more than a specific value. Therefore, the overlapping of color dots can be kept down, and dots disperse, whereby the granularity will improve.

In the (second) image processing method of this invention, for representing tone data sampled from an original image in pixels by multi-valued data, an accumulation error for a position of a target pixel is separated into a first correction accumulation error and a second correction accumulation error. A correction level is generated by adding the first correction accumulation error to a data level of the target pixel. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error.

In case the distribution coefficients fluctuating, it is possible to keep down occurrence of texture in addition to the effects of the first image processing method.

In the (third) image processing method of this invention, for representing tone data sampled from an original image in pixels by multi-valued data, an input level of a target pixel is obtained by adding a predetermined data level for the target pixel. An accumulation error for a position of the target pixel is separated into a first correction accumulation error and a second correction accumulation error. A correction level is generated by adding the first correction accumulation error to the input level. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error.

As set forth above, since the data level for the target pixel and the predetermined data level are added, it is possible to substantially keep down the texture for an image with small change in density and an image with a uniform density generated by computer in addition to effects of the second image processing method.

In the (fourth) image processing method of this invention, for representing tone data sampled from an original image in pixels by multi-valued data, processing conditions are determined using a data level of a target pixel. An accumulation error for a position of the target pixel is separated into a first correction accumulation error and a second correction accumulation error. A correction level is generated by adding the first correction accumulation error to a data level of the target pixel. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a predetermined distribution coefficient. The error distribution value is added to an accumulation error for a position of the unprocessed pixel to update the accumulation error. Then, in this method, the separation into the first correction accumulation error and the second correction accumulation error is controlled using the processing conditions.

In this case, since the separation into the first correction accumulation error and the second correction accumulation error is controlled using the processing conditions, example detecting a edge (a character/line-drawing area), dots are overstrike in character, line drawing area even if other color dots are present, and therefore the edge sharpness of characters, line drawing increases, and the image quality in the character, line drawing area will improve. Also, the propagation of accumulation error can be prevented and occurrence of unnecessary noise can be kept down.

In the (fifth) image processing method of this invention, for representing tone data sampled from an original image in pixels by multi-valued data, processing conditions are determined using a data level of a target pixel. A correction level is generated by adding an accumulation error for a position of the target pixel to a data level of the target pixel. After a multi-valued level of the correction level is determined, a correction multi-valuation error that is a difference between the correction level and the multi-valued level is computed. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, the distribution coefficient is controlled using the processing conditions.

As set forth above, since the distribution coefficient is controlled using the processing conditions, the granularity of image can be controlled corresponding to an image area.

In the (sixth) image processing method of this invention, for representing tone data sampled from an original image in pixels by multi-valued data, processing conditions are determined using a data level of a target pixel. An accumulation error for a position of the target pixel is separated into a first correction accumulation error and a second correction accumulation error. A correction level is generated by adding the first correction accumulation error to a data level of the target pixel. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, at least one of the separation into the first correction accumulation error and the second correction accumulation error, and the distribution coefficient is controlled using the processing conditions.

As set forth above, the sixth image processing method is possible to obtain the effects of the fifth image processing method in addition to the effects of the fourth image processing method. As the two kinds of the separation of the accumulation error and the distribution coefficient are controlled together, the image quality will improve.

In the (seventh) image processing method of this invention, for representing tone data sampled from an original image in pixels by multi-valued data, processing conditions are determined using a data level of a target pixel. An input level of a target pixel is obtained by adding a predetermined data level for the target pixel. A correction level is generated by adding an accumulation error for a position of the target pixel to the input level. After a multi-valued level of the correction level is determined, a multi-valuation error that is a difference between the correction level and the multi-valued level is computed. An error distribution value for an unprocessed pixel around the target pixel is computed from the multi-valuation error using a predetermined distribution coefficient. The error distribution value is added to an accumulation error for a position of the unprocessed pixel to update the accumulation error. Then, in this method, the predetermined data level is controlled using the processing conditions.

As set forth above, since the data level to be added to the target pixel is controlled using the data level of the target pixel or the pixel around the target pixel, the diffusion of dots can be controlled minutely on the density level of target. Example, the data level can be added only the highlight area or shadow area in which the diffusion of dots is worse.

In the (eighth) image processing method of this invention, for representing tone data sampled from an original image in pixels by multi-valued data, processing conditions are determined using a data level of a target pixel. An input level of the target pixel is obtained by adding a predetermined data level for the target pixel. An accumulation error for a position of the target pixel is separated into a first correction accumulation error and a second correction accumulation error. A correction level is generated by adding the first correction accumulation error to the input level. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a predetermined distribution coefficient. The error distribution value is added to an accumulation error for a position of the unprocessed pixel to update the accumulation error. Then, in this method, at least one of the separation into the first correction accumulation error and the second correction accumulation error, and the predetermined data level is controlled using the processing conditions.

As set forth above, the eighth image processing method is possible to obtain the effects of the fourth image processing method and the seventh image processing apparatus. Then, as the two kinds of the separation of the accumulation error and the data level to be added are controlled together, the image quality will improve.

In the (ninth) image processing method of this invention, for representing tone data sampled from an original image in pixels by multi-valued data, processing conditions are determined using a data level of a target pixel. An input level of a target pixel is obtained by adding a predetermined data level for the target pixel. A correction level is generated by adding an accumulation error for a position of the target pixel to the input level. After a multi-valued level of the correction level is generated, a correction multi-valuation error that is a difference between the correction level and the multi-valued level is computed. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, at least one of the distribution coefficient and the predetermined data level is controlled using the processing conditions.

As set forth above, the ninth image processing method is possible to obtain the effects of the seventh image processing method in addition to the effects of the fifth image processing method. As the distribution coefficient and the data level to be added are controlled together, the image quality will improve.

In the (tenth) image processing method of this invention, for representing tone data sampled from an original image in pixels by multi-valued data, processing conditions are determined using a data level of a target pixel. An input level of the target pixel is obtained by adding a predetermined data level for the target pixel. An accumulation error for a position of the target pixel is separated into a first correction accumulation error and a second correction accumulation error. A correction level is generated by adding the first correction accumulation error to the input level. After a multi-valued level of the correction level is determined, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, at least one of the distribution coefficient, the predetermined data level, and the separation into the first correction accumulation error and the second correction accumulation error is controlled using the processing conditions.

As set forth above, the tenth image processing method is possible to obtain the effects of the forth image processing method, the fifth image processing method, and the seventh image processing method at the same time. As the three kinds of the separation of the accumulation error, the distribution coefficient, and the data level to be added are controlled together, the image quality will improve.

In the (eleventh) image processing method of this invention, for representing tone data sampled from an original image in pixels by multi-valued data, processing conditions are determined using only a data level of a target pixel. A correction level is generated by adding an accumulation error for a position of the target pixel to the data level of the target pixel. After a multi-valued level of the correction level is determined using a fluctuating threshold value, a multi-valuation error that is a difference between the correction level and the multi-valued level is computed. An error distribution value for an unprocessed pixel around the target pixel is computed from the multi-valuation error using a predetermined distribution coefficient. The error distribution value is added to an accumulation error for a position of the unprocessed pixel to update the accumulation error. Then, in this method, the threshold value is generated on the basis of the processing conditions.

As set forth above, since the generation of threshold value using only the data level of the target pixel, processing speed is faster than detecting the image area including the pixel around the target pixel, and it can be obtained an image data in which the delay of dot can be kept down.

In the (twelfth) image processing method of this invention, for representing tone data sampled from an original image in pixels by multi-valued data, processing conditions are determined using a data level of a target pixel. An accumulation error for a position of the target pixel is separated into a first correction accumulation error and a second correction accumulation error. A correction level is generated by adding the first correction accumulation error to the data level of the target pixel. After a multi-valued level of the correction level is determined using a fluctuating threshold value, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a predetermined distribution coefficient. The error distribution value is added to an accumulation error for a position of the unprocessed pixel to update the accumulation error. Then, in this method, the threshold value is generated on the basis of the processing conditions, and the separation into the first correction accumulation error and the second correction accumulation error is controlled using the processing conditions.

As set forth above, the twelfth image processing method is possible to obtain the effects of the eleventh image processing method, in addition to the effects of the fourth image processing method. As the two kinds of the separation of the accumulation error and the generation of the threshold value are controlled together, the image quality will improve.

In the (thirteenth) image processing method of this invention, for representing tone data sampled from an original image in pixels by multi-valued data, processing conditions are determined using a data level of a target pixel. A correction level is generated by adding an accumulation error for a position of the target pixel to the data level of the target pixel. After multi-valued level of the correction level is determined using a fluctuating threshold value, a correction multi-valuation error that is a difference between the correction level and the multi-valued level is computed. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, the threshold value is generated on the basis of the processing conditions, and the distribution coefficient is controlled using the processing conditions.

As set forth above, the thirteenth image processing method is possible to obtain the effects of the eleventh image processing method in addition to the effects of the fifth image processing method. As the two kinds of the distribution coefficient and the generation of the threshold value are controlled together, the image quality will improve.

In the (fourteenth) image processing method of this invention, for representing tone data sampled from an original image in pixels by multi-valued data, processing conditions are determined using a data level of a target pixel. An accumulation error for a position of the target pixel is separated into a first correction accumulation error and a second correction accumulation error. A correction level is generated by adding the first correction accumulation error to the data level of the target pixel. After a multi-valued level of the correction level is determined using a fluctuating threshold value, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, the threshold value is generated on the basis of the processing conditions, and at least one of the distribution coefficient and the separation into the first correction accumulation error and the second correction accumulation error is controlled using the processing conditions.

As set forth above, the fourteenth image processing method is possible to obtain the effects of the eleventh image processing method in addition to the effects of the fourth image processing method and the fifth image processing method. As the three kinds of the separation of the accumulation error, the distribution coefficient, and the generation of the threshold value are controlled together, the image quality will improve.

In the (fifteenth) image processing method of this invention, for representing tone data sampled from an original image in pixels by multi-valued data, processing conditions are determined using a data level of a target pixel. An input level of the target pixel is obtained by adding a predetermined data level for the target pixel. A correction level is generated by adding an accumulation error for a position of the target pixel to the input level. After a multi-valued level of the correction level is determined using a fluctuating threshold value, a multi-valuation error that is a difference between the correction level and the multi-valued level is computed. An error distribution value for an unprocessed pixel around the target pixel is computed from the multi-valuation error using a predetermined distribution coefficient. The error distribution value is added to an accumulation error for a position of the unprocessed pixel to update the accumulation error. Then, in this method, the threshold value is generated on the basis of the processing conditions, and the predetermined data level is controlled using the processing conditions.

As set forth above, the fifteenth image processing method is possible to obtain the effects of the eleventh image processing method in addition to the effects of the seventh image processing method. As the data level to be added to the input level and the generation of the threshold value are controlled together, the image quality will improve.

In the (sixteenth) image processing method of this invention, for representing tone data sampled from an original image in pixels by multi-valued data, processing conditions are determined using a data level of a target pixel. An input level of the target level is obtained by adding a predetermined data level for the target pixel. An accumulation error for a position of the target pixel is separated into a first correction accumulation error and a second correction accumulation error. A correction level is generated by adding the first correction accumulation error to the input level. After a multi-valued level of the correction level is determined using a fluctuating threshold value, a multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a predetermined distribution coefficient. The error distribution value is added to an accumulation error for a position of the unprocessed pixel to update the accumulation error. Then, in this method, the threshold value is generated on the basis of the processing conditions, and at least one of the predetermined data level and the separation into the first correction accumulation error and the second correction accumulation error is controlled using the processing conditions.

As set forth above, the sixteenth image processing method is possible to obtain the effects of the eleventh image processing method in addition to the effects of the fourth image processing method and the seventh image processing method. As the three kinds of the separation of the accumulation error, the data level to be added to the input data level, and the generation of the threshold value are controlled together, the image quality will improve.

In the (seventeenth) image processing method of this invention, for representing tone data sampled from an original image in pixels by multi-valued data, processing conditions are determined using a data level of a target pixel. An input level of the target pixel is obtained by adding a predetermined data level for the target pixel. A correction level is generated by adding an accumulation error for a position of the target pixel to the input level. After a multi-valued level of the correction level is determined using a fluctuating threshold value, a multi-valuation error that is a difference between the correction level and the multi-valued level is computed. An error distribution value for an unprocessed pixel around the target pixel is computed from the multi-valuation error using a distribution coefficient that changes in a specific cycle. The error distribution value is added to an accumulation error for a position of the unprocessed pixel to update the accumulation error. Then, in this method, the threshold value is generated on the basis of the processing conditions, and at least one of the distribution coefficient and the predetermined data level is controlled using the processing conditions.

As set forth above, the seventeenth image processing method is possible to obtain the effects of the eleventh image processing method in addition to the effects of the fifth image processing method and the seventh image processing method. As the three kinds of the distribution coefficient, the data level to be added to the input data level, and the generation of the threshold value are controlled together, the image quality will improve.

In the (eighteenth) image processing method of this invention, for representing tone data sampled from an original image in pixels by multi-valued data, processing conditions are determined using a data level of a target pixel. An input level of the target level is obtained by adding a predetermined data level for the target pixel. An accumulation error for a position of the target pixel is separated into a first correction accumulation error and a second correction accumulation error. A correction level is generated by adding the first correction accumulation error to the input level. After a multi-valued level of the correction level is determined using a fluctuating threshold value. A multi-valuation error that is a difference between the correction level and the multi-valued level is computed. A correction multi-valuation error is computed by adding the second correction accumulation error to the multi-valuation error. An error distribution value for an unprocessed pixel around the target pixel is computed from the correction multi-valuation error using a distribution coefficient that changes in a specific cycle. The error distribution value is added to an accumulation error for a position of the unprocessed pixel to update the accumulation error. Then, in this method, the threshold value is generated on the basis of the processing conditions, and at least one of the distribution coefficient, the predetermined data level, and the separation into the first correction accumulation error and the second correction accumulation error is controlled using the processing conditions.

As set forth above, the eighteenth image processing method is possible to obtain the effects of the eleventh image processing method in addition to the effects of the fourth image processing method, the fifth image processing apparatus, and the seventh image processing method. As the four kinds of the separation of the accumulation error, the distribution coefficient, the data level to be added to the input data level, and the generation of the threshold value are controlled together, the image quality will improve.

In the image processing method of the present invention, as an example, the processing conditions are determined on the basis of results for detecting an area including a highlight area or a shadow area in at least one color data level. Also, the processing conditions can be determined by using only the data level of the target pixel.

The processing conditions can be determined on the basis of results for detecting an area including at least the maximum data level or the minimum data level. In addition, the processing conditions can be determined on the basis of results for detecting an area where the edge quantity of the image area is not smaller than a specific value and an area where the granularity in the image area changes no smaller than a specific value.

Also, the separation into the first correction accumulation error and the second correction accumulation error is controlled by multi-valued data for other color at the same pixel position, as an example.

In case predetermined processing conditions are met, both the first correction accumulation error and the second correction accumulation error for a position of the target pixel may be made 0. In this case, the predetermined processing conditions are that the data level of the target pixel is the maximum data or the minimum data level as an example.

The predetermined cycle of the distribution coefficient may fluctuate according to the processing conditions.

The error distribution value of the distribution coefficient may fluctuate according to the processing conditions.

Also, a filter size of the distribution coefficients may fluctuate according to the processing conditions.

It is possible that the distribution coefficient comes in two kinds, one for the second correction accumulation error and the other for the multi-valuation error.

Also, the data level to be added to the input level may be changed according to color.

The predetermined data level can be added to only a specific data level of the original image on the basis of the processing conditions. In this case, the specific data level is a highlight level that indicates a highlight with regard to at least one color or a shadow level that indicates a shadow with regard to at least one color as an example. The specific data level can be a data level determined on the basis of the degree of change in granularity after multi-valuation.

In a case that the input level is a shadow level that indicates a shadow with regard to at least one color, it is possible to decrease the threshold value of multi-valuation on the basis of the processing conditions. And, in a case that the input level is a highlight level that indicates a highlight with regard to at least one color, it is possible to increase the threshold value of multi-valuation on the basis of the processing conditions.

Also, the threshold value for multi-valuation of a specific data level of the original image may be fluctuated in a specific cycle on the basis of the processing conditions.

In case a threshold value is generated on the basis of the processing conditions, it is possible to differentiate a threshold value in one color from a threshold value in another color.

Also, in the (first) image processing apparatus of this invention, an error storing unit stores a multi-valuation error of a target pixel by relating the multi-valuation error to pixel positions around the target pixel when tone data sampled from an original image by pixels is multi-valuated. An error re-distribution determining unit separates an accumulation error for a position of the target pixel into a first correction accumulation error and a second correction accumulation error. An input correction unit adds an input level that is the data level of the target pixel and the first correction accumulation error together. A multi-valuation unit determines a multi-valued level of a correction level outputted from the input correction unit. A difference operation finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit.

In this way, the accumulation error is separated into the first correction accumulation error and second correction accumulation error according to the error redistribution control signal, and therefore, diffusion of dots can be controlled. Especially when positioning information on dots of other colors is used as the error distribution control signal, overlapping of dots decreases and an image with good granularity can be obtained.

In the (second) image processing apparatus of this invention, the error storing unit stores a multi-valuation error of a target pixel by relating the multi-valuation error to pixel positions around the target pixel when tone data sampled from an original image by pixels is multi-valuated. An error re-distribution determining unit separates an accumulation error for a position of the target pixel into a first correction accumulation error and a second correction accumulation error. An input correction unit adds an input level that is the data level of the target pixel and the first correction accumulation error together. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle.

In this apparatus, the error re-distribution determining unit makes it possible to obtain an image with a good granularity with less overlapping of color dots. In addition, provision of distribution coefficient generating unit can keep down occurrence of texture in image.

In the (third) image processing apparatus of this invention, a data addition unit adds a predetermined data level to a data level of an original image to give an input level of a target pixel when tone data sampled from the original image by pixels is multi-valuated. An error storing unit stores a multi-valuation error of the target pixel by relating the multi-valuation error to pixel positions around the target pixel. An error re-distribution determining unit separates an accumulation error for a position of the target pixel into a first correction accumulation error and a second correction accumulation error. An input correction unit adds the input level and the first correction accumulation error together. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle.

In the third image processing apparatus, provision of data addition unit can substantially keep down the texture on an image with less change in density and an image with a uniform density generated by computer, in addition to the of the second image processing apparatus

Also, on the (fourth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. An error re-distribution determining unit separates an accumulation error for a position of the target pixel into a first correction accumulation error and a second correction accumulation error. An input correction unit adds an input level that is the data level of the target pixel and the first correction accumulation error together. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit. Then, in this apparatus, the separation into the first correction accumulation error and the second correction accumulation error is controlled using the processing conditions.

As set forth above, since the separation into the first correction accumulation error and the second correction accumulation error is controlled using the processing conditions, example processing condition determining unit detects a edge (a character/line-drawing area), dots are overstrike in character, line drawing area even if other color dots are present, and therefore the edge sharpness of characters, line drawing increases, and the image quality in the character, line drawing area will improve. Also, the propagation of accumulation error can be prevented and occurrence of unnecessary noise can be kept down.

In the (fifth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. An input correction unit adds an accumulation error for a position of the target pixel to an input level that is the data level of the target pixel. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle.

As set forth above, since the distribution coefficient is controlled using the processing conditions, the granularity of image can be controlled corresponding to an image area.

In the (sixth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. An error re-distribution determining unit separates an accumulation error for a position of the target pixel into a first correction accumulation error and a second correction accumulation error. An input correction unit adds the first correction accumulation error to an input level that is the data level of the target pixel. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle. Then, in this apparatus, at least one of the separation into the first correction accumulation error and the second correction accumulation error, and the distribution coefficient is controlled using the processing conditions.

As set forth above, the sixth image processing apparatus is possible to obtain the effects of the fifth image processing apparatus in addition to the effects of the fourth image processing apparatus. As the two kinds of the separation of the accumulation error and the distribution coefficient are controlled together, the image quality will improve.

In the (seventh) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds the data level controlled by the processing conditions to the data level of the original image to give an input level of the target pixel. An input correction unit adds an accumulation error for a position of the target pixel to the input level. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit.

As set forth above, when the data level to be added to the target pixel is controlled using the data level of the target pixel or the pixel around the target pixel, the diffusion of dots can be controlled minutely on the density level of target. Example, the data level can be added only the highlight area or shadow area in which the diffusion of dots is worse.

In the (eighth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds a predetermined data level to the data level of the original image to give an input level of the target pixel. An error re-distribution determining unit separates an accumulation error for a position of the target pixel into a first correction accumulation error and a second correction accumulation error. An input correction unit adds the first correction accumulation error to the input level. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the error distribution value being stored in the error storing unit. Then, in this apparatus, at least one of the separation into the first correction accumulation error and the second correction accumulation error, and the predetermined data level to be added by the data addition unit is controlled using the processing conditions.

As set forth above, the eighth image processing apparatus is possible to obtain the effects of the fourth image processing apparatus and the seventh image processing apparatus. Then, as the two kinds of the separation of the accumulation error and the data level to be added are controlled together, the image quality will improve.

In the (ninth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds a predetermined data level to the data level of the original image to give an input level of the target pixel. An input correction unit adds the accumulation error for a position of the target pixel to the input level. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, the accumulation error being stored in the error storing unit. A distribution coefficient generating unit generates the distribution coefficient used by the error distribution update unit while changing the distribution coefficient in a predetermined cycle. Then, in this apparatus, at least one of the distribution coefficient and the predetermined data level to be added by the data addition unit is controlled using the processing conditions.

As set forth above, the ninth image processing apparatus is possible to obtain the effects of the seventh image processing apparatus in addition to the effects of the fifth image processing apparatus. As the distribution coefficient and the data level to be added are controlled together, the image quality will improve.

In the (tenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds a predetermined data level to the data level of the original image to give an input level of the target pixel. An error re-distribution determining unit separates an accumulation error for a position of the target pixel into a first correction accumulation error and a second correction accumulation error. An input correction unit adds the first correction accumulation error to the input level. A multi-valuation unit determines a multi-valued level of a correction level outputted from the input correction unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle. Then, in this apparatus, at least one of the separation into the first correction accumulation error and the second correction accumulation error, the predetermined data level to be added by the data addition unit, and the distribution coefficient is controlled using the processing conditions.

As set forth above, the tenth image processing apparatus is possible to obtain the effects of the forth image processing apparatus, the fifth image processing apparatus, and the seventh image processing apparatus at the same time. As the three kinds of the separation of the accumulation error, the distribution coefficient, and the data level to be added are controlled together, the image quality will improve.

In the (eleventh) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using only the data level of the target pixel. An input correction unit adds an accumulation error for a position of the target pixel to an input level that is the data level of the target pixel. A threshold value generating unit generates a threshold value for a multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit.

As set forth above, since the generation of threshold value using only the data level of the target pixel, processing speed is faster than detecting the image area including the pixel around the target pixel, and it can be obtained an image data in which the delay of dot can be kept down.

In the (twelfth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. An error re-distribution determining unit separates an accumulation error for a position of the target pixel into a first correction accumulation error and a second correction accumulation error. An input correction unit adds the first correction accumulation error to an input level that is the data level of the target pixel. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit. Then, in this apparatus, the separation into the first correction accumulation error and the second correction accumulation error is controlled using the processing conditions.

As set forth above, the twelfth image processing apparatus is possible to obtain the effects of the eleventh image processing apparatus, in addition to the effects of the fourth image processing apparatus. As the two kinds of the separation of the accumulation error and the generation of the threshold value are controlled together, the image quality will improve.

In the (thirteenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. An input correction unit adds an accumulation error for a position of the target pixel to an input level that is the data level of the target pixel. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle. Then, in this apparatus, the distribution coefficient is controlled using the processing conditions.

As set forth above, the thirteenth image processing apparatus is possible to obtain the effects of the eleventh image processing apparatus in addition to the effects of the fifth image processing apparatus. As the two kinds of the distribution coefficient and the generation of the threshold value are controlled together, the image quality will improve.

In the (fourteenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. An error re-distribution determining unit separates an accumulation error for a position of the target pixel into a first correction accumulation error and a second correction accumulation error. An input correction unit adds the first correction accumulation error to an input level that is the data level of the target pixel. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle. Then, in this apparatus, at least one of the separation into the first correction accumulation error and the second correction accumulation error, and the distribution coefficient is controlled using the processing conditions.

As set forth above, the fourteenth image processing apparatus is possible to obtain the effects of the eleventh image processing apparatus in addition to the effects of the fourth image processing apparatus and the fifth image processing apparatus. As the three kinds of the separation of the accumulation error, the distribution coefficient, and the generation of the threshold value are controlled together, the image quality will improve.

In the (fifteenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds the data level controlled by the processing conditions to the data level of the original image to give an input level of the target pixel. An input correction unit adds an accumulation error for a position of the target pixel to the input level. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit.

As set forth above, the fifteenth image processing apparatus is possible to obtain the effects of the eleventh image processing apparatus in addition to the effects of the seventh image processing apparatus. As the data level to be added to the input level and the generation of the threshold value are controlled together, the image quality will improve.

In the (sixteenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds a predetermined data level to the data level of the original image to give an input level of the target pixel. An error re-distribution determining unit separates an accumulation error for a position of the target pixel into a first correction accumulation error and a second correction accumulation error. An input correction unit adds the first correction accumulation error to the input level. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error and the second correction accumulation error using a distribution coefficient, and adds the error distribution value to the accumulation error for a position of the unprocessed pixel, with the accumulation error being stored in the error storing unit. Then, in this apparatus, at least one of the predetermined data level to be added by the data addition unit, and the separation into the first correction accumulation error and the second correction accumulation error is controlled using the processing conditions.

As set forth above, the sixteenth image processing apparatus is possible to obtain the effects of the eleventh image processing apparatus in addition to the effects of the fourth image processing apparatus and the seventh image processing apparatus. As the three kinds of the separation of the accumulation error, the data level to be added to the input data level, and the generation of the threshold value are controlled together, the image quality will improve.

In the (seventeenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds a predetermined data level to the data level of the original image to give an input level of the target pixel. An input correction unit adds an accumulation error for a position of the target pixel to the input level. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle. Then, in this apparatus, at least one of the predetermined data level to be added by the data addition unit and the distribution coefficient is controlled using the processing conditions.

As set forth above, the seventeenth image processing apparatus is possible to obtain the effects of the eleventh image processing apparatus in addition to the effects of the fifth image processing apparatus and the seventh image processing apparatus. As the three kinds of the distribution coefficient, the data level to be added to the input data level, and the generation of the threshold value are controlled together, the image quality will improve.

In the (eighteenth) image processing apparatus of this invention, an error storing unit stores a multi-valuation error of a target pixel by relating the multi-valuation error to pixel positions around the target pixel when tone data sampled from an original image by pixels is multi-valuated. A processing conditions determining unit determines processing conditions using the data level of the target pixel. A data addition unit adds a predetermined data level to the data level of the original image to give an input level of the target pixel. An error re-distribution determining unit separates an accumulation error for a position of the target pixel into a first correction accumulation error and a second correction accumulation error. An input correction unit adds the first correction accumulation error to the input level. A threshold value generating unit generates a threshold value for multi-valuation using the processing conditions. A multi-valuation unit determines a multi-valued level of a correction level outputted from the input correction unit using the threshold value outputted from the threshold value generating unit. A difference operation unit finds the multi-valuation error that is the difference between the correction level and the multi-valued level. An error distribution update unit updates an accumulation error by computing an error distribution value for an unprocessed pixel around the target pixel from the multi-valuation error using a distribution coefficient, and adds the error distribution value to the accumulation error for a position of the unprocessed pixel, with the accumulation error being stored in the error storing unit. A distribution coefficient generating unit generates the distribution coefficient used by the error distribution update unit while changing the distribution coefficient in a predetermined cycle. Then, in this apparatus, at least one of the separation into the first correction accumulation error and the second correction accumulation error, the predetermined data level to be added by the data addition unit and the distribution coefficient is controlled using the processing conditions.

As set forth above, the eighteenth image processing apparatus is possible to obtain the effects of the eleventh image processing apparatus in addition to the effects of the fourth image processing apparatus, the fifth image processing apparatus, and the seventh image processing apparatus. As the four kinds of the separation of the accumulation error, the distribution coefficient, the data level to be added to the input data level, and the generation of the threshold value are controlled together, the image quality will improve.

In the image processing apparatus of the present invention, the processing conditions determining unit detects, as an example, an area including a highlight area or a shadow area in at least one color data level, and determines the processing conditions on the basis of the detection results. The processing conditions determining unit may determine the processing conditions by using only the data level of the target pixel.

Also, the processing conditions determining unit may detect an area including at least the maximum data level or the minimum data level and determine the processing conditions on the basis of the detection results. In addition, the processing conditions determining unit may detect an area where the edge quantity of the image area is not smaller than a specific value, and determine the processing conditions on the basis of the detection results. And the processing conditions determining unit may detect an area where the granularity in the image area changes no smaller than a specific value, and determines the processing conditions on the basis of the detection results.

The error re-distribution determining unit uses multi-valued data in the separation for other color at the same pixel position as an example. In case predetermined processing conditions are met, error re-distribution determining unit may make both the first correction accumulation error and the second correction accumulation error for a position of the target pixel 0. In this case, the predetermined processing conditions are that the data level of the target pixel is the maximum data or the minimum data level.

The predetermined cycle of the distribution coefficient may fluctuate according to the processing conditions.

The error distribution value of the distribution coefficient may fluctuate according to the processing conditions, too.

Also, a filter size of the distribution coefficients may fluctuate according to the processing conditions.

It is possible that the distribution coefficient to be outputted from the distribution coefficient generating unit comes in two kinds, one for the second correction accumulation error and the other for the multi-valuation error.

The data addition unit changes the data level to be added according to color.

The data addition unit may add the data level to only a specific data level of the original image on the basis of the processing conditions. In this case, the specific data level is a highlight level that indicates a highlight with regard to at least one color or a shadow level that indicates a shadow with regard to at least one color as an example.

Also, the specific data level can be a data level determined on the basis of the degree of change in granularity after multi-valuation.

In a case that the input level is a shadow level that indicates a shadow with regard to at least one color, the threshold value generating unit may decrease the threshold value of multi-valuation on the basis of the processing conditions. And, in a case that the input level is a highlight level that indicates a highlight with regard to at least one color, the threshold value generating unit may increase the threshold value of multi-valuation on the basis of the processing conditions.

Also, the threshold value generating unit may fluctuate the threshold value for multi-valuation of a specific data level of the original image in a specific cycle on the basis of the processing conditions. In case a threshold value is generated on the basis of the processing conditions, the threshold value generating unit can differentiate a threshold value in one color from a threshold value in another color.

Also, the present invention provides not only the image processing method or the image processing apparatus but also an image processing system or an image processing program.

In the image processing system, the same function of the image processing apparatus can be obtained in cooperation with plural units comprised in the system.

Also, the image processing program makes a computer or a computer system operate as the image processing apparatus or the image processing system. It is possible to obtain the same function of the image processing apparatus or the image processing system by the image processing program cooperating with hardware of the computer or the computer system.

### BRIEF DESCRIPTION OF DRAWINGS

FIG. 1 is a block diagram of an image processing apparatus in the first embodiment according to the present invention.

FIG. 2 is a block diagram of a color image processing apparatus.

FIG. 3 is a block diagram of a first error distribution determining circuit, an example of an error re-distribution determining unit.

FIG. 4 is a block diagram of a first error distribution update circuit, an example of error distribution update unit.

FIG. 5 is a block diagram of an image processing apparatus in the second embodiment according to the present invention.

FIG. 6 is a block diagram of a first distribution coefficient generating circuit, an embodiment of distribution coefficient generating unit.

FIG. 7 is a block diagram of an image processing apparatus in the third embodiment according to the present invention.

FIG. 8 is a block diagram of a first data addition circuit, an example of data addition unit.

FIG. 9 is a block diagram of an image processing apparatus in the fourth embodiment of the present invention.

FIG. 10 is diagram showing a processing condition determining circuit A, an example of processing condition determining unit.

FIG. 11 is processing condition determining circuit B, an example of processing condition determining unit.

FIG. 12 is a diagram showing a processing condition determining circuit C, an example of processing condition determining unit.

FIG. 13 is a diagram showing processing condition determining circuit D, an example of processing condition determining unit.

FIG. 14 is a diagram showing image area determining circuit, an example of image area determining unit.

FIG. 15 is diagram showing a second error distribution determining circuit, an example of error re-distribution determining unit.

FIG. 16 is a block diagram of an image processing apparatus in the fifth embodiment according to the present invention.

FIG. 17 is a block diagram of second distribution coefficient generating circuit, an example of distribution coefficient generating unit.

FIG. 18 is a block diagram of an image processing apparatus in the sixth embodiment according to the present invention.

FIG. 19 is a block diagram of an image processing apparatus in the seventh embodiment according to the present invention.

FIG. 20 is a block diagram of a second data addition circuit, an example of data addition unit.

FIG. 21 is a block diagram of an image processing apparatus in the eighth embodiment according to the present invention.

FIG. 22 is a block diagram of an image processing apparatus in the ninth embodiment according to the present invention.

FIG. 23 is a block diagram of an image processing apparatus in the tenth embodiment according to the present invention.

FIG. 24 is a block diagram of an image processing apparatus in the eleventh embodiment according to the present invention.

FIG. 25 is a block diagram of a threshold value generating circuit, an example of threshold value generating unit.

FIG. 26 is an explanatory diagram of threshold values.

FIG. 27 is a block diagram of an image processing apparatus in the twelfth embodiment according to the present invention.

FIG. 28 is a block diagram of an image processing apparatus in the thirteenth embodiment according to the present invention.

FIG. 29 is a block diagram of an image processing apparatus in the fourteenth embodiment according to the present invention.

FIG. 30 is a block diagram of an image processing apparatus in the fifteenth embodiment according to the present invention.

FIG. 31 is a block diagram of an image processing apparatus in the sixteenth embodiment according to the present invention.

FIG. 32 is a block diagram of an image processing apparatus in the seventeenth embodiment according to the present invention.

FIG. 33 is a block diagram of an image processing apparatus in the eighteenth embodiment according to the present invention.

FIG. 34 is a block diagram of an MPU system.

FIG. 35 is a flow chart of an image processing method in the nineteenth embodiment according to the present invention.

FIG. 36 is a flow chart of an image processing method in the twentieth embodiment according to the present invention.

FIG. 37 is a flow chart of an image processing method in the twenty-first embodiment according to the present invention.

FIG. 38 is a flow chart of an image processing method in the twenty-second embodiment according to the present invention.

FIG. 39 is a flow chart of an image processing method in the twenty-third embodiment according to the present invention.

FIG. 40 is a flow chart of an image processing method in the twenty-fourth embodiment according to the present invention.

FIG. 41 is a flow chart of an image processing method in the twenty-fifth embodiment according to the present invention.

FIG. 42 is a flow chart of an image processing method in the twenty-sixth embodiment according to the present invention.

FIG. 43 is a flow chart of an image processing method in the twenty-seventh embodiment according to the present invention.

FIG. 44 is a flow chart of an image processing method in the twenty-eighth embodiment according to the present invention.

FIG. 45 is a flow chart of an image processing method in the twenty-ninth embodiment according to the present invention.

FIG. 46 is a flow chart of an image processing method in the thirtieth embodiment according to the present invention.

FIG. 47 is a flow chart of an image processing method in the thirty-first embodiment according to the present invention.

FIG. 48 is a flow chart of an image processing method in the thirty-second embodiment according to the present invention.

FIG. 49 is a flow chart of an image processing method in the thirty-third embodiment according to the present invention.

FIG. 50 is a flow chart of an image processing method in thirty-fourth embodiment according to the present invention.

FIG. 51 is a flow chart of an image processing method in the thirty-fifth embodiment according to the present invention.

FIG. 52 is a flow chart of an image processing method in the thirty-sixth embodiment according to the present invention.

FIG. 53 is a block diagram of the prior art error diffusion processing apparatus.

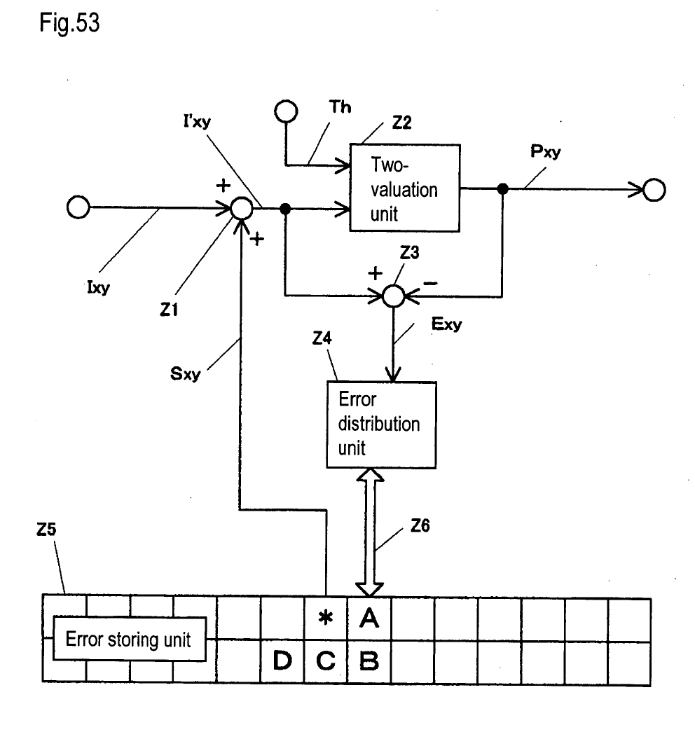

FIG. 54 is an explanatory diagram of distribution coefficient of error.

FIG. 55 is a block diagram of a prior art image signal processing apparatus.

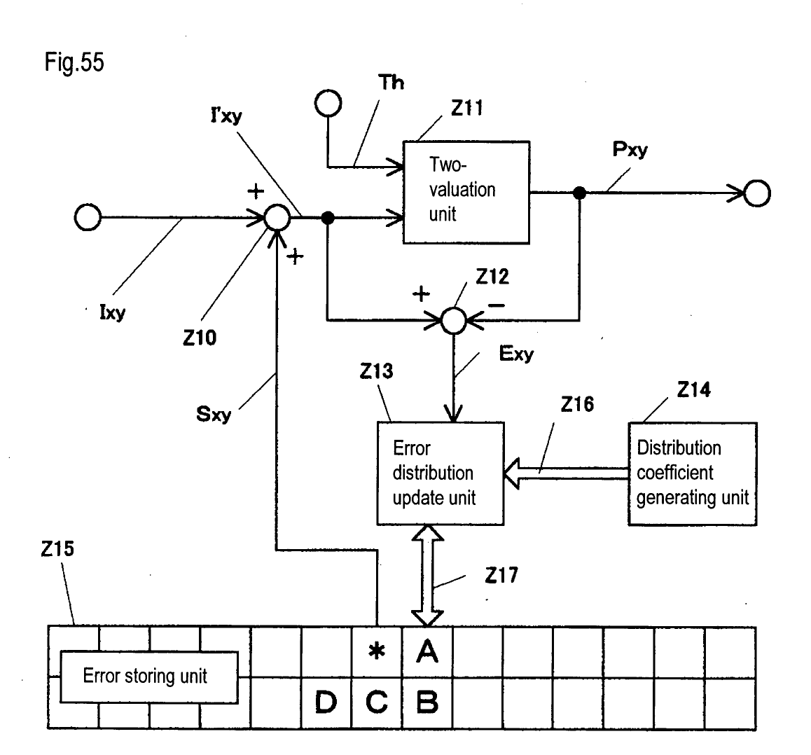

FIG. 56 is a block diagram of another prior art image signal processing apparatus.

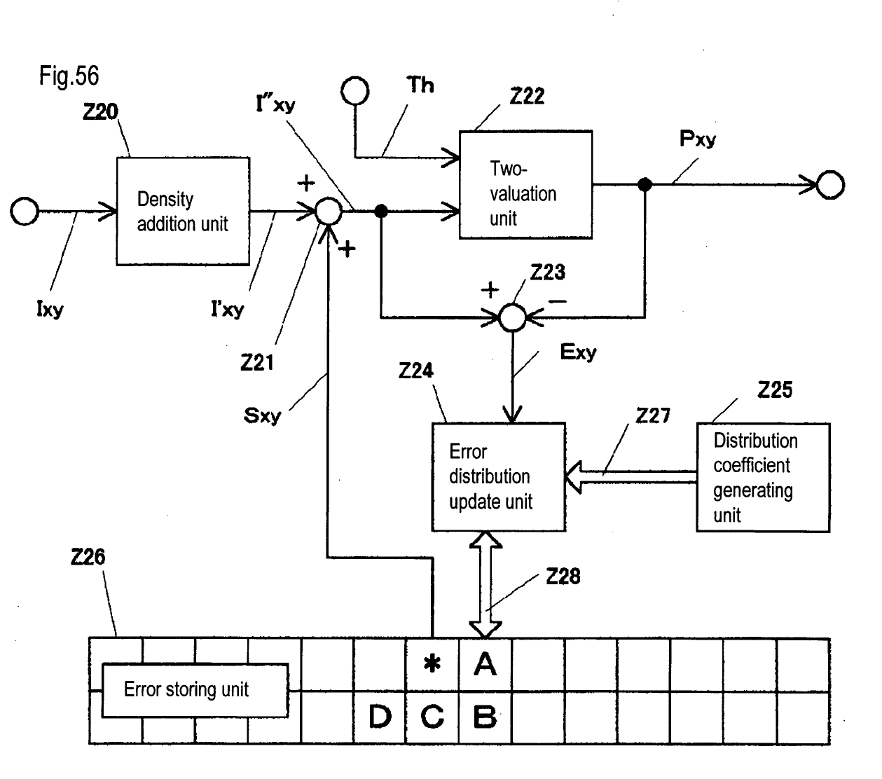

### BEST MODE FOR CARRYING OUT THE INVENTION

Now, the embodiments of the present invention will be described with reference to the drawings. The embodiments will be described with the case of a recording system shown and with data level as density level.

### First Embodiment

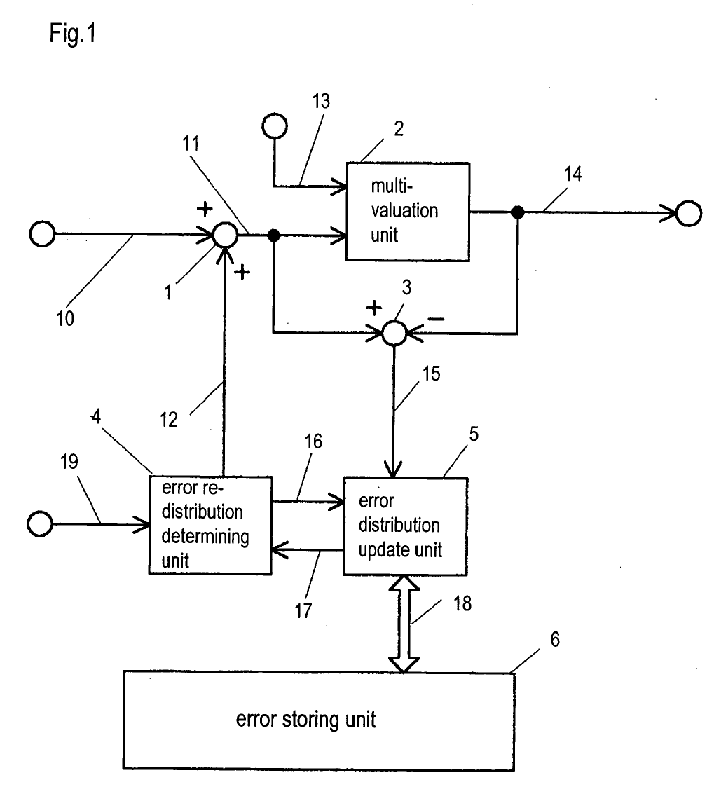

FIG. 1 is a block diagram of an image processing apparatus in the first embodiment according to the present invention. The image processing apparatus shown in FIG. 1 comprises input correction unit 1, multi-valuation unit 2, difference operation unit 3, error re-distribution determining unit 4, error distribution update unit 5 and error storing unit 6.

Error re-distribution determining unit 4 separates accumulation error 17 for the target pixel position into first correction accumulation error 12 and second correction accumulation error 16 according to error distribution control signal 19. Input correction unit 1 first adds first correction accumulation error 12 outputted from error re-distribution determining unit 4 to tone density level 10 of each pixel which is sampled from the original image and generates correction level 11. Multi-valuation unit 2 compares correction level 11 and a plurality of threshold values 13 and outputs multi-valued data 14. Difference operation unit 3 calculates multi-valuation error 15 from correction level 11 and multi-valued data 14. Error distribution update unit 5 distributes the sum of multi-valuation error 15 and second correction accumulation error 16 according to a specific distribution coefficients (distribution ratio), and adds each distributed error to the respective accumulation error 18 at the pixel position for each unprocessed pixel adjacent to a target pixel stored in error storing unit 6 (or stored in error distribution update unit 5) and updates the accumulation error.

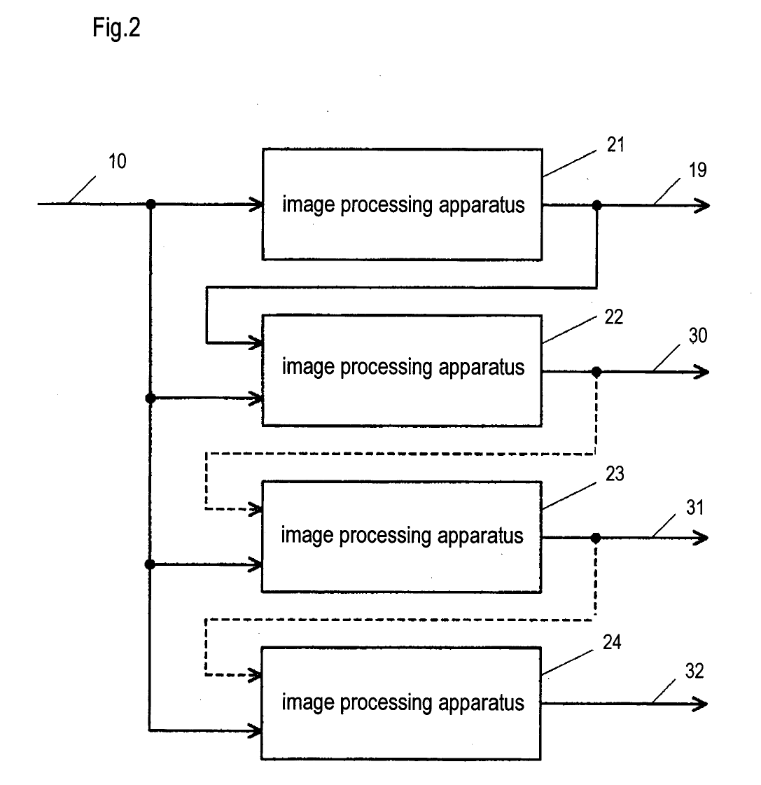

FIG. 2 indicates the structure of the color image processing device in the simplified manner. The color signal is comprised of density level 10 of tone for respective colors of C (cyan), M (magenta), Y (yellow) and K (black). The color image processing device has four image processing devices 21-24 for respective colors, and density level 10 of each color is inputted to the corresponding image processing devices. The respective image processing devices 21-24 output multi-valued data of density level 10 as signals 19, 30, 31 and 32. In FIG. 2, the signal 19 outputted from image processing device 21 is also inputted to the image processing device 22 as an error re-distribution control signal. This indicates that the present invention is applied to the image processing device 22 among the image processing devices 21-24. The present invention, however, can be applied to the other image processing devices. For example, in order to apply the present invention to the image processing devices 23 and 24, as shown by the broken line in FIG. 2, the signals 30 and 31 outputted from the image processing devices 22 and 23 may be inputted to the image processing devices 23 and 24 respectively as error re-distribution control signals.

The reason to use multi-valued data of other colors outputted from the image processing device 21 for error re-distribution control signal 19 corresponding to the image processing device 22 is that the granularity becomes finer and the image quality is more improved in case a dot of other color is not laid to the notice pixel position than other color dot is laid. In order to attain a high quality image, an accumulation error corresponding to the notice pixel position is not added to density level of the notice pixel, but multi-valuation is conducted only in the density level of the original image, which prevents a dot from being laid to the same position.

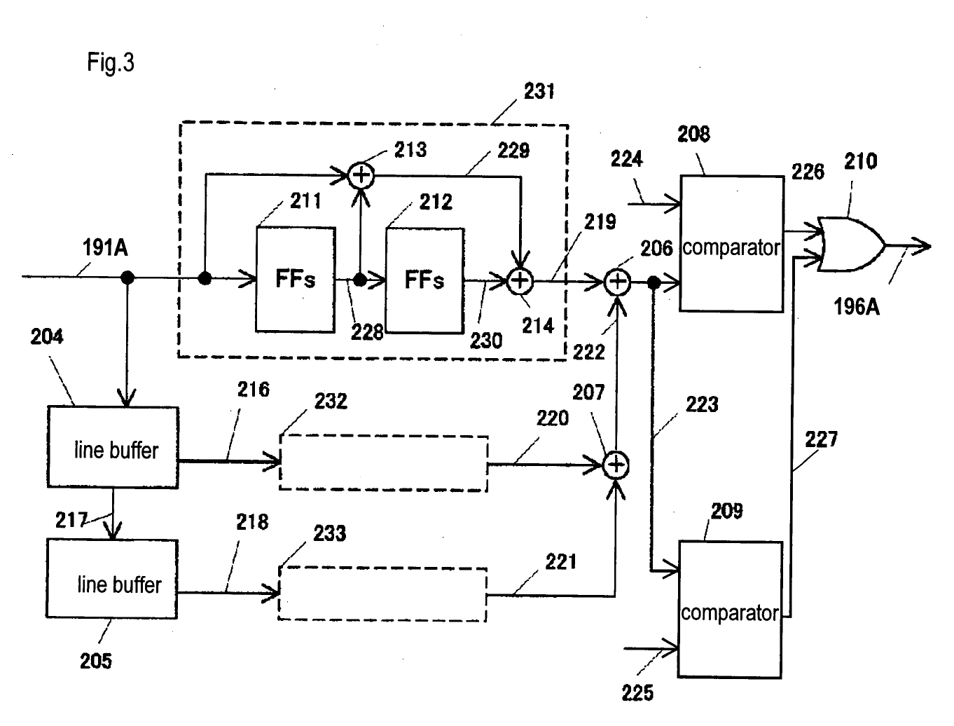

Color for separating an accumulation error into the first correction accumulation error and the second correction accumulation error by using error re-distribution control signal 19 could be one color. Also, here, error re-distribution control signal 19 explains as a signal indicating whether other color dot exists or not, but it is not limited to the foregoing. FIG. 3 is a block diagram of a first error distribution value determination circuit that is an example of error re-distribution determining unit 4. The error distribution determining circuit is made up of comparators 41, 42, logic element 43, selectors 44, 45. Accumulation error 17 for the target pixel position is first inputted into comparators 41, 42. In comparator 41, a comparison is made with specific value 46. The specific value 46 is density level “0”, for example. In addition, accumulation error 17 is compared with specific value 47 by comparator 42. Specific value 47 is density level “128”, for example. If accumulation error 17 is larger than specific threshold 46, comparator 41 makes signal line 48 a high level. If accumulation error 17 is smaller than specific value 47, comparator 42 makes signal line 49 a high level. That is, these output signals 48 and 49 judge whether accumulation error 17 is within a specific scope (larger than specific value 46 and smaller than specific value 47).

Only when error distribution control signal 19 is at a high level (indicates that a dot of another color is stricken) and the outputs of comparators 48 and 49 are at a high level, logical element 43 sets signal line 50 at a high level. Selector 44 outputs specific value 51 when signal line 50 is at a high level, and outputs accumulation error 17 when signal 50 is at a low level. That is, when another dot is stricken at the target pixel position, and when the accumulation error for the pixel position is within a specific range, specific value 51 (“0” for example) is outputted instead of accumulation error 17. That can reduce the overlapping ratio of color dots. The value outputted from selector 44 becomes first correction accumulation error 12. On the other hand, selector 45 outputs accumulation error 17 when signal line 50 is at a high level and outputs specific value 52 (“0” for example) when signal line 50 is at a low level. The value outputted from selector 45 becomes second correction accumulation error 16.

In the present example, specific values are fixed values 46, 47, but may be fluctuated depending on or density level at or around the target pixel.

The present embodiment is so configured that either accumulation error 17 or specific value “0” is selected as first correction accumulation error 12 and second correction accumulation error. But it is not limited to this method, but it may be so configured that the distribution ratio is changed depending on selection signals.

Input correction unit 1 may be formed of adders, and multi-valuation unit 2 is formed of a plurality of comparators and selectors. And also difference operation unit 3 can be formed of a difference device (not shown). A well known method may be used. Also as error storing unit 6, RAM (random access memory) or line buffer may be used.

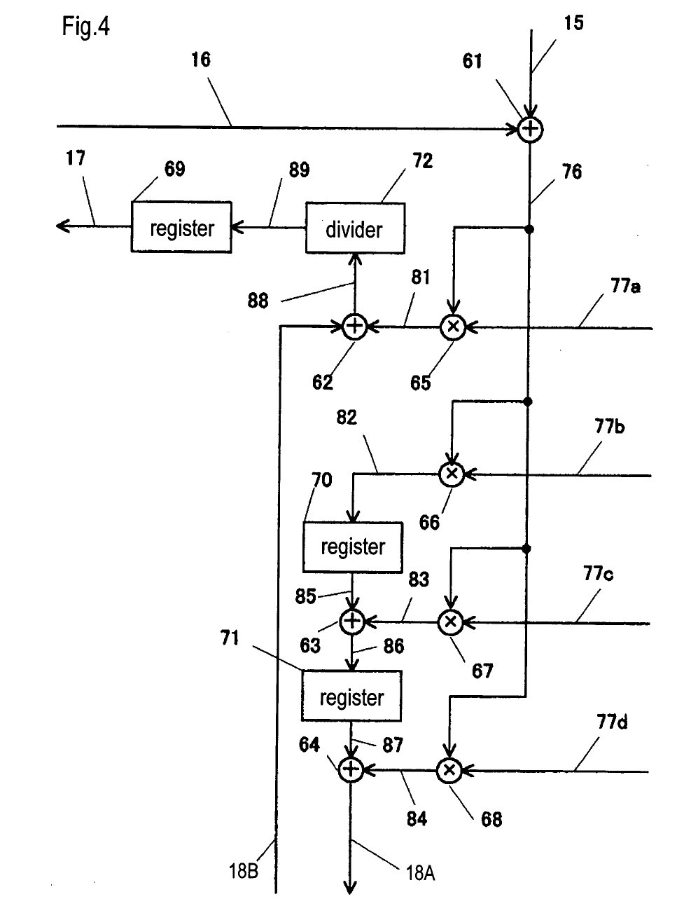

FIG. 4 is a block diagram of a first error distribution update circuit, an example of error distribution update unit 5. The first error distribution update circuit comprises adders 61 to 64, multipliers 65 to 68, register 69-71 and divider 72.

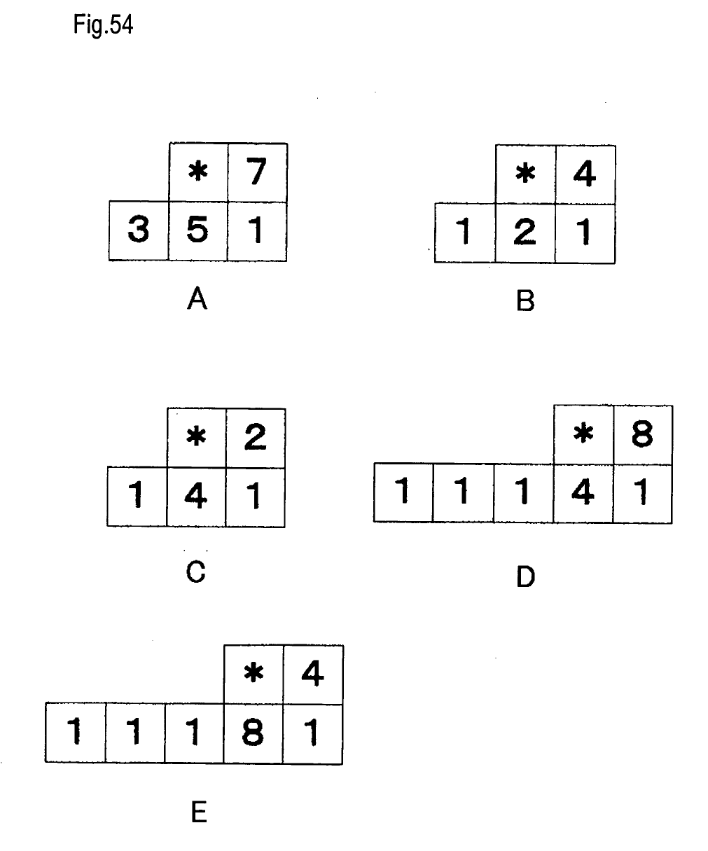

Adder 61 obtains a correction multi-valued error 76 by adding second correction accumulation error 16 outputted from error re-distribution determining unit 4 and multi-valued error 15 outputted from difference operation unit 3. The correction multi-valued error 76 is multiplied by the respective values 77a to 77d in multipliers 65 to 68. As specific values 77a to 77d, the distribution coefficients shown in FIG. 54A may be used. That is, specific value 77a is a value “7”; specific value 77b is a value “1”; specific value 77c is a value “5”; specific value 77d is a value “3.” Distribution error 82 generated by multiplier 66 is stored in register 70. The register synchronizes with the sampling of the pixel and stores data. That is, from register 70, the multiplication result of the preceding image is outputted from register 70. Adder 63 adds distribution error 85 of the previous pixel and distribution error 83 outputted from multiplier 67 and then outputs the result to register 71. Similarly, register 71 delays data for one pixel. The signal outputted from adder 64 becomes accumulation error 18a, that is, an accumulation of accumulation errors distributed to the pixels located lower than the target pixel, and stored in error storing unit 6.

Adder 62 adds together accumulation error 18B one line before and distribution error 81 of target pixel. The addition result is inputted into divider 72 and divided by a specific value. The specific value to be used is a value obtained by adding all distribution coefficients together. In the present example, the distribution coefficients shown in FIG. 54A is used and divided by a value “16.” To simplify the circuit, the division of addition result 88 may be executed with 4 bit shift. Division result 89 is stored in register 69 and is outputted as final accumulation error 17 in the next pixel processing.

In present example, second correction accumulation error 16 and multi-valuation error 15 are added together and the result is distributed according to the distribution coefficients. Instead, the results may be distributed according to different distribution coefficients respectively.

As described, the accumulation error is separated into the first correction accumulation error and second correction accumulation error according to the error redistribution control signal, and therefore, an image with good granularity can be obtained. Especially when positioning information on dots of other colors is used as the error distribution control signal, overlapping of dots decreases and an image with good granularity can be obtained.

### Second Embodiment

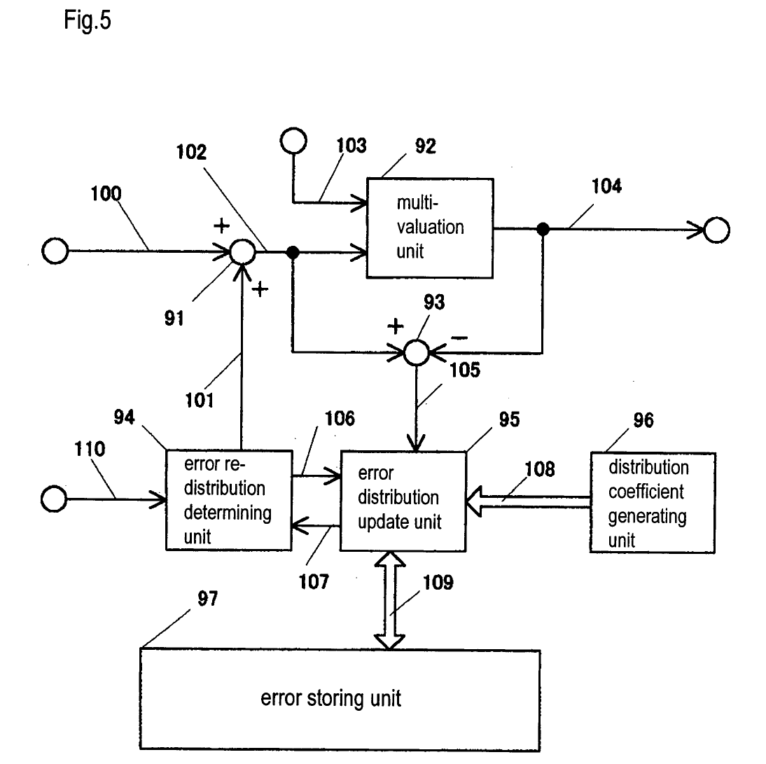

FIG. 5 is a block diagram of an image processing apparatus in the second embodiment according to the present invention. The image processing apparatus shown in FIG. 5 is made up of input correction unit 91, multi-valuation mean 92, difference operation unit 93, error re-distribution determining unit 94, error distribution update unit 95, distribution coefficient generating unit 96 and error storing unit 97.

Error re-distribution determining unit 94 separates accumulation error 107 for the target pixel position into first correction accumulation error 101 and second correction accumulation error 106 according to error distribution control signal 110. Input correction unit 91 adds first correction accumulation error 101 outputted from error re-distribution determining unit 94 to tone density level 100 of each pixel which is sampled from the original image, and generates correction level 102. Multi-valuation unit 92 compares correction level 102 and a plurality of specific threshold values 103, and outputs multi-valued data 104. Difference operation unit 93 works out multi-valuation error 105 from correction level 102 and multi-valued data 104. Distribution coefficient generating unit 96 generates distribution coefficient 108 at specific intervals and outputs the same to error distribution update unit 95. Error distribution update unit 95 distributes the sum of multi-valuation error 105 and second correction accumulation error 106 according to distribution coefficients 108 and adds each distributed error to the respective accumulation error 109 at the pixel position for each unprocessed pixel adjacent to a target pixel stored in error storing unit 97 (or stored in error distribution update unit 95), and updates accumulation error.

In FIG. 5, input correction unit 91, multi-valuation unit 92, difference operation unit 93, error re-distribution determining unit 94, error distribution update unit 95 and error storing unit 97 can be materialized in the same configuration as in the first embodiment. Therefore, there will be explained distribution coefficient generating unit 96.

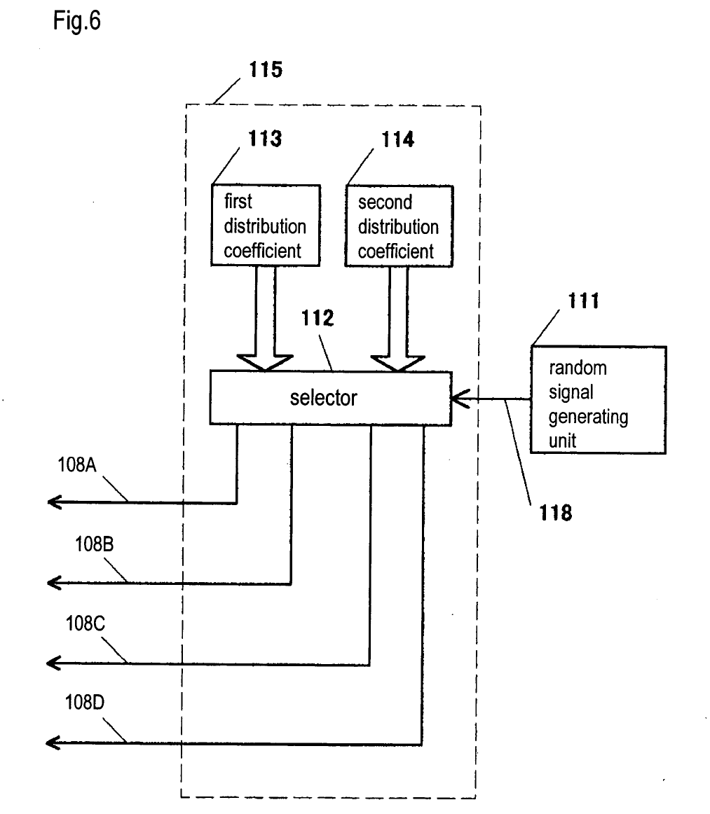

FIG. 6 is a block diagram of a first distribution coefficient generating circuit, an example of distribution coefficient generating unit 96. The first distribution coefficient generating circuit comprises random signal generating unit 111 and selector 112. One-bit random signal 118 is outputted from random signal generating unit 111. With one-bit random value generated by computer stored in a table in advance, random signal 118 may be outputted per pixel. Selector 112 selects either the first distribution coefficients 113 or second distribution coefficients by random signal 118 and outputs it as distribution coefficients 108 (108A to 108D). The outputted distribution coefficients 108 are inputted into error distribution update unit 95. Distribution coefficients shown in FIG. 54B may be used as first distribution coefficients 113 and distribution coefficients shown in FIG. 54C may be used as second distribution coefficients 114. The distribution coefficients are not limited to that. Furthermore, the size of filter of distribution coefficients may be changed. The number of distribution coefficients is not limited to two. More than two distribution coefficients may be switched. (The same is applicable to the embodiments which will be described later.)

Furthermore, distribution coefficients 108 outputted from distribution coefficient generating unit 96 may be outputted for two purposes, that is, for second correction accumulation error 106 and for multi-valuation error 105. In this case, second correction accumulation error 106 and multi-valuation error 105 are distributed according to different distribution coefficients. After distribution, they may be synthesized (added) and made accumulation error at each position.

The error re-distribution determining unit 94 makes it possible to obtain an image with a good granularity with less overlapping of color dots. In addition, provision of distribution coefficient generating unit 96 can keep down occurrence of texture in image.

### Third Embodiment

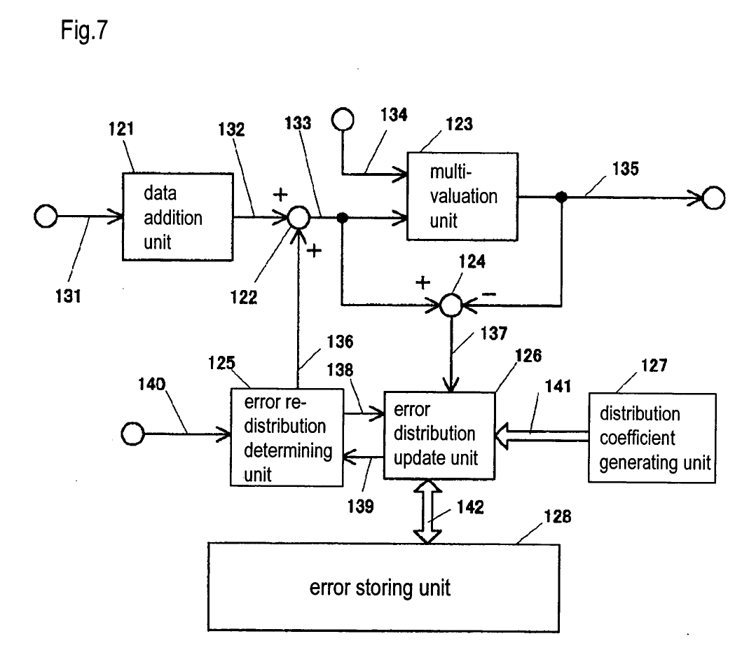

FIG. 7 is a block diagram of an image processing apparatus in the third embodiment according to the present invention. The image processing apparatus shown in FIG. 7 comprises data addition unit 121, input correction unit 122, multi-valuation 123, difference operation unit 124, error re-distribution determining unit 125, error distribution update unit 126, distribution coefficient generating unit 127 and error storing unit 128.

Data addition unit 121 adds density level (data level) fluctuating at specific intervals different from the density level of target pixel to tone density level of each pixel which is sampled from the original image, and generates input level 132. Error re-distribution determining unit 125 separates accumulation error 139 for the target pixel position into first correction accumulation error 136 and second correction accumulation error 138 in accordance with error distribution control signal 140. Input correction unit 122 adds first correction accumulation error 136 outputted from error re-distribution determining unit 125 to input level 132 outputted from data addition unit 121, and generates correction level 133. Multi-valuation unit 123 compares correction level 133 and a plurality of specific threshold values 134 and outputs multi-valued data 135. Difference operation unit 124 works out multi-valuation error 137 from correction level 133 and multi-valued data 135. Distribution coefficient generating unit 127 generates distribution coefficient 141 at specific intervals and outputs the same to error distribution update unit 126. Error distribution update unit 126 distributes the sum of multi-valuation error 137 and second correction accumulation error 136 according to distribution coefficients 141 and adds each distributed error to the respective accumulation error 142 at the pixel position for each unprocessed pixel adjacent to a target pixel stored in error storing unit 128 (or stored in error distribution update unit 126), and updates the accumulation error.

In FIG. 7, input correction unit 122, multi-valuation unit 123, difference operation unit 124, error re-distribution determining unit 127, error re-distribution determining unit 125, error distribution update unit 126 and error storing unit 128 can be materialized in the same configuration as in the second embodiment. Therefore, there will be explained data addition unit 121.

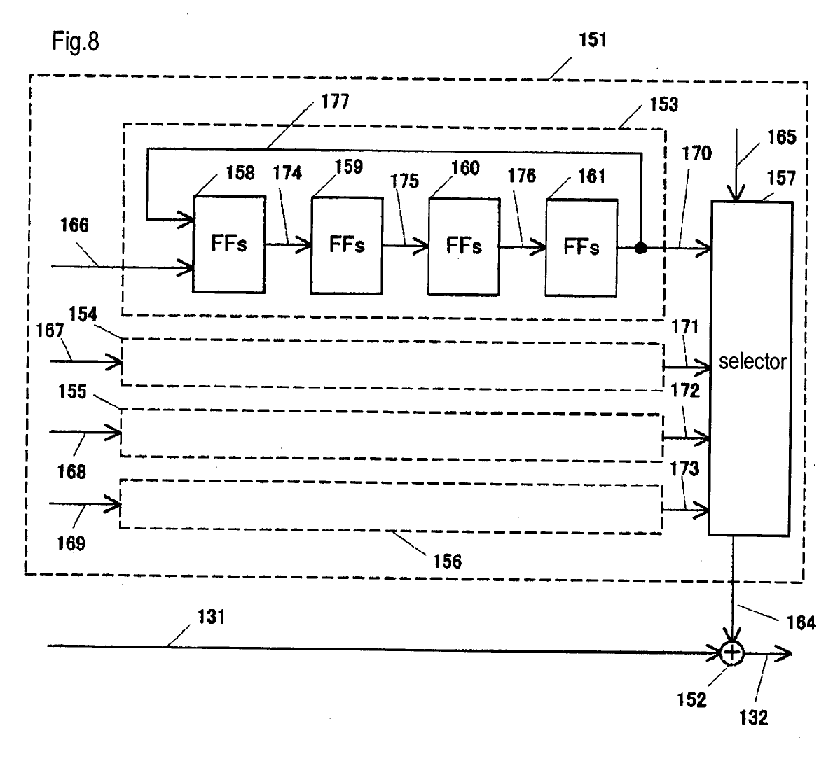

FIG. 8 is a block diagram of a first data addition circuit, an example of data addition unit 121. The first data addition circuit is made up of data generating unit 151 and adder 152. Tone density level 131 of each pixel which is sampled from the original image is added to density level 164 outputted from data generating unit 151 by adder 152 and generates input level 132.

Data generating unit 151 is made up of line data generating unit 153 to 156 and selector 157. Selector 157 selects and outputs any one of addition data levels 170 to 173 outputted from line data generating unit 153 to 156 on the basis of line information 165 on the target pixel. In the present embodiment, selected addition data levels 170 to 173 change four lines by four lines. It is noted that in the present embodiment, there are provided four line data generating unit, but the number of the unit is not limited to four.

Line data generating unit 153 is made up of a plurality of registers (or a set of flip-flops) 158 to 161. Data levels 174 to 176 outputted from registers 158 to 160 are inputted to registers 159 to 161 in the following stage respectively. The data level 170 outputted from the register 161 placed in the last stage is inputted to the register 158 placed in the forefront stage through the signal line 177. In line data generating unit 153, the value of register circulates by every pixel. As a result, the data level 170 outputted from the register 161 varies by four pixel cycles. An initial value of the register is set to the register 158 through the signal line 166.

In the example of FIG. 8, four registers 158 to 161 are set in line data generating unit 153, but it is not limited to four registers. By changing an initial value which is set in one or more registers by colors, the diffusion of dots which are different by every color is generated.

Other line data generating units 154 to 156 are comprised in the same manner as line data generating unit 153. As an example for these, an initial value of the register of other line data generating units 154 to 156 is set through signal lines 167-169 respectively.

For example, by using such data addition unit 121, density level 161 is added to density level 131, and input level 132 is produced.

Provision of data addition unit 121 can substantially keep down the texture on an image with less change in density and an image with a uniform density generated by computer, in addition to the effects described in the second embodiment.

If correction level is multi-valuated without adding data level, there is a data level for which the granularity extremely decreases. The continuity of impression of grain can be improved by adding data to such data level which is determined according to the degree of change of the granularity after the multi-valuation.

### Fourth Embodiment

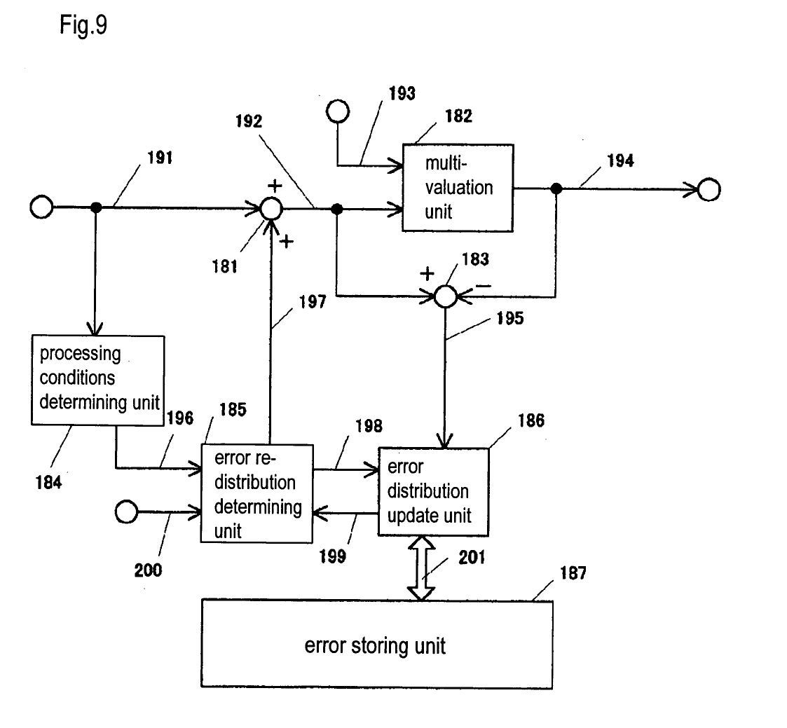

FIG. 9 is a block diagram of an image processing apparatus in the fourth embodiment according to the present invention. The image processing apparatus shown in FIG. 9 is made up of input correction unit 181, multi-valuation unit 182, difference operation unit 183, processing condition determining unit 184, error re-distribution determining unit 185, error distribution update unit 186 and error storing unit 187.

Processing condition determining unit 184 determines processing conditions using the density level of the target pixel alone or density level of the target pixel and density level adjacent to the target pixel out of tone density levels 191 which are sampled from the original image by pixels, and outputs first processing condition signal 196. Error re-distribution determining unit 185 separates the accumulation error for the target pixel position into first correction accumulation error 197 and second correction accumulation error 198 on the basis of error distribution control signal 200 and first processing condition signal 196. Input correction unit 181 adds first correction accumulation error 197 to input level 191, that is, density level of the target pixel and generates correction level 192. Multi-valuation unit 182 generates multi-valued data 194 from correction level 192 and a plurality of threshold value 193. Difference operation unit 183 works out multi-valuation error 195 from correction level 192 and multi-valued data 194. Error distribution update unit 186 distributes multi-valuation error 195 according to distribution coefficient and adds each distributed error to the respective accumulation error 201 at the pixel position for each unprocessed pixels adjacent to a target pixel stored in error storing unit 187 (or stored in error distribution update unit 186), and updates the accumulation error.

In FIG. 9, input correction unit 181, multi-valuation unit 182, difference operation unit 183, error distribution update unit 186, and error storing unit 187 can be materialized in the same configuration as in the first embodiment. Therefore, there will be explained processing condition determining unit 184 and error re-distribution determining unit 185.

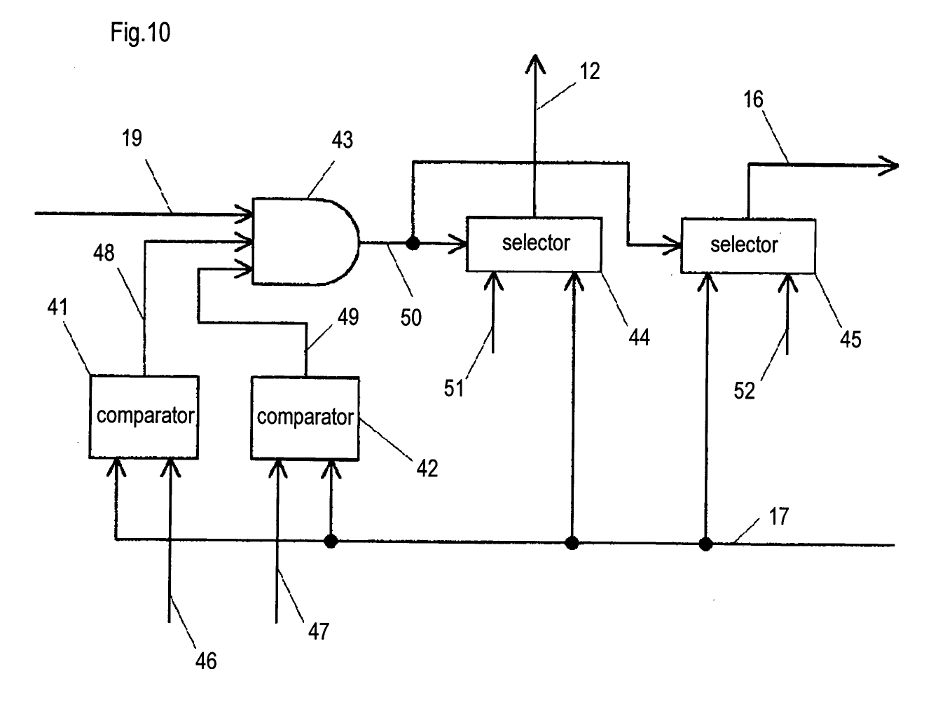

FIG. 10 is a block diagram of processing condition determining circuit A, a first example of processing condition determining unit 184. Processing condition determining circuit A of the present embodiment is a circuit for detecting the highlight area and shadow area.

Processing condition determining circuit A shown in FIG. 10 are made up of line buffers 204, 205, adders 206, 207, 213, 214, registers (a set of flip-flops) 211, 212, comparators 208, 209 and logic element 210. It is noted that blocks 231, 232, 233 are identical in configuration.

Tone density level 191A of each pixel which is sampled from the original image is inputted into register 211. After delaying for one pixel, the output signal 228 of register 211 is inputted into register 212. After delaying by one more pixel, register 212 outputs signal 230. By these, density levels 191A, 228, 230 of three pixels can be handled at the same time. Adder 213 adds density level 191A and signal 228, and the addition result 229 is furthermore added to signal 230 at adder 214. That means that image data for three pixels are added. Line buffer 204 delays image data for one line. In addition, line buffer 205 delays image data by one more line. Blocks 232, 233 are identical with block 231 in configuration. These permit handling density levels of pixels on three columns, three rows. Image data for three lines are added by adders 206, 207. Added data 223 of a total of 9 pixels are compared with specific values 224, 225 at comparators 208, 209. If the added data 223 is smaller than specific threshold value 224, comparator 208 outputs to signal line 226 a high level signal indicating that the area is a highlight area, while if the added data 223 is larger than the threshold value 225, comparator 209 outputs to signal line 227 a high level signal indicating that the area is a shadow area. If either signal line 226 or 227 is a high level, logical element 210 sets (first) processing condition signal at a high level.

In the present embodiment, the pixel position of the target pixel is the third column, third row and the image data corresponding to the target pixel is the oldest pixel data. Therefore, the density level 191 to be inputted into input correction unit 181 has to be delayed (no delay circuit shown). The delay circuit may make common use of a line buffer or register in processing condition determining circuit A shown in FIG. 10

The target pixel position, in the above example, is not limited to data at this pixel position. It is also noted that the image area is detected from the density level of an area of 3×3 pixels, but the area is not limited to this area size.

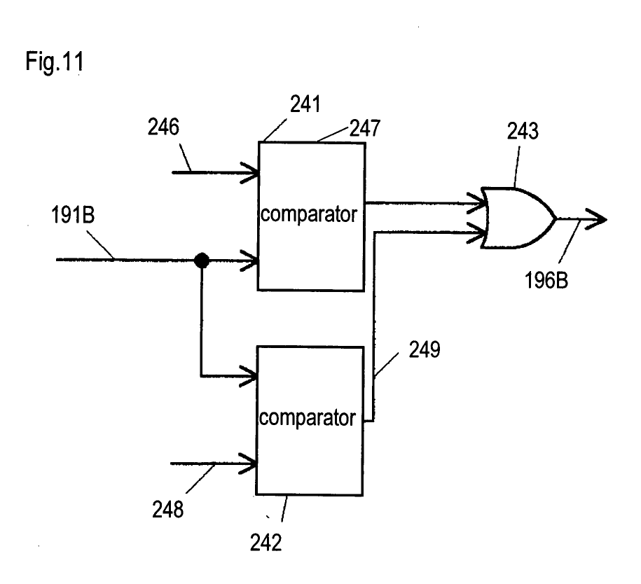

FIG. 11 is a block diagram of processing condition determining circuit B, a second example of processing condition determining unit 184. Processing condition determining circuit B detects whether the target pixel in the original image is at the minimum level or at the maximum level.

Processing condition determining circuit B shown in FIG. 11 is formed of comparators 241, 242, and logic element 243. Density level 191B of the target pixel is inputted into comparator 241 and it is judged whether the density level is equal to the minimum density level 246. If density level 191B is equal to minimum density level 246, comparator 241 outputs high level to signal line 247. Furthermore, density level 191B is inputted into comparator 242 and it is judged whether the density level is equal to maximum density level 248. If density level 191B is equal to maximum density level 248, comparator 242 outputs high level to signal line 249. If one of the signal lines 247, 249 becomes a high level, logic element 243 sets (first) processing condition signal 196B at a high level.

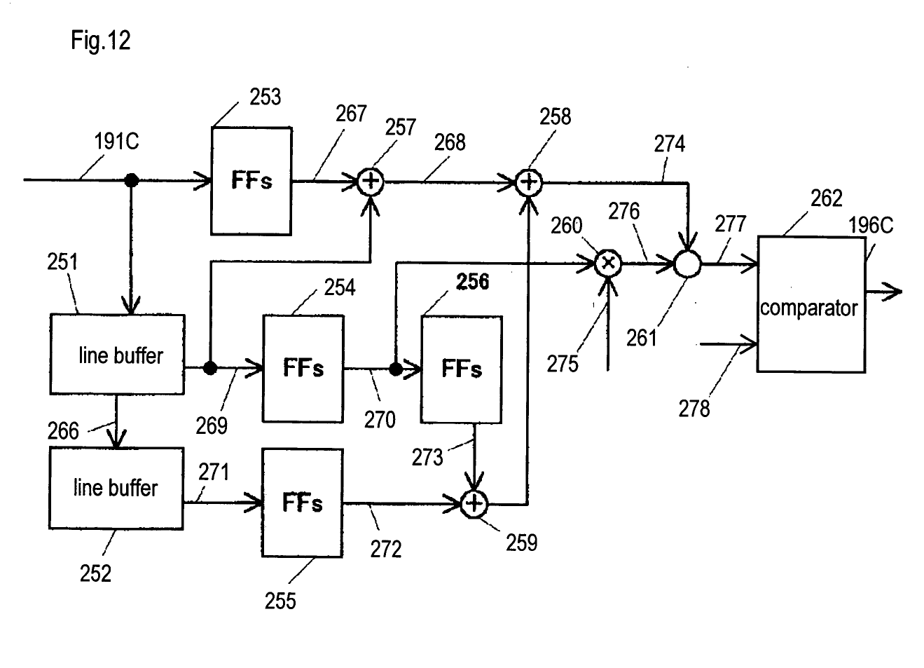

FIG. 12 is a block diagram of processing condition determining circuit C, a third example of processing condition determining unit 184. Processing condition determining circuit C detects a character/line-drawing area by edge detection.

Processing condition determining circuit C shown in FIG. 12 is made up of line buffer 251, 252, registers 253 to 256, adders 257 to 259, multiplier 260, divider 261, comparator 262. Processing condition determining circuit C is well known as edge detection circuit. The line buffer delays image data by one line. Therefore, an image outputted from line buffer 251 delays by one line and an image outputted from line buffer 252 delays by two lines. Furthermore, the register delays image data by one pixel. The density level at the target pixel position in the present embodiment is a density level 270 outputted from register 254. Data outputted from adder 258 is a value obtained by adding all density levels 267, 269, 272, 273, adjacent to the target pixel in the vertical and horizontal directions. Density level 270 at the target pixel position is inputted into multiplier 260 and multiplied by a specific value (“4”, for example). The difference value (absolute value) between the output of multiplier 260 and the output of adder 258 is worked out by difference circuit 261. Difference value 277 is compared with specific value 278 at comparator 262, and if the difference value 277 is larger than specific value 278, the comparator sets (first) processing condition signal 196C at a high level.

When processing condition determining circuit C of the present embodiment is used, density level 191 to be inputted in input correction unit 181 also has to be delayed (no delay circuit shown).

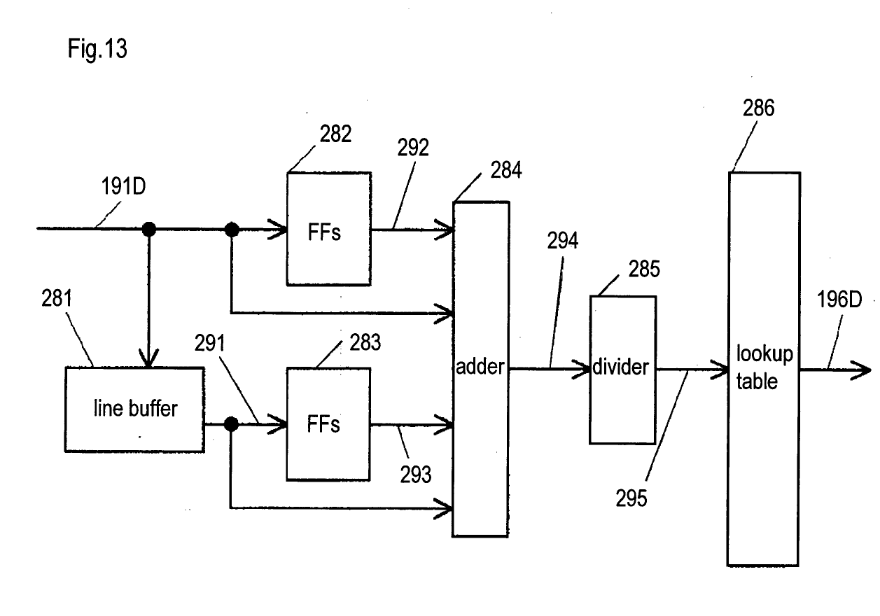

FIG. 13 is a block diagram of processing condition determining circuit D, a fourth example of processing condition determining unit 184. Processing condition determining circuit D in the present embodiment detects the average density level in a specific area of the original image. When an image of a specific density level is multi-valuated, there is a density level area where the granularity changes markedly (decreases), which can affect the continuity of the impression of grain in images like gradation. Therefore, this density area is detected.

Processing condition determining circuit D shown in FIG. 13 is formed of line buffer 281, registers 282, 283, adder 284, divider 285, look-up table 286. The density level at the target pixel is density level 293 outputted from register 283. Line buffer 281 delays image data by one line, and registers 282, 283 delay by one pixel. Therefore, adder 284 outputs to signal line 294 the results obtained by adding all density levels in an area of 2×2. At divider 285, the addition result is divided by “4” and the average density level 295 is outputted. In the case of value “4”, merely two-bit shift may be used. Lookup table 286 outputs (first) processing condition signal 196D, a signal judging whether the density level is within a specific scope from average density level 295.

Lookup table 286 is used. As an alternative to that, it may be judged by comparator whether the density level is within a specific scope.

It is also noted that the average density level in a 2×2 area is worked out in processing condition determining circuit D, but the present invention is not limited to this area size. Furthermore, when processing condition determining circuit D of the present embodiment is used, density level 191 to be inputted into input correction unit 181 also has to be delayed (no delay circuit shown).

As set forth above, different circuits can be materialized as processing condition determining unit 184. They may be used alone, or some of them may be used in combination. When some are combined, image area judging unit may be provided which judges the image area from a plurality of (first) processing condition signals.

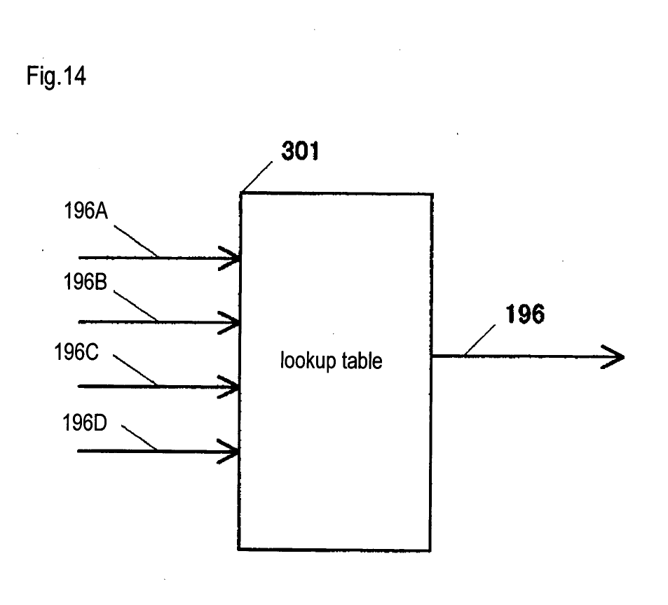

FIG. 14 is an image area judging circuit, an example of image area judging unit for generating first processing condition signal when the four above-mentioned processing condition determining circuits are combined.

(First) Processing condition signal 196A outputted from processing condition determining circuit A, (first) processing condition signal 196B outputted from processing condition determining circuit B, (first) processing condition signal 196C outputted from processing condition determining circuit C and (first) processing condition signal 196D outputted from processing condition determining circuit D are inputted into lookup table 301. A control signal outputted from lookup table 301 becomes first processing condition signal 196. The way of controlling will be explained in detail later.

The present example of processing condition determining unit 184 is so configured that image data is delayed by line buffer and at the same time density levels for a plurality of lines can be processed at the same time. As an alternative to that, it is may be so configured that data is read directly form the memory instead of using the line buffer.

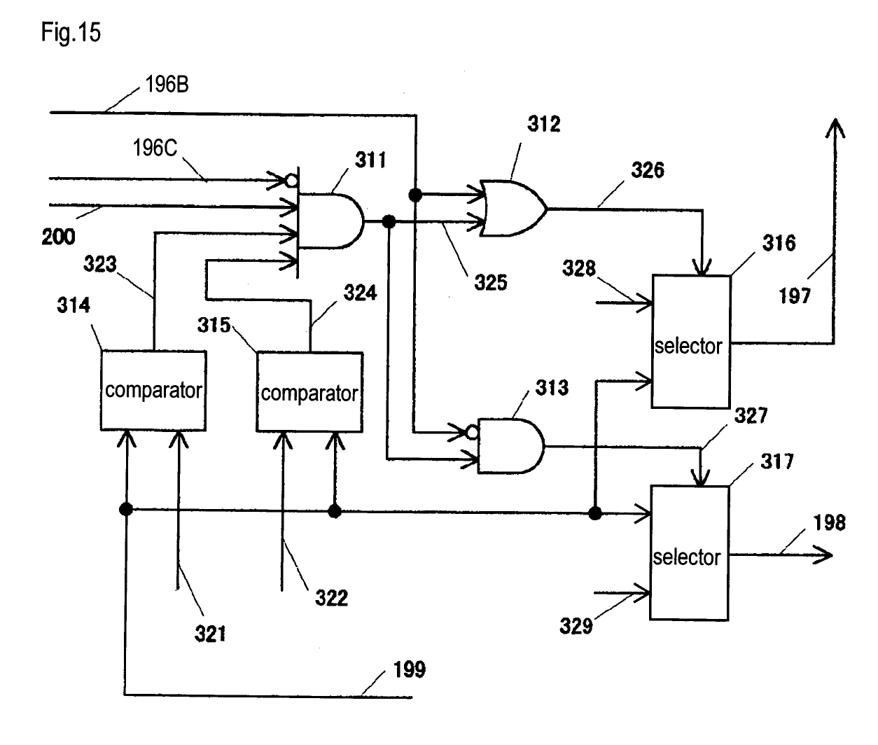

FIG. 15 is a second error distribution determining circuit, an example of error re-distribution determining unit 185. The second error distribution determining circuit shown in FIG. 15 is formed of logic elements 311 to 313, comparators 314, 315 and selectors 316, 317.

Accumulation error 199 for the target pixel position is first inputted into comparators 314, 315. Comparator 314 compares the accumulation error with specific value 321. The specific value 321 is density level “0”, for example. Also, accumulation error 199 is compared with specific value 322 at comparator 315. Specific value 322 is density level “128,” for example. If accumulation error 199 is larger than specific value 321, comparator 314 sets output line 323 at a high level. If, on the other hand, accumulation error 199 is smaller than specific value 322, comparator 315 sets output line at a high level. In other words, it can be judged from these output signals 323, 324 whether accumulation error 199 is within a specific scope.

Only when error distribution control signal 200 is high level (indicating that another color dot is stricken), output of comparators 314, 315 is high level and first processing condition signal 196C outputted from processing condition determining unit 184 is low level, logic element 311 sets signal line 325 at high level. As first processing condition signal 196C, detection signal of character, line drawing area shown in FIG. 12 is desirable. That is, if character, line drawing areas are detected, logical element 311 outputs a low level. In the present embodiment, first processing condition signal 196B is input signal of the second error distribution determining circuit. As first processing condition signal 196B, the maximum density level or minimum density level shown in FIG. 11 is desirable. When the processing condition signal 196B is high level (when maximum density level or minimum density level is detected) or the output of logical element 311 is at a high level, logical element 312 outputs high level to signal line 326. When signal line 326 is at a high level, selector 316 outputs specific value 328, and when signal line 326 is at a low level, accumulation error 199 is outputted. That is, when maximum density level or minimum density level is detected, or when another color dot is stricken at the target pixel position and accumulation error 199 for the target pixel position is within a specific scope, not accumulation error 199 but specific value 328 (“0”, for example) is outputted. That can keep down propagation of unneeded errors at the most white part or most black part on the ground etc. or overlapping rate of color dots. The value outputted from selector 316 becomes first correction accumulation error 197. When signal line 325 is at a high level and first processing condition signal 196B is at a low level (when maximum density level and maximum density level are not detected), selector 317 outputs accumulation error 199, and when signal line 325 is low level or first processing condition signal 196B is high level, specific value 329 (“0”, for example) is outputted. A value outputted from selector 317 becomes second correction accumulation error 198.

In the present embodiment, specific values 321, 322 are fixed value. These values may be changed depending on the density level at or around target pixel.

The present embodiment is so configured that either accumulation error 199 or specific value “0” is selected as first correction accumulation error 197 and second correction accumulation error 198. The present embodiment is not limited to this method, but may be so configured that the distribution ratio of accumulation error 199 is changed depending on the selection signal.

Furthermore, first processing condition signals 196B, 196C are used. The present embodiment is not limited to these signals, but other first processing condition signals 196A, 196B or a combination of these signals may be used.

### Fifth Embodiment

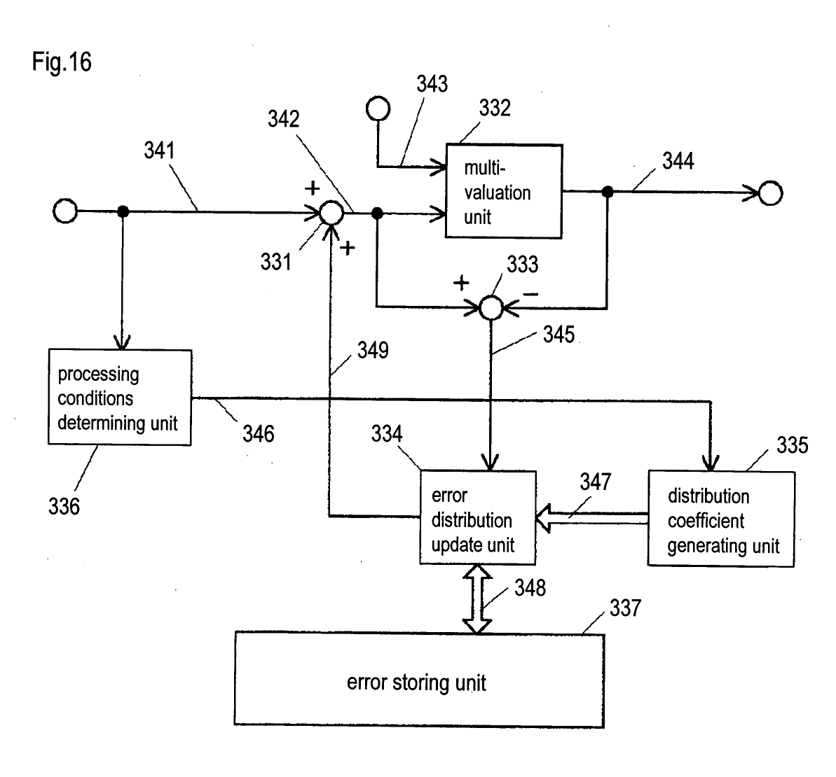

FIG. 16 is a block diagram of an image processing apparatus in the fifth embodiment according to the present invention. The image processing apparatus shown in FIG. 16 is formed of input correction unit 331, multi-valuation unit 332, difference operation unit 333, error distribution update unit 334, distribution coefficient generating unit 335, processing condition determining unit 336 and error storing unit 337.

Processing condition determining unit 336 determines processing condition using the density level at or around the target pixel out of tone density levels 341 which are sampled from the original image by pixels, and outputs second processing condition signal 346. Input correction unit 331 adds accumulation error 349 for the target pixel position to tone density level 341 and generates correction level 342. Multi-valuation unit 332 generates multi-valued data 344 from correction level 342 and a plurality of threshold values 343. Difference operation unit 333 works out multi-valuation error 345 from correction level 342 and multi-valued data 344. Distribution coefficient generating unit 335 generates distribution coefficient 347 at specific intervals and outputs the same to error distribution update unit 334. Then, the specific interval of distribution coefficient generating unit 335 is controlled by second processing condition signal 346 outputted from processing condition determining unit 336. Error distribution update unit 334 distributes multi-valuation error 345 according to distribution coefficients 347, and adds each distributed error to the respective accumulation error 348 of the pixel position for each unprocessed pixels adjacent to the target pixel stored in error storing unit 337 (or stored in error distribution update unit 334), and updates accumulation error.

In FIG. 16, input correction unit 331, multi-valuation unit 332, difference operation unit 333, processing condition determining unit 336 and error storing unit 337 can be each materialized in the same configuration as the fourth embodiment. Therefore, there will be explained error distribution update unit 334 and distribution coefficient generating unit 335.

A second error distribution update circuit, an example of error distribution update unit 334, can be materialized with some changes made in first error distribution update circuit shown in FIG. 4. The second error distribution update circuit where second correction accumulation error 16 does not exist is constituted without adder 61 (not shown).

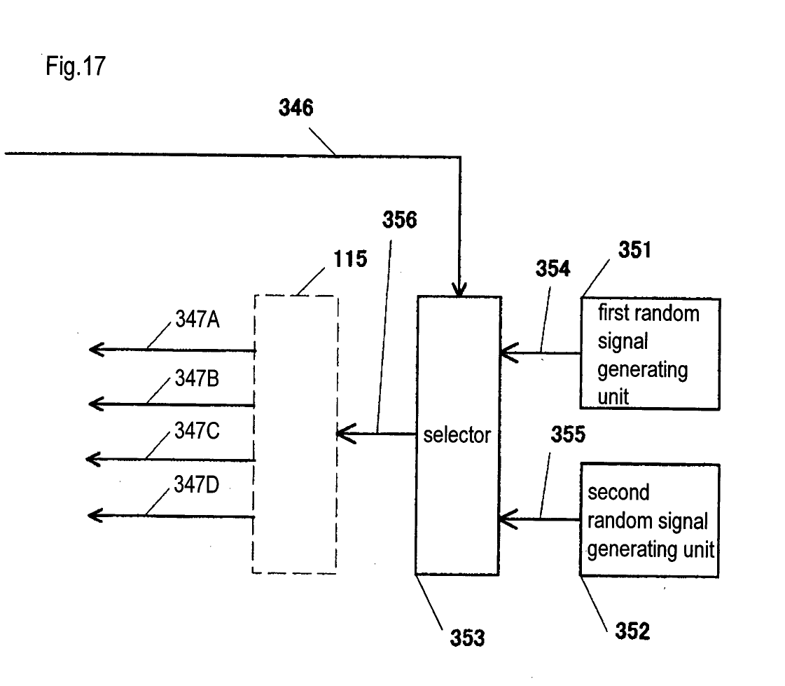

FIG. 17 is a block diagram of a second distribution coefficient generating circuit, an example of distribution coefficient generating unit 335. The second distribution coefficient generating circuit shown in FIG. 17 is formed of first random signal generating unit 351, second random signal generating unit 352, selector 353 and distribution coefficient selection unit 115. Distribution coefficient unit 115 can be materialized in the same configuration as block 115 surrounded with dotted line in the first distribution coefficient generating circuit, as shown in FIG. 6.

First random signal generating unit 351 and second random signal generating unit 352 are different in ratio of generating one bit random signals “0” and “1.” For example, when two distribution coefficients in FIG. 54B and FIG. 54C are switched, first random signal generating unit 351 generates signals selecting the respective distribution coefficients statistically roughly half and half. Second random signal generating unit 352 is made to generate random signals in which either of the distribution coefficients is selected more. Selector 353 switches first random signal 354 and second random signal 355 on the basis of second processing condition signal 346. From distribution coefficient selection unit 115, selected distribution coefficient 347 (347A to 347D) is outputted.

In the present embodiment, there are provided two random signal generating unit, that is, first random signal generating unit 351 and second random signal generating unit 352. The number of random signal generating unit is not limited to two. More than two may be provided to control minutely. Without a plurality of random signal generating units, one random signal might be controlled by the second processing condition signal outputted from processing condition determining means, in order to change a ratio of each distribution coefficients to be selected. The ratio of the value “1” to “0” could be changed by the logical synthesis with the OR or AND element of random signals, which are generated by delaying a random signal.

In addition to controlling random signal, the selection of distribution coefficients may be controlled (selector 112 is controlled) (the same is applicable to the embodiments that will be described later).

If distribution coefficients are switched in a random way, the occurrence of texture can be controlled, but the granularity will be poor. If distribution coefficients and random ratio are selected properly in view of the relation between granularity and texture, therefore, the picture quality will improve. In the case of highlight or shadow area, if dots are dispersed, the dot delay observed in the error diffusion method will be reduced and the picture quality will improve. Therefore, it is better for distribution coefficients to be switched at random. In the case of the minimum density level or maximum density level, occurrence of unnecessary dots can be prevented if all coefficients are turned to “0” so that no errors may propagate. For an area like character/line-drawing area where texture does not stand out, the picture quality will improve without rather than with changing distribution coefficients in a random manner. Furthermore, for an area with density level such as a near multi-valued level, it is preferable to make the quality of the granularity poor intentionally because the granularity extremely decreases there. Such an area could be observed according to the granularity after multi-valuation. If the distribution coefficients are switched so as to make the quality of the granularity poor, the impression of grain for the area will be balanced with the impression for areas with other density levels.

### Sixth Embodiment

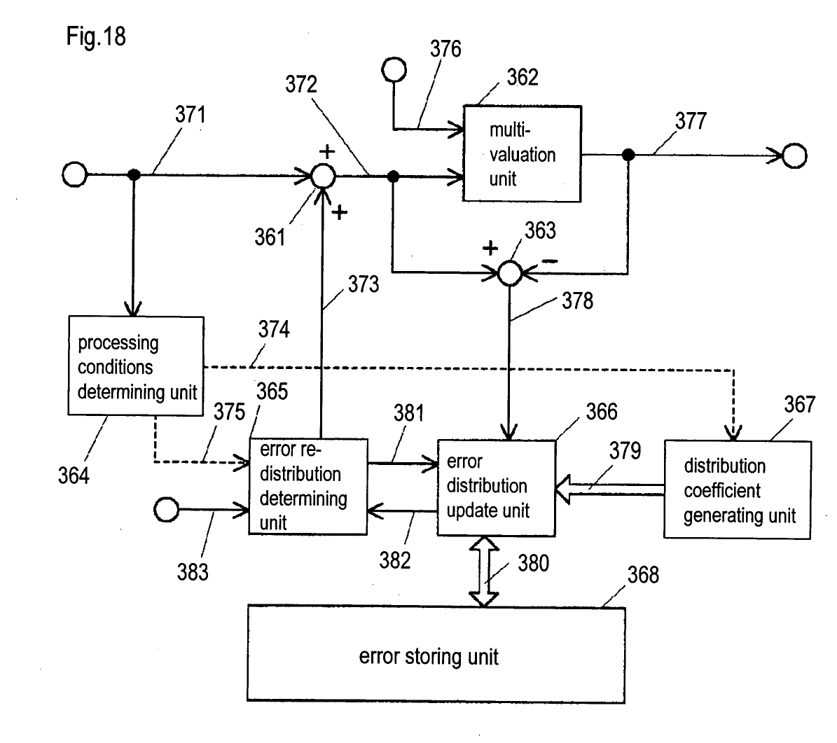

FIG. 18 is a block diagram of an image processing apparatus in the sixth embodiment according to the present invention. The image processing apparatus shown in FIG. 18 is formed of input correction unit 361, multi-valuation unit 362, difference operation unit 363, processing condition determining unit 364, error re-distribution determining unit 365, error distribution update unit 366, distribution coefficient generating unit 367 and error storing unit 368.

Processing condition determining unit 364 detects a specific area from density level at or around the target pixel out of the tone density levels 371 which are sampled from the original image by pixels and outputs first processing condition signal 375 and second processing condition signal 374. Error re-distribution determining unit 365 separates accumulation error 382 for the target pixel position into first correction accumulation error 373 and second correction accumulation error 381 on the basis of error distribution control signal 383 and first processing condition signal 375. Input correction unit 361 adds first correction accumulation error 373 to tone density level 371 and generates correction level 372. Multi-valuation unit 362 generates multi-valued data 377 from correction level 372 and a plurality of specific threshold value 376. Difference operation unit 363 works out multi-valued data 378 from correction level 372 and multi-valued data 377. Distribution coefficient generating unit 367 generates distribution coefficient 379 at specific intervals and outputs the same to error distribution update unit 366. Then, the distribution coefficient of distribution coefficient generating unit 367 is controlled by second processing condition signal 374 outputted from processing condition determining unit 364. Error distribution update unit 366 distributes multi-valuation error 378 according to distribution coefficients 379, and adds each distributed error to the respective accumulation error 380 at the target pixel position for each unprocessed pixel adjacent to a target pixel stored in error storing unit 368 (or stored in error distribution update unit 366) and updates the accumulation error.

In FIG. 18, input correction unit 361, multi-valuation unit 362, difference operation unit 363, processing condition determining unit 364, error re-distribution determining unit 365, error distribution update unit 366, distribution coefficient generating unit 367 and error storing unit 368 can be materialized in the same configuration as described before. Processing condition determining unit 364 outputs first processing condition signal 375 and second processing condition signal 374. As an alternative to that, those signals may be outputted from a lookup table shown in FIG. 14 as different processing condition signals or the processing condition signal.

The present embodiment is so configured that error re-distribution determining unit 365 and distribution coefficient generating unit 367 are both controlled by processing condition determining unit 364. As an alternative to that, only either of them may be controlled.

According to the present embodiment, dots are overstruck in character, line drawing area even if other color dots are present, and therefore the edge sharpness of characters, line drawing increases, and the picture quality in the character, line drawing area will improve. When the maximum density level or minimum density level is detected, the propagation of accumulation error can be prevented and occurrence of unnecessary noise can be kept down.

### Seventh Embodiment

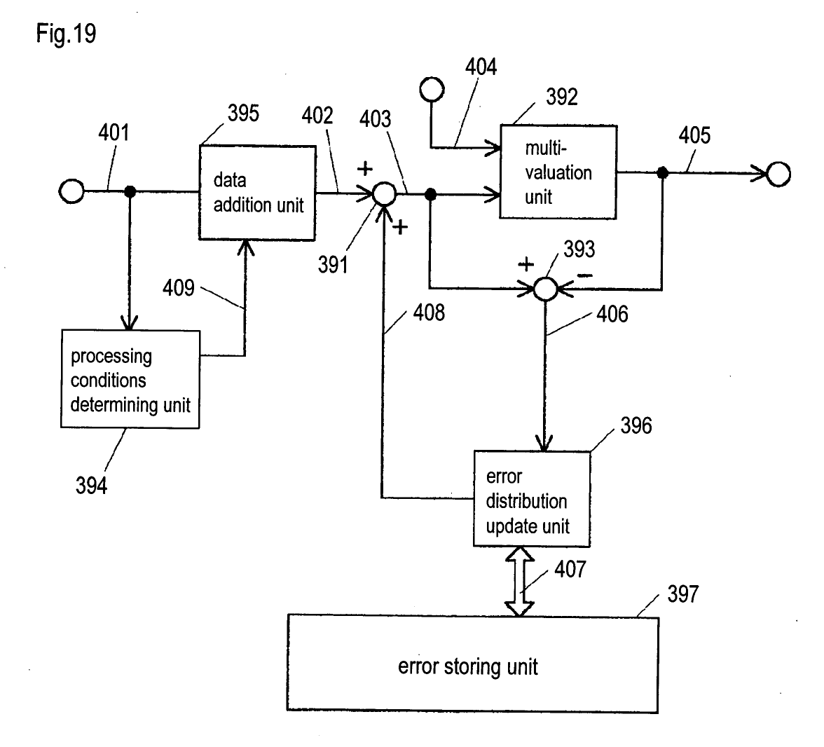

FIG. 19 is a block diagram of an image processing apparatus in the seventh embodiment according to the present invention. The image processing apparatus shown in FIG. 19 is formed of input correction unit 391, multi-valuation unit 392, difference operation unit 393, processing condition determining unit 394, data addition unit 395, error distribution update unit 396 and error storing unit 397.

Processing condition determining unit 394 outputs third processing condition signal 409 using the density level at or around the target pixel out of tone density levels 401 which are sampled from the original image by pixels. Data addition unit 395 adds the density level changing at specific intervals to density level 401 on the basis of third processing condition signal 409 and generates input level 402. Input correction unit 391 adds accumulation error 408 for the target pixel position to input level 402 and generates correction level 403. Multi-valuation unit 392 generates multi-valued data 405 from correction level 403 and a plurality of specific threshold values 404. Difference operation unit 393 works out multi-valuation error 406 from correction level 403 and multi-valued data 405. Error distribution update unit 396 distributes multi-valuation error 406 according to the distribution coefficients and adds each distributed error to the respective accumulation error 407 at the pixel position for each unprocessed pixel adjacent to a target pixel stored in error storing unit 397 (or stored in error distribution update unit 396), and updates accumulation error.

In FIG. 19, input correction unit 391, multi-valuation unit 392, difference operation unit 393, processing condition determining unit 394, error distribution update unit 396, and error storing unit 397 can be materialized in the same configuration as mentioned before. Therefore, there will be explained data addition unit 395. In this embodiment, third processing condition signal 409 is outputted from processing condition determining unit 394, but any of the aforesaid processing condition signals or the processing condition signal outputted from the lookup table shown in FIG. 14 may be used.

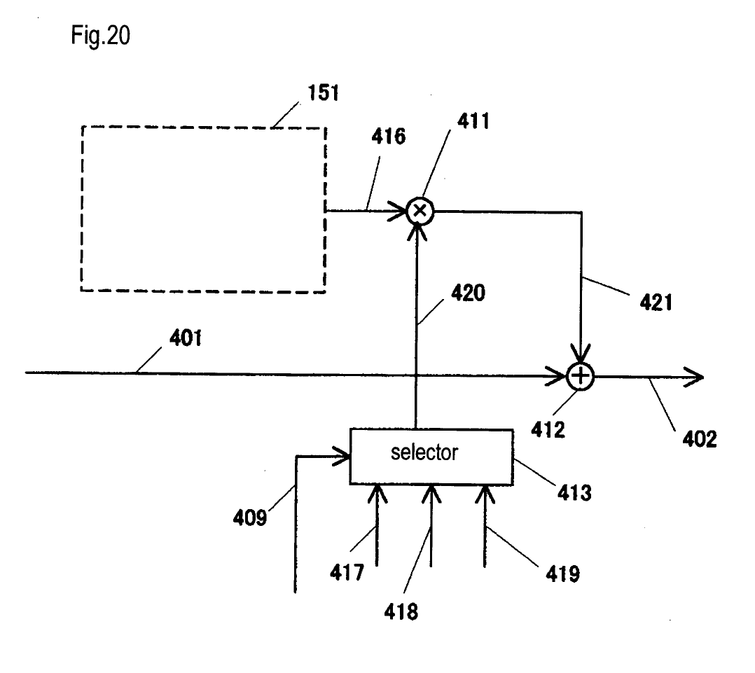

FIG. 20 is a second data addition circuit, an example of data addition unit 395. The second data addition circuit shown in FIG. 20 is formed of data generating unit 151, multiplier 411, adder 412, and selector 413. Data generating unit 151 can be formed of the same circuits as block 151 in the first data addition circuit shown in FIG. 8. Third processing condition signal 409 outputted from processing condition determining unit 394 is inputted in selector 413 and becomes selective signals of multiplicators 417 to 419. A selected multiplicator is multiplied by addition data level 416 in multiplier 411, and the multiplying result or addition level 421 is outputted to adder 412. At adder 412, density level 401 and addition level 421 are added and input level 402 is generated.

If one of multiplicators 417 to 419 is made “0”, the data can be added to specific density level alone.

The present embodiment is so configured that density level 401 is corrected on the basis of third processing condition signal 409 by data addition unit 395. Therefore, data level to be added to density level 401 of the original image can be changed for every area of image and the granularity can be controlled minutely.

### Eighth Embodiment

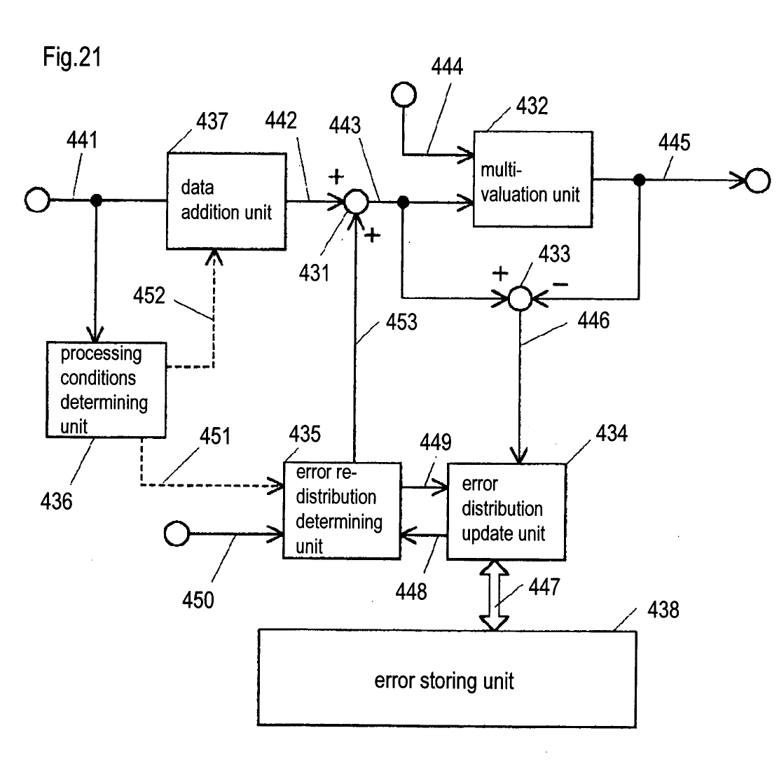

FIG. 21 is a block diagram of an image processing apparatus in the eighth embodiment according to the present invention. The image processing apparatus shown in FIG. 21 is formed of input correction unit 431, multi-valuation unit 432, difference operation unit 433, error distribution update unit 434, error re-distribution determining unit 435, processing condition determining unit 436, data addition unit 437, and error storing unit 438.

Processing condition determining unit 436 outputs first processing condition signal 451 and third processing condition signal 452, using density level at or around the target pixel position out of tone density levels 441 which are sampled from the original image by pixels. Error re-distribution determining unit 435 separates accumulation error 448 for the target pixel position into first correction accumulation error 453 and second correction accumulation error 449 on the basis of error distribution control signal 450 and first processing condition signal 451. Data addition unit 437 adds a density level fluctuating at specific intervals to density level 441 on the basis of third processing condition signal 452. Input correction unit 431 adds first correction accumulation error 453 to input level 442 and generates correction level 443. Multi-valuation unit 432 generates multi-valued data 445 from correction level 443 and a plurality of specific threshold values 444. Difference operation unit 433 works out multi-valuation error 446 from correction level 443 and multi-valued data 445. Error distribution update unit 434 distributes multi-valuation error 446 according to the distribution coefficients, and adds each distributed error to the respective accumulation error 447 at the pixel position for each unprocessed pixel adjacent to a target pixel stored in error storing unit 438 (or stored in error distribution update unit 434), and updates the accumulation error.

All units in FIG. 21 can be materialized in the same configuration as described before.

The present embodiment is so configured that both error re-distribution determining unit 435 and data addition unit 437 are controlled by processing condition determining unit 436. As an alternative to that, it may be so configured that either of them is controlled.

### Ninth Embodiment

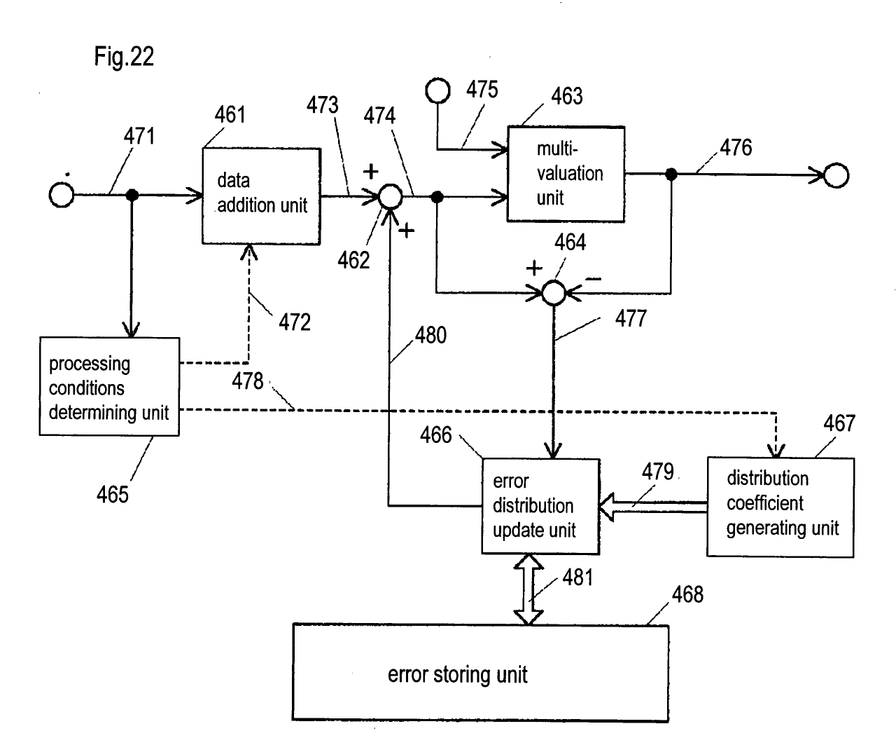

FIG. 22 is a block diagram of an image processing apparatus in the ninth embodiment according to the present invention. The image processing apparatus shown in FIG. 22 is formed of data addition unit 461, input correction unit 462, multi-valuation unit 463, difference operation unit 464, error distribution update unit 466, processing condition determining unit 465, distribution coefficient generating unit 467, and error storing unit 468.

Processing condition determining unit 465 outputs second processing condition signal 478 and third processing condition signal 472, using the density level at or around the target pixel position out of tone density levels 471 which are sampled from the original image by pixels. Data addition unit 461 adds data level fluctuating at specific intervals on the basis of third processing condition signal 472 and generates input level. Input correction unit 462 adds accumulation error 480 for the target pixel position to input level 473 and generates correction level 474. Multi-valuation unit 463 generates multi-valued data 476 from correction level 474 and a plurality of specific threshold values 475. Difference operation unit 464 works out multi-valuation error 477 from correction level 474 and multi-valued data 476. Distribution coefficient generating unit 467 generates distribution coefficient 479 at specific intervals and outputs the results to error distribution update unit 466. Then, the distribution coefficient of distribution coefficient generating unit 467 is controlled by second processing condition signal 478 outputted from processing condition determining unit 465. Error distribution update unit 466 distributes multi-valuation error 477 according the distribution coefficients 479, and adds each distributed error to the respective accumulation error 481 at the pixel position for each unprocessed pixel adjacent to a target pixel stored in error storing unit 468 (or stored in error distribution update unit 466) and updates the accumulation error.

All units in FIG. 22 can be materialized in the same configuration as described earlier.

The present embodiment is so configured that data addition unit 461 and distribution coefficient generating unit 467 are both controlled by processing condition determining unit 465. Instead, either of them may be controlled.

### Tenth Embodiment

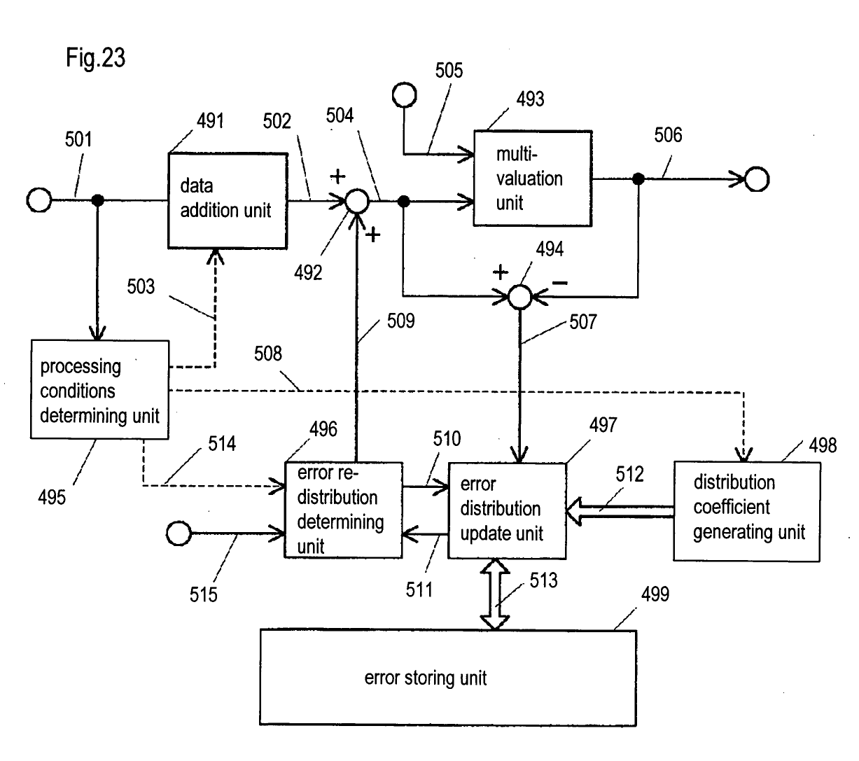

FIG. 23 is a block diagram of an image processing apparatus in the tenth embodiment according to the present invention. The image processing apparatus shown in FIG. 23 is formed of data addition unit 491, input correction unit 492, multi-valuation unit 493, difference operation unit 494, processing condition determining unit 495, error re-distribution determining unit 496, error distribution update unit 497, distribution coefficient generating unit 498, and error storing unit 499.

Processing condition determining unit 495 outputs first processing condition signal 514, second processing condition signal 508 and third processing condition signal 503, using the density level at or around the target pixel out of tone density levels 501 which are sampled from the original image by pixels. Error re-distribution determining unit 496 separates accumulation error 511 for the target pixel position 514 into first correction accumulation error 509 and second correction accumulation error 510 on the basis of error distribution control signal 515 and first processing condition signal 514. Data addition unit 491 adds a density level fluctuating at specific intervals to density level 501 on the basis of third processing condition signal 503 and generates input level 502. Input correction unit 492 adds first correction accumulation error 509 to input level 502, and generates correction level 504. Multi-valuation unit 493 generates multi-valued data 506 from correction level 504 and a plurality of specific threshold values 505. Difference operation unit 494 works out multi-valuation error 507 from correction level 504 and multi-valued data 506. Distribution coefficient generating unit 498 generates distribution coefficient 512 at specific intervals and outputs the same to error distribution update unit 497. Then, distribution coefficient of distribution coefficient generating unit 498 is controlled by second correction accumulation error 508 outputted from processing condition determining unit 495. Error distribution update unit 497 distributes multi-valuation error 507 according to distribution coefficient 512, and adds each distributed error to the respective pixel position for each unprocessed pixel adjacent to a target pixel stored in error storing unit 499 (or stored in error re-distribution determining unit 497), and updates the accumulation error.

In FIG. 23, all units can be materialized in the same configuration as described earlier. It is noted that processing condition determining unit 495 outputs first processing condition signal 514, second processing condition signal 508 and third processing condition signal 503. These signals may be outputted as different processing condition signals or may be all as the same processing condition signals form the lockup table shown in FIG. 14.

The present embodiment is so configured that processing condition determining unit 495 controls error re-distribution determining unit 496, distribution coefficient generating unit 498, data addition unit 491. Instead, at least one of them only may be controlled.

There will be described control of error re-distribution determining unit, distribution coefficient generating unit, data addition unit by 1 to 3 processing condition signals outputted from processing condition determining unit.

In a preferred embodiment, when highlight area and shadow area are detected in processing condition determining circuit A shown in FIG. 10, data addition unit 121 may increase addition density level. If the data level is a highlight or shadow level which indicates highlights or shadows not with three color components but with only one component. Error re-distribution determining unit may increase the ratio of the second correction accumulation error and the fluctuation in distribution parameter by distribution coefficient generating unit may be increased. Furthermore, when it is detected in processing condition determining circuit B that the target pixel is the maximum level or minimum level, data addition unit may make addition density level “0”, error re-distribution determining unit may make first correction accumulation error and second correction accumulation error “0” and distribution coefficient generating unit may make all distribution coefficients “0”. Furthermore, in case processing condition determining circuit C detects character, line drawing area, data addition unit may make addition density level “0”, error re-distribution determining unit may increase the ratio of first correction accumulation error, and distribution coefficient generating unit may make distribution coefficients not fluctuate. In addition, when an area is detected in processing condition determining circuit D where the granularity fluctuates violently as compared with the other area, data addition unit may increase additional density level, error re-distribution determining unit may increase the ratio of first correction accumulation error, distribution coefficient generating unit may fluctuate distribution coefficients violently.

As described, a high quality picture can be obtained without texture, with high sharpness in character, drawing line and good continuity of the impression of grain.

### Eleventh Embodiment

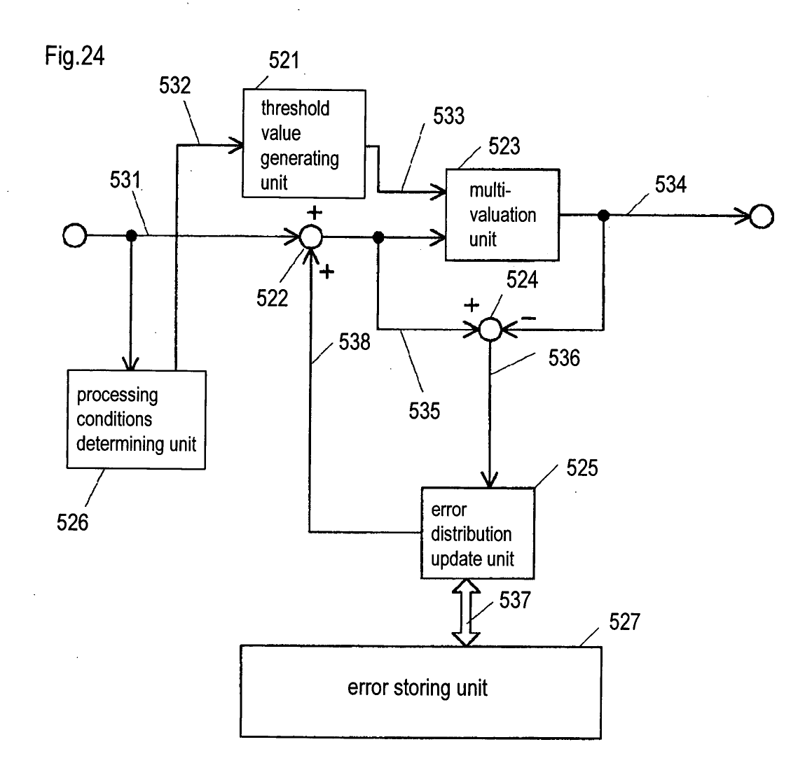

FIG. 24 is a block diagram of an image processing apparatus in the eleventh embodiment according to the present invention. The image processing apparatus shown in FIG. 24 is formed of threshold value generating unit 521, input correction unit 522, multi-valuation unit 523, difference operation unit 524, error distribution update unit 525, processing condition determining unit 526, and error storing unit 527.

Processing condition determining unit 526 outputs fourth processing condition signal 532 using the density level of the target pixel out of tone density levels 531 which are sampled from the original image by pixels. Threshold value generating unit 521 generates a plurality of threshold values 533 for multi-valuation using fourth processing condition signal 532 outputted from processing condition determining unit 526. Input correction unit 522 adds accumulation error 538 to input level 531, that is, density level of the target pixel and generates correction level 535. Multi-valuation unit 523 generates multi-valued data 534 from correction level 535 and a plurality of threshold values 533. Multi-valuation unit 523 generates multi-valued data 534 from correction level 535 and a plurality of threshold values 533. Difference operation unit 524 works out multi-valuation error 536 from correction level 535 and multi-valued data 534. Error distribution update unit 525 distributes multi-valuation error 536 according to the distribution coefficients, and adds each distributed error to the respective accumulation error 537 at the target pixel position for each unprocessed pixel adjacent to a target pixel stored in error storing unit 527 (or stored in error distribution update unit 525), and updates the accumulation error.

In FIG. 24, all units except for threshold value 521 can be materialized in the same configuration as described earlier. Fourth processing condition signal 532 outputted from processing condition determining unit 526 is a density level only at the target pixel in the present embodiment.

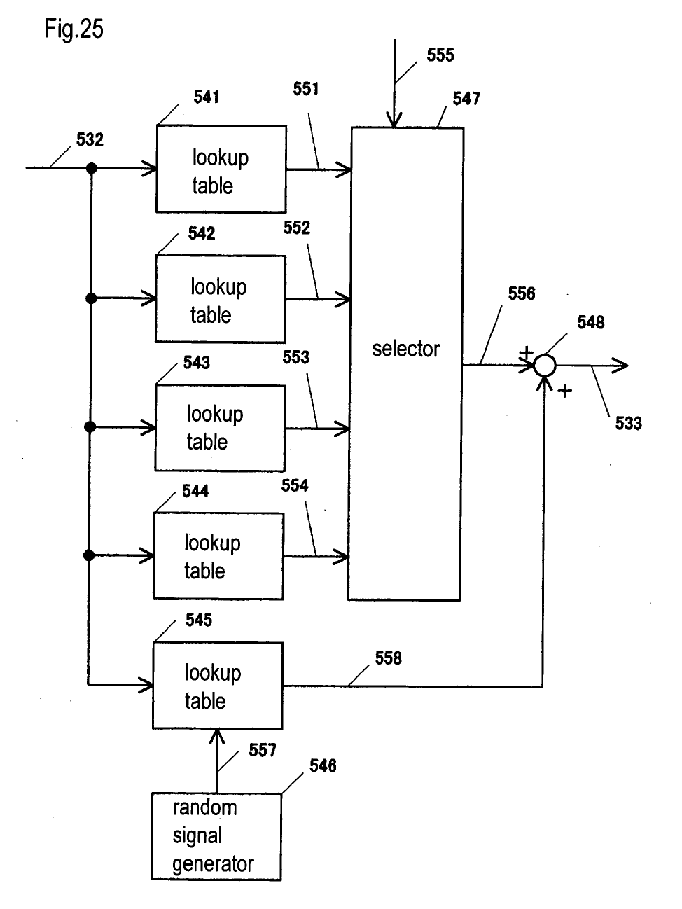

FIG. 25 is a block diagram of a threshold value generating circuit, an example of threshold value generating unit 521. Threshold value generating circuit shown in FIG. 25 is formed of lookup tables 541 to 545, selector 547, adder 548, and random signal generator 546.

Fourth processing condition signal 532 outputted from processing condition determining unit 526 is inputted into lookup tables 541 to 445. Lookup table 541 is a threshold value generating table for C (cyan) data, lookup table 542 is for M (magenta) and lookup table 543 is Y (yellow), and lookup table 544 is for K (black). Selector 547 selects any one of threshold values 551 to 554 outputted from lookup tables according to color information 555, and outputs the selected threshold. The signal line is shown in one line, but plural threshold values are outputted from the lookup tables.

Lookup table 545 outputs noise data 558, which is random in case of a specific density level, for example, from fourth processing condition signal 532 and random signal 557 outputted from random signal generator 546. Except for the specific density level, value “0” (noiseless) is outputted from lookup table 545.

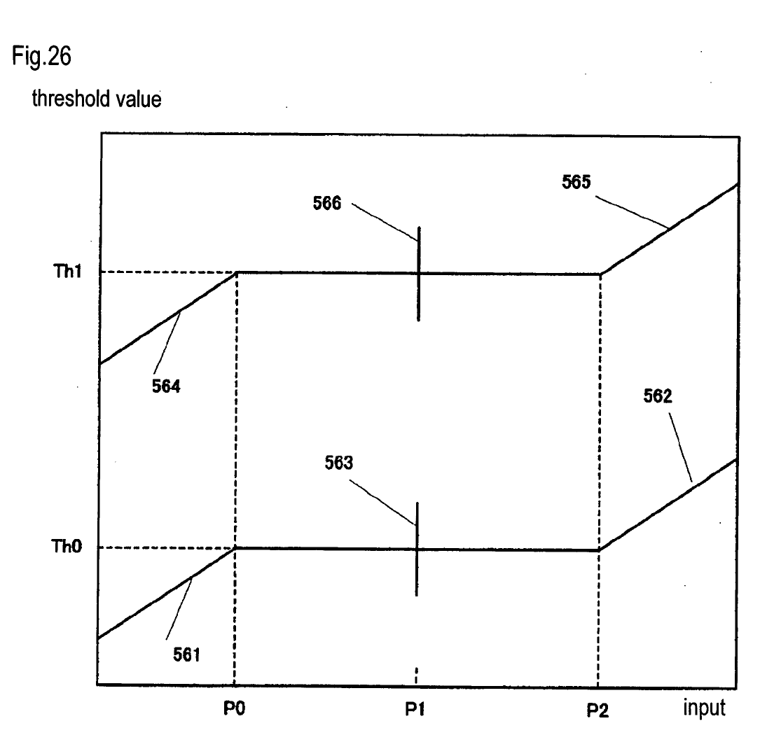

FIG. 26 is an explanatory diagram of threshold value in the present embodiment, in which data stored in the lookup table is shown in graph. The abscissa represents values of fourth processing condition ( be obtained.

In the present embodiment, the density level at the target pixel alone as fourth processing condition signal is used. In other embodiments, the target pixel alone does not necessarily have to be used.

The present embodiment is so configured that lookup tables 541 to 544 for four colors are prepared, and a threshold value for each color may be generated. It may so configured that a lookup table for one color alone is used.

Also, the present embodiment is so configured that a plurality of lookup tables 541 to 544 and selector 547 and adder 548 are used. The present embodiment is not limited to that. For example, instead of these, one lookup table may be used. Furthermore, it may be so configured that one threshold value for one color alone is different, and the threshold values for other colors are identical.

### Twelfth Embodiment

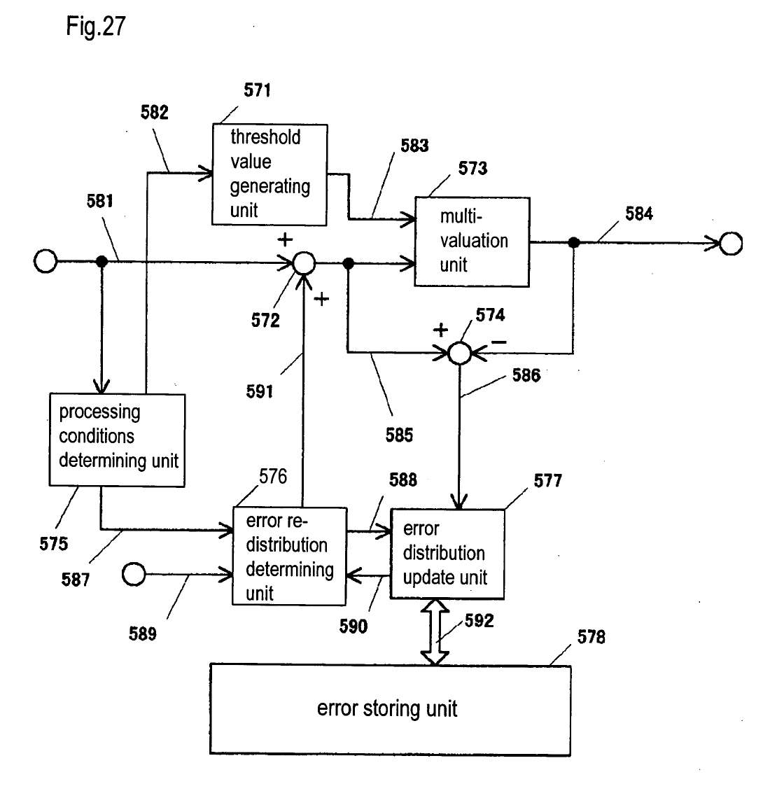

FIG. 27 is a block diagram of an image processing apparatus in the twelfth embodiment according to the present invention. The image processing apparatus shown in FIG. 27 is formed of threshold value generating unit 571, input correction unit 572, multi-valuation unit 573, difference operation unit 574, processing condition determining unit 575, error re-distribution determining unit 576, error distribution update unit 577 and error storing unit 578.

Processing condition determining unit 575 outputs first processing condition signal 587 and fourth processing condition signal 582, using the density level at or around the target pixel pieces of out of tone density level 581 which are sampled from the original image by pixels. Threshold value generating unit 571 generates a plurality of threshold values 583 for multi-valuation using fourth processing condition signal 582 outputted from processing condition determining unit 575. Error re-distribution determining unit 576 separates accumulation error 590 for the target pixel position into first correction accumulation error 591 and second correction accumulation error 588 on the basis of error distribution control signal 589 and first processing condition signal 587. Input correction unit 572 adds first correction accumulation error 591 to the density level of the target pixel or input level 581 and generates correction level 585. Multi-valuation unit 573 generates multi-valued data 584 from correction level 585 and a plurality of threshold values 583. Difference operation unit 574 works out multi-valuation error 586 from correction level 585 and multi-valued data 584. Error distribution update unit 577 distributes multi-valuation error 586 according to the distribution coefficients, and adds each distributed error to the respective accumulation error 592 at the pixel position for each unprocessed pixel adjacent to a target pixel stored in error storing unit 578 (or stored in error distribution update unit 577), and updates the accumulation error.

As described above the image processing apparatus, in the twelfth embodiment, consists of the threshold value generating unit 571, processing condition determining unit 575 and error re-distribution determining unit 576. In FIG. 27, all units can be materialized in the same configuration as described earlier.

### Thirteenth Embodiment

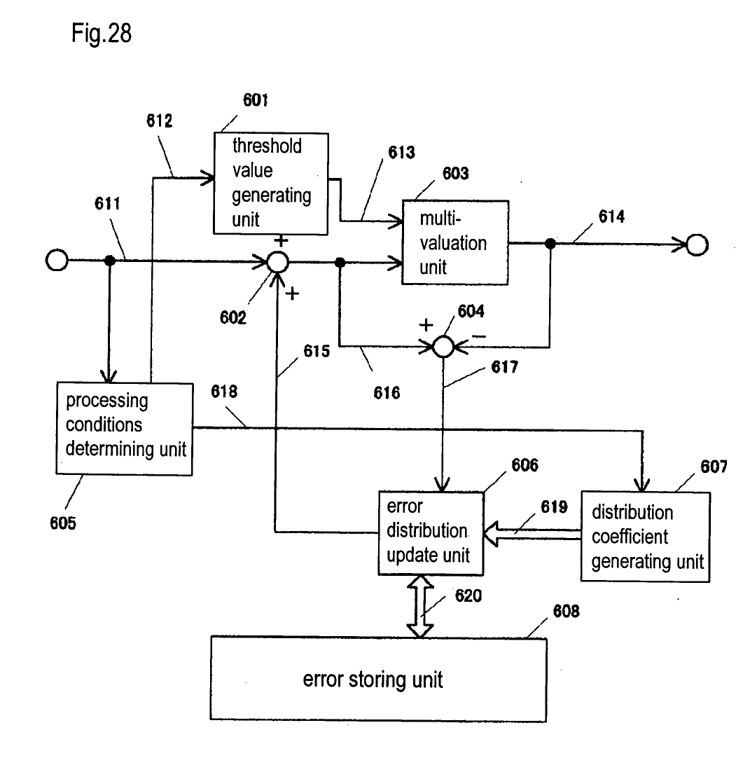

FIG. 28 is a block diagram of an image processing apparatus in the thirteenth embodiment according to the present invention. The image processing apparatus shown in FIG. 28 is formed of threshold value generating unit 601, input correction unit 602, multi-valuation unit 603, difference operation unit 604, processing condition determining unit 605, error distribution update unit 606, distribution coefficient generating unit 607, and error storing unit 608.

Processing condition determining unit 605 outputs second processing condition signal 618 and fourth processing condition signal 612, using the density level at or around the target pixel position out of tone density level 611 which are sampled from the original image by pixels. Threshold value generating unit 601 generates a plurality of threshold values 613 for multi-valuation using fourth processing condition signal 612 outputted from processing condition determining unit 605. Input correction unit 602 generates correction level 616 by adding accumulation error 615 to input level 611, that is, the density level at the target pixel. Multi-valuation unit 603 generates multi-valued data 614 from correction level 616 and a plurality of threshold values 613. Difference operation unit 604 works out multi-valuation error 617 from correction level 616 and multi-valued data 614. Distribution coefficient generating unit 607 generates distribution coefficients 619 at specific intervals and outputs the distribution coefficients 619 to error distribution update unit 606. In this, the distribution coefficients of distribution coefficient generating unit 606 is controlled by second processing condition signal 618 outputted from processing condition determining unit 605. Error distribution update unit 606 distributes multi-valuation error 617 according to the distribution coefficients 619 and adds each distributed error to the respective accumulation error 620 at the pixel position corresponding to each unprocessed pixel adjacent to a target pixel stored in error storing unit (or stored in error distribution update unit 606), and updates the accumulation error.

As described above the image processing apparatus, in the thirteenth embodiment, consists of the threshold value generating unit 601, processing condition determining unit 602 and error re-distribution determining unit 607. In FIG. 28, all units can be materialized in the same configuration as described earlier.

### Fourteenth Embodiment

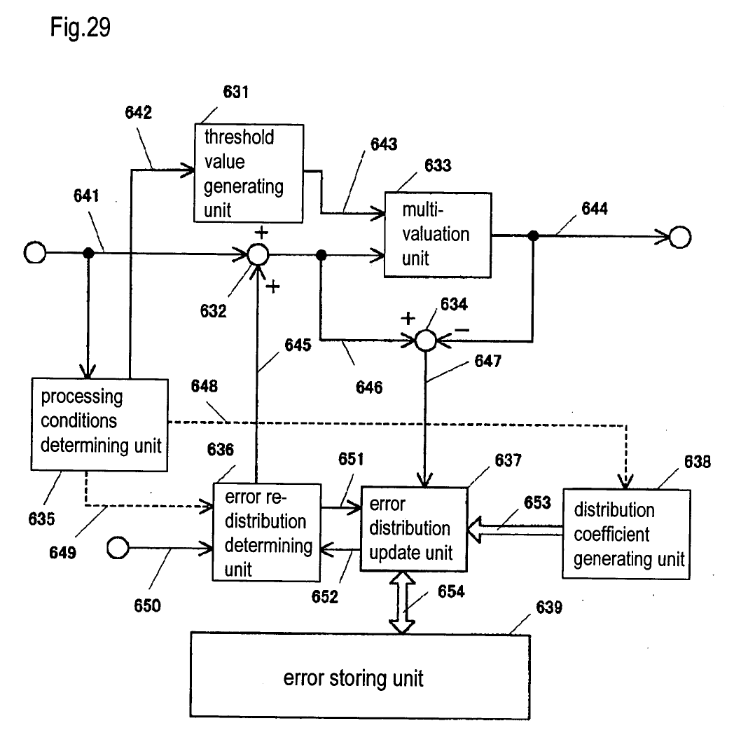

FIG. 29 is a block diagram of an image processing apparatus in the fourteenth embodiment according to the present invention. The image processing apparatus shown in FIG. 29 is formed of threshold value generating unit 631, input correction unit 632, multi-valuation unit 633, difference operation unit 634, processing condition determining unit 635, error re-distribution determining unit 636, error distribution update unit 637, distribution coefficient generating unit 638 and error distribution update unit 639.

Processing condition determining unit 635 outputs first processing condition signal 649, second processing condition signal 648, and fourth processing condition signal 642, using the density level at the target pixel or around the pixel position out of the tone density levels 641 which are sampled from the original image by pixels. Threshold value generating unit 631 generates a plurality of threshold values 643 for multi-valuation using fourth processing condition signal 642 outputted from processing condition determining unit 635. Error re-distribution determining unit 636 separates accumulation error 652 for the target pixel position into first correction accumulation error 645 and second correction accumulation error 651 on the basis of error distribution control signal 650 and first processing condition signal 649. Input correction unit 632 adds first correction accumulation error 645 to input level 641, that is, the density level of the target pixel and generates correction level 646. Difference operation unit 633 generates multi-valued data 644 from correction level 646 and a plurality of threshold values 643. Difference operation unit 634 works out multi-valuation error 647 from correction level 646 and multi-valued data 644. Distribution coefficient generating unit 638 generates distribution coefficient 653 at specific intervals and outputs the same to error distribution update unit 637. Then, distribution coefficient 653 of distribution coefficient generating unit 638 is controlled by second processing condition signal 648 outputted from processing condition determining unit 635. Error distribution update unit 637 distributes multi-valuation error 647 according to the distribution coefficients 653 and adds each distributed error to the respective accumulation error 654 at the pixel position corresponding to each unprocessed pixel adjacent to a target pixel stored in error storing unit 639 (or stored in error distribution update unit 637), and updates the accumulation error.

As described above the image processing apparatus, in the fourteenth embodiment, consists of the threshold value generating unit 631, processing condition determining unit 635, error re-distribution determining unit 636 and distribution coefficient generating unit 638. In FIG. 29, all units can be materialized in the same configurations as described earlier.

The present embodiment is so configured that threshold value generating unit 631, error re-distribution determining unit 636, and distribution coefficient generating unit 638 are all controlled by processing condition determining unit 635. Instead, it may be so configured that threshold value generating unit 631 and at least one of other unit only are controlled.

### Fifteenth Embodiment

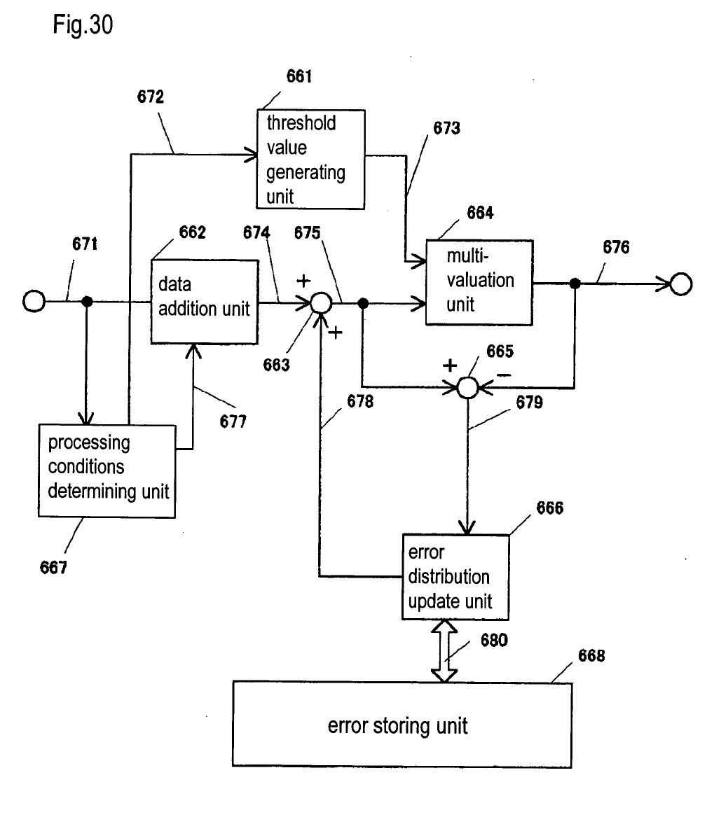

FIG. 30 is a block diagram of an image processing apparatus in the fifteenth embodiment according to the present invention. The image processing apparatus shown in FIG. 30 is formed of threshold value generating unit 661, data addition unit 662, input correction unit 663, multi-valuation unit 664, difference operation unit 665, error distribution update unit 666, error re-distribution determining unit 667, and error storing unit 668.

Processing condition determining unit 667 outputs third processing condition signal 677 and fourth processing condition signal 672, using the density level at or around the target pixel position out of the tone density levels 671 which are sampled from the original image by pixels. Threshold value generating unit 661 generates a plurality of threshold values 673 for multi-valuation using fourth processing condition signal 672 outputted from processing condition determining unit 667. Data addition unit 662 adds a density level fluctuating at specific intervals to density level 671 on the basis of third processing condition signal 677. Input correction unit 663 adds accumulation error 678 to input level 674 and generates correction level 675. Multi-valuation unit 664 generates multi-valued data 676 from correction level 675 and a plurality of threshold values 673. Difference operation unit 665 works out multi-valuation error 679 from correction level 675 and multi-valued data 676. Error distribution update unit 666 distributes multi-valuation error 679 according to the distribution coefficients, adds each distributed error to the respective accumulation error 680 at pixel position corresponding to unprocessed pixel adjacent to the target pixel stored in error storing unit 668 (or stored in error distribution update unit 666), and updates the accumulation error.

As described above the image processing apparatus, in the fifteenth embodiment, consists of the threshold value generating unit 661, data addition unit 662 and processing condition determining unit 667. In FIG. 30, all units can be materialized in the same configuration as described earlier.

### Sixteenth Embodiment

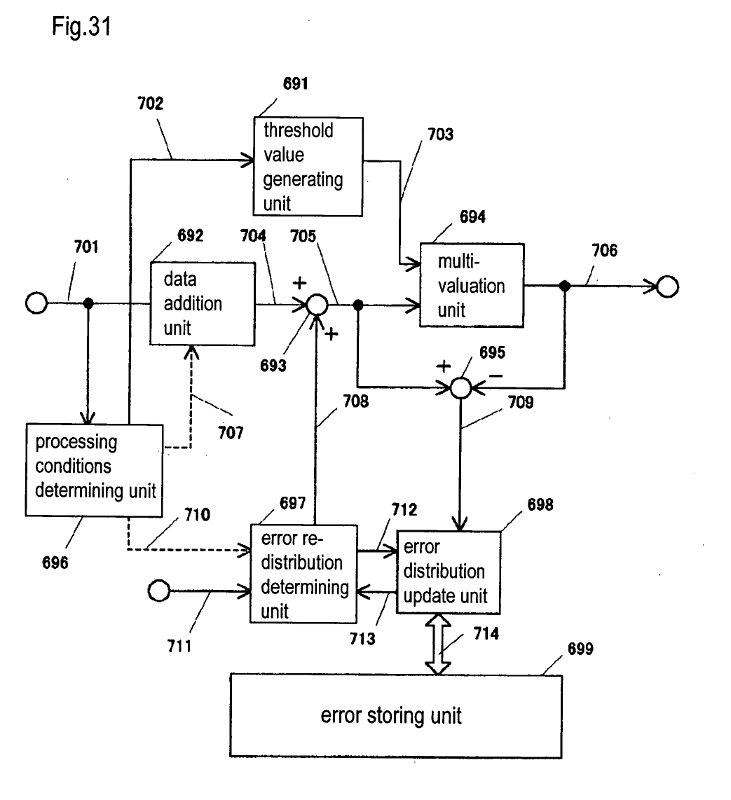

FIG. 31 is a block diagram of an image processing apparatus in the sixteenth embodiment according to the present invention. The image processing apparatus shown in FIG. 31 is formed of threshold value generating unit 691, data addition unit 692, input correction unit 693, multi-valuation unit 694, difference operation unit 695, processing condition determining unit 696, error re-distribution determining unit 697, error distribution update unit 698, and error storing unit 699.

Processing condition determining unit 696 outputs first processing condition signal 710, third processing condition signal 707 and fourth processing condition signal 702, using the density level at or around target pixel position out of the tone density levels 701 which are sampled from the original image by pixels. Threshold value generating unit 691 generates a plurality of threshold values 730 for multi-valuation using fourth processing condition signal 702 outputted from error re-distribution determining unit 696. Error re-distribution determining unit 697 separates accumulation error 713 corresponding to the target pixel position into error distribution control signal 711 and first processing condition signal 710. Data addition unit 692 adds a density level fluctuating at specific intervals to density level 701 on the basis of third processing condition signal 707, and generates input level 704. Input correction unit 693 adds first correction accumulation error 708 to input level 704 and generates correction level 705. Multi-valuation unit 694 generates multi-valued data 706 from correction level 705 and a plurality of threshold values 703. Difference operation unit 695 works out multi-valuation error 709 from correction level 705 and multi-valued data 706. Error distribution update unit 698 distributes multi-valuation error 709 according to the distribution coefficients, and add each distributed error to the respective accumulation error 714 at the pixel position for each unprocessed pixel adjacent to a target pixel stored in error storing unit (or stored in error distribution update unit 698), and updates the accumulation error.

As described above the image processing apparatus, in the sixteenth embodiment, consists of the threshold value generating unit 691, data addition unit 692, processing condition determining unit 696, and error re-distribution determining unit 697. In FIG. 31, all units can be materialized in the same configuration as described earlier.

The present embodiment is so configured that threshold value generating unit 691, error re-distribution determining unit 697 and data addition unit 692 are all controlled by processing condition determining unit 696. Instead, it may be so configured that threshold value generating unit 691 and at least one unit alone are controlled.

### Seventeenth Embodiment

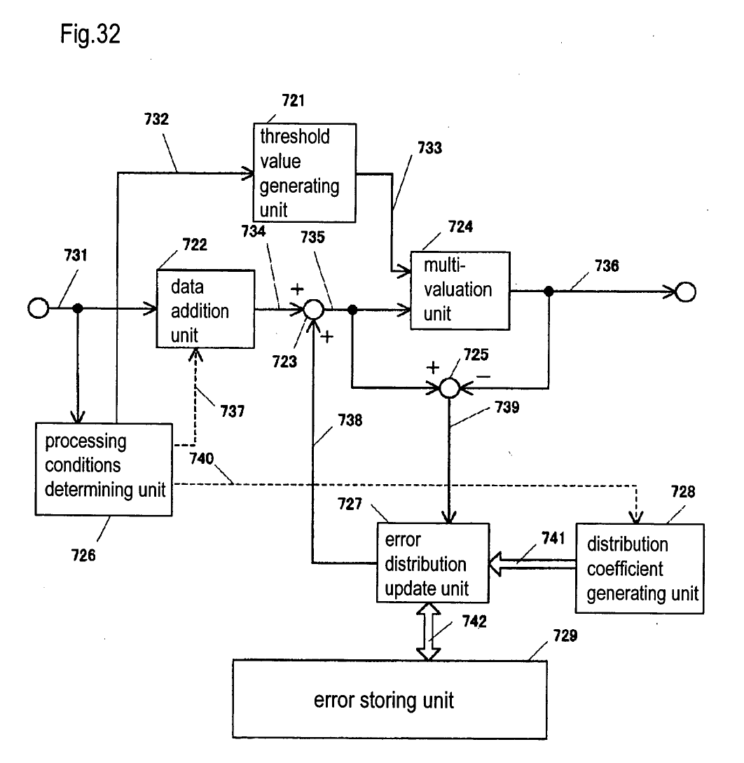

FIG. 32 is a block diagram of an image processing apparatus in the seventeenth embodiment according to the present invention. The image processing apparatus shown in FIG. 32 is formed of threshold value generating unit 721, data addition unit 722, input correction unit 723, multi-valuation unit 724, difference operation unit 725, processing condition determining unit 726, error distribution update unit 727, distribution coefficient generating unit 728 and error storing unit 729.

Processing condition determining unit 726 outputs second processing condition signal 740, third processing condition signal 737, and fourth processing condition signal 732, using the density level at or around the target pixel position out of the tone density levels 731 which are sampled from the original image by pixels. Threshold value generating unit 721 generates a plurality of threshold values 733 for multi-valuation using fourth processing condition signal 732 outputted from processing condition determining unit 726. Data addition unit 722 adds a density level fluctuating at specific intervals to density level 731 on the basis of third processing condition signal 737, and generates inputs level 734. Input correction unit adds accumulation error 738 to input level 734 and generates correction level 735. Multi-valuation unit 724 generates multi-valued data 736 from correction level 735 and a plurality of threshold values 733. Difference operation unit 739 works out multi-valuation error 739 from correction level 735 and multi-valued data 736. Distribution coefficient generating unit 728 generates distribution coefficient 741 at specific intervals, and outputs the same to error distribution update unit 727. Then, distribution coefficient 741 of distribution coefficient generating unit 728 is controlled by second processing condition signal 740 outputted from processing condition determining unit 726. Error distribution update unit 727 distributes multi-valuation error 739 according to the distribution coefficients 741, and adds each distributed error to the respective accumulation error 742 at the pixel position for each unprocessed pixel adjacent to a target pixel stored in error distribution update unit 729 (or stored in error distribution update unit 727), and updates the accumulation error.

As described above the image processing apparatus, in the seventeenth embodiment, consists of the threshold value generating unit 721, data addition unit 722, processing condition determining unit 726, and distribution coefficient generating unit 728. In FIG. 32, all units can be materialized in the same configurations as described earlier.

The present embodiment is so configured that threshold value generating unit 721, distribution coefficient generating unit 728, and data addition unit 722 are all controlled by processing condition determining unit 726. Instead, it may so configured that threshold value generating unit 721 and at least one unit alone are controlled.

### Eighteenth Embodiment

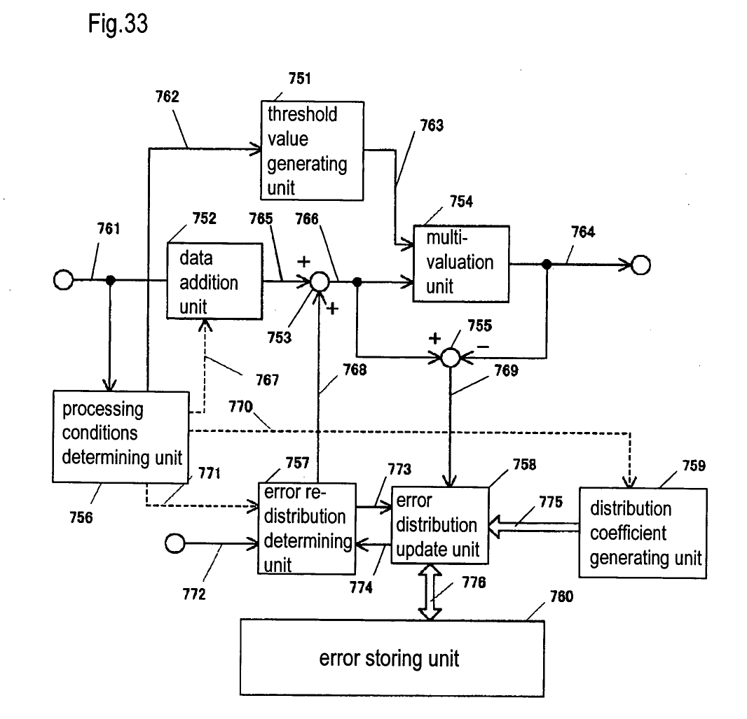

FIG. 33 is a block diagram of an image processing apparatus in the eighteenth embodiment according to the present invention. The image processing apparatus shown in FIG. 33 is formed of threshold value generating unit 751, data addition unit 752, input correction unit 753, multi-valuation unit 754, difference operation unit 755, processing condition determining unit 756, error re-distribution determining unit 757, error distribution update unit 758, distribution coefficient generating unit 759, and error storing unit 760.

Processing condition determining unit 756 outputs first processing condition signal 771, second processing condition signal 770, third processing condition signal 767 and fourth processing condition signal 762, using density level at or around the target pixel out of the tone density levels 761 which are sampled from the original image by pixels. Threshold value generating unit 751 generates a plurality of threshold values 763 for multi-valuation using fourth processing condition signal 762 outputted from processing condition determining unit 756. Error re-distribution determining unit 772 separates accumulation error 774 for the target pixel position into first correction accumulation error 768 and second correction accumulation error 773 on the basis of error distribution control signal 772 and first processing condition signal 771. Data addition unit 752 adds a density level fluctuating at specific intervals to density level 761 on the basis of third processing condition signal 767, and generates input level 765. Input correction unit 753 adds first correction accumulation error 768 to input level 765 and generates correction level 766. Multi-valuation unit 754 generates multi-valued data 764 from correction level 766 and a plurality of threshold values 763. Difference operation unit 755 works out multi-valuation error 769 from correction level 766 and multi-valued data 764. Distribution coefficient generating unit 759 generates distribution coefficient 775 at specific intervals and outputs the same to error distribution update unit 758. Then, the distribution coefficient of distribution coefficient generating unit 759 is controlled by second processing condition signal 770 outputted from processing condition determining unit 756. Error distribution update unit 758 distributes multi-valuation error 769 according to distribution coefficients 775, and adds each distributed error to the respective accumulation error 776 at the pixel position corresponding to each unprocessed pixel adjacent to a target pixel stored in error storing unit 760 (or stored in error distribution update unit 758), and updates the accumulation error.

As described above the image processing apparatus, in the eighteenth embodiment consists of the threshold value generating unit 751, data addition unit 752, processing condition determining unit 756, error re-distribution determining unit 757 and distribution coefficient generating unit 759. In FIG. 33, all units can be materialized in the same configurations as described earlier.

The present embodiment is so configured that threshold value generating unit 751, error re-distribution determining unit 757, distribution coefficient generating unit 759 and data addition unit 752 are all controlled by processing condition determining unit 756. Instead, it may be so configured that threshold value generating unit 751 and at least one alone of the other unit are controlled.

### Nineteenth Embodiment

The nineteenth embodiment to thirty-sixth embodiment are materialized with the first embodiment to the eighteenth embodiment as software (program for image processing).

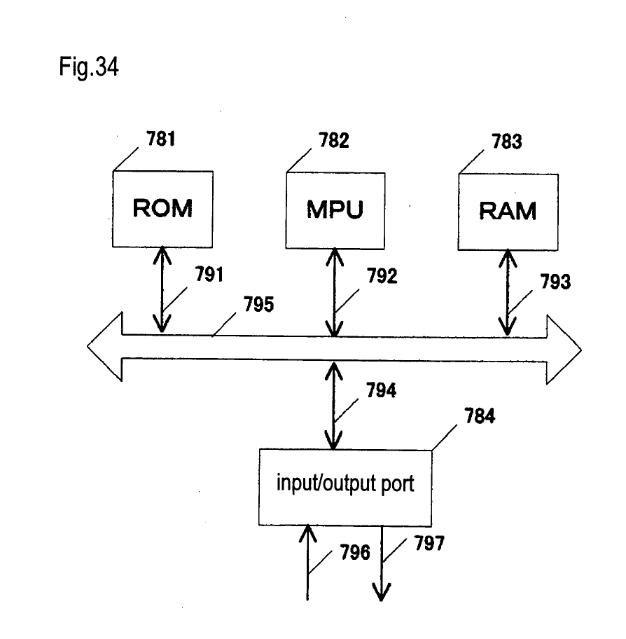

FIG. 34 is a block diagram of an MPU system to materialize the image processing method of the present invention by software. The MPU system shown in FIG. 34 is formed of MPU (micro processing unit) 782, ROM (read only memory) 781, RAM (random access memory) 783, input/output port 784. This MPU system is well known, and will be described briefly. MPU 782 executes a program for image processing stored in ROM 781 using RAM 783, as a working memory. Input/output port 784 does input 796 and output 797 of an image. Image data is transferred from input/output port 784 to RAM 783. According to a program for image processing of ROM, image processing is executed. As an alternative to that, the program for image processing may be transferred from input/output port to RAM 783 and executed on RAM. When processing is over, image data is outputted through input/output port 784. Image processing may be performed on a personal computer.

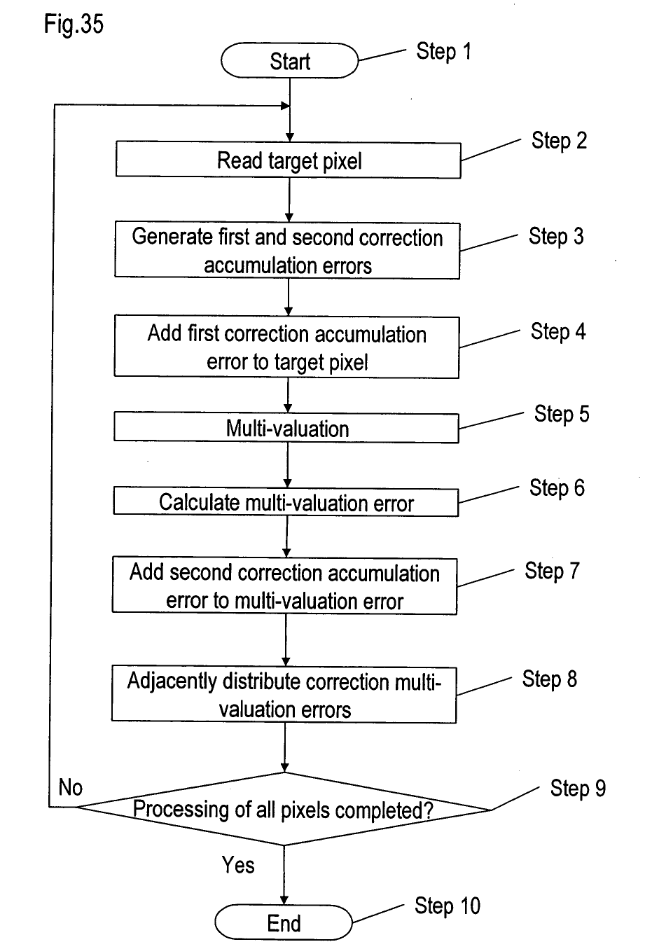

FIG. 35 is a flow chart of an image processing method in the nineteenth embodiment according to the present invention. The image processing method in the nineteenth embodiment is a method that is implemented as image processing program by software to carry out the processing corresponding to the function of image processing apparatus.

When the image processing method according to the present invention starts (Step 1), the density level of the target pixel is read in Step 2. In Step 3, the accumulation error for the target pixel position is separated into the first and second correction accumulation errors. As to the distribution ratio at which accumulation error is separated, information as to whether other color dots are stricken or not may be used. Also, when the first and second correction accumulation errors are worked out, second correction accumulation error may be generated only when the accumulation error is a positive number and smaller than a specific value. In Step 4, first correction accumulation error is added to the density level of the target pixel. The correction level obtained is multi-valuated in Step 5. In Step 6, multi-valuation error or difference between correction level and multi-valued level is worked out. In Step 7, second correction accumulation error is added to multi-valuation error obtained to generate a correction multi-valuation error. In step 8 the correction multi-valuation error is distributed according to distribution coefficients. And each accumulation error corresponding to each unprocessed pixel is updated by adding each distributed error to each accumulation error. When it is judged that the above Step 2 to 8 are repeated for each pixel (Step 9), the processing of this image ends (Step 10).

As set forth above, since the accumulation error for the target pixel position is separated into first and second correction accumulation errors, and added the first correction accumulation error to the density level of the original image, the density level of the target pixel can be made not larger than the original image when another color dot is presented as long as the error is not accumulated more than a specific value. Therefore, the overlapping of color dots can be kept down, and dots disperse, whereby the granularity will improve.

### Twentieth Embodiment

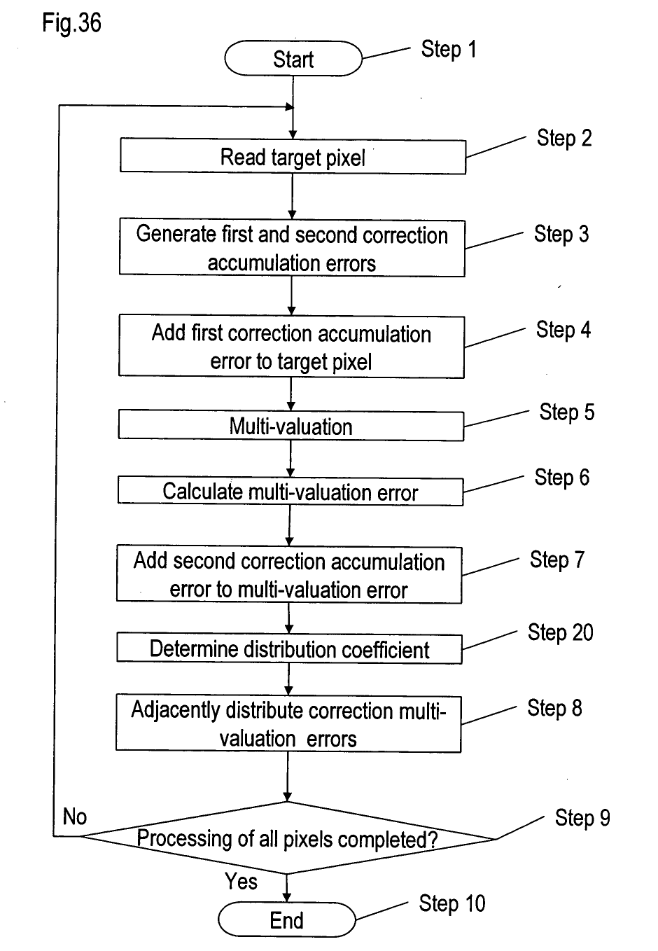

FIG. 36 is a flow chart of the image processing method in the twentieth embodiment according to the present invention. The image processing method in the twentieth embodiment is a method which is turned into software with the processing contents of the image processing apparatus in the second embodiment. The program according to this method will be executed by MPU system.

The present embodiment, as shown in FIG. 36 can be materialized by adding a new step 20 to the flow chart of the image processing method of the nineteenth embodiment shown in FIG. 35. Step 20 may be added before Step 8. In FIG. 36, Step 20 is added after Step 7. That is, in Step 7, second correction accumulation error is added to multi-valuation error, and after a correction multi-valuation error is generated, the correction multi-valuation error is distributed according to the distribution coefficients which are determined using the random function in Step 20. Instead of using the random function, a random value may be taken out of a table in processing with the table prepared in advance.

As set forth above, fluctuating the distribution coefficients can keep down occurrence of texture in addition to the effects of the nineteenth embodiment.

### Twenty-First Embodiment

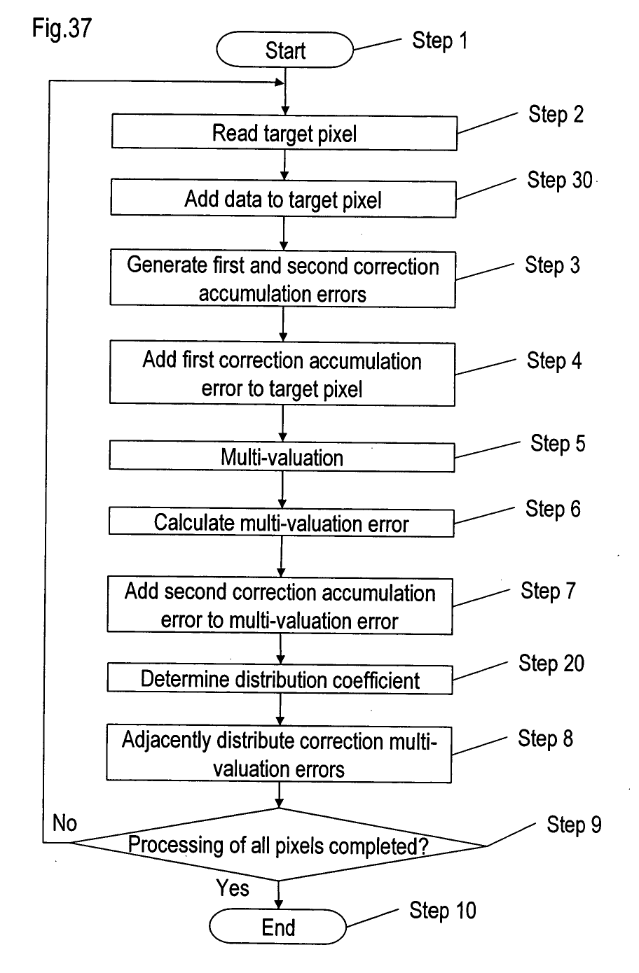

FIG. 37 is a flow chart of the image processing method in the twenty-first embodiment according to the present invention. The image processing method in the twenty-first embodiment is a method which is turned into software with the processing contents of the image processing apparatus in the third embodiment. The program according to this method will be executed by MPU system.

The present embodiment, as shown in FIG. 36 can be materialized by adding Step 30 between Step 2 (in the twentieth embodiment) and Step 3. That is, a density fluctuating at specific intervals is added to the density level of the target pixel read in Step 2. It is desirable that if all density levels of the respective factors in an area of a specific size are added together, the total value will be “0.”

As set forth above, if the density level at the target pixel and a different density level are added, it is possible to substantially keep down the texture for an image with small change in density and an image with a uniform density generated by computer in addition to effects of the twentieth embodiment.

### Twenty-Second Embodiment

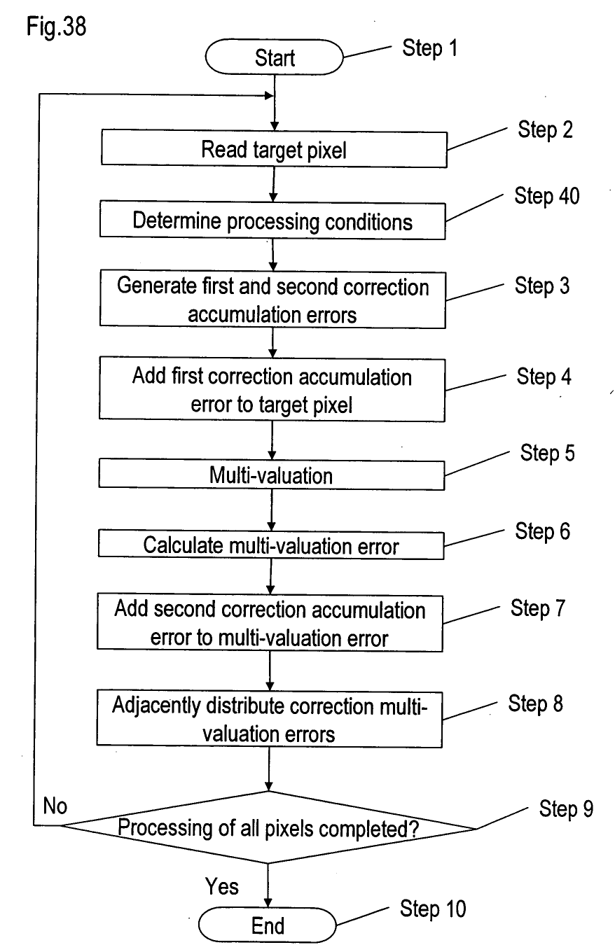

FIG. 38 is a flow chart of the image processing method in the twenty-second embodiment according to the present invention. The image processing method in the twenty-second embodiment is a method which is turned into software with the processing contents of the image processing apparatus in the fourth embodiment. The program according to this method will be executed by MPU system.

The present embodiment as shown in FIG. 38 can be materialized by adding Step 40 between Step 2 (in the nineteenth embodiment) and Step 3. That is, processing conditions are determined using the density levels at and around the target pixel read in Step 2. To be specific, a specific area in an image is detected using the density level at or around the target pixel. Among the specific areas in the image are high light area, shadow area, maximum density level (area), minimum density level (area), character, line drawing area, granularity decreasing area (described in the fourth embodiment. According to the results, the separation of first and second correction accumulation errors are controlled. That permits minute control of overlapping of color dots and keeps down occurrence of unnecessary dots.

### Twenty-Third Embodiment

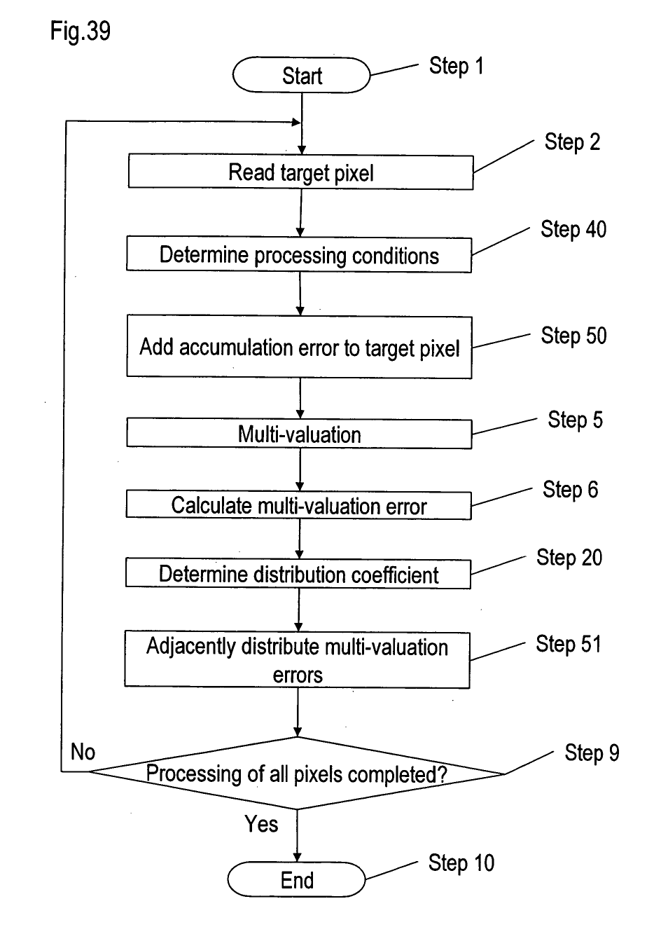

FIG. 39 is a flow chart of an image processing method in the twenty-third embodiment according to the present invention. The image processing method in the twenty-third embodiment is a method which is turned into software with the processing contents of the image processing apparatus in the fifth embodiment. The program according to this method will be executed by MPU system.

When the image processing method of the present invention, as shown in FIG. 39 starts (Step 1), the density level at the target pixel is read in Step 2. Then, processing conditions are determined in Step 40 using the target pixel. In Step 50, the accumulation error is added to the density level of the target pixel. The correction level obtained is multi-valuated in Step 5. In Step 6, the multi-valuation error, that is, difference between correction level and multi-valued level is worked out. In Step 20, the distribution coefficients according to which the multi-valuation error is distributed are determined using the random function. Then, as processing contents in the fifth embodiment, the method of generating distribution coefficients are changed depending on the processing conditions worked out in Step 40. In Step 51, multi-valuation error is distributed according to each distribution coefficient. And each distributed error is added to accumulation error for each position adjacent to the target pixel to update the accumulation error value. When processing of all pixels is over (Step 9), the present image processing ends (Step 10).

Processing conditions are determined using the target pixel, and the distribution coefficients are changed, and therefore occurrence of texture can be further kept down.

### Twenty-Fourth Embodiment

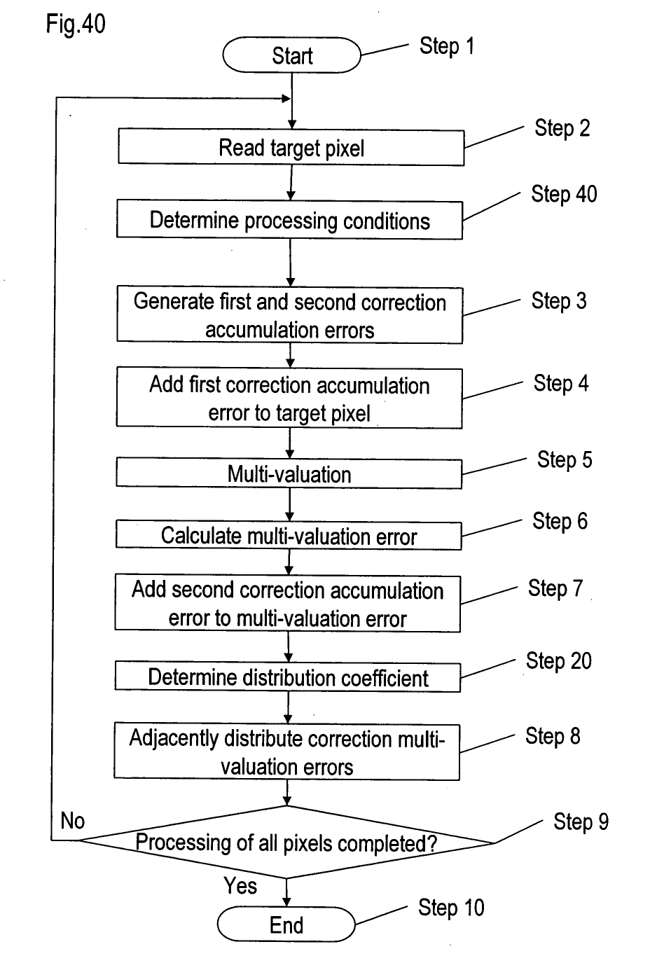

FIG. 40 is a flow chart of an image processing method in the twenty-fourth embodiment according to the present invention. The image processing method in the twenty-fourth embodiment is a method which is turned into software with the processing conditions of the image processing apparatus in the sixth embodiment. The program according to this method will be executed by MPU system.

The image processing method in the twenty-fourth embodiment is a method of the twentieth embodiment to which Step 40 is added as shown in FIG. 40. The Step 40 is the same as above explained. Since the processing condition is determined at Step 40 after Step 2, that permits to control the separation of first or second multi-valuation error and the fluctuation of distribution coefficients. Therefore, that keeps down occurrence of unnecessary dots and occurrence of texture.

### Twenty-Fifth Embodiment

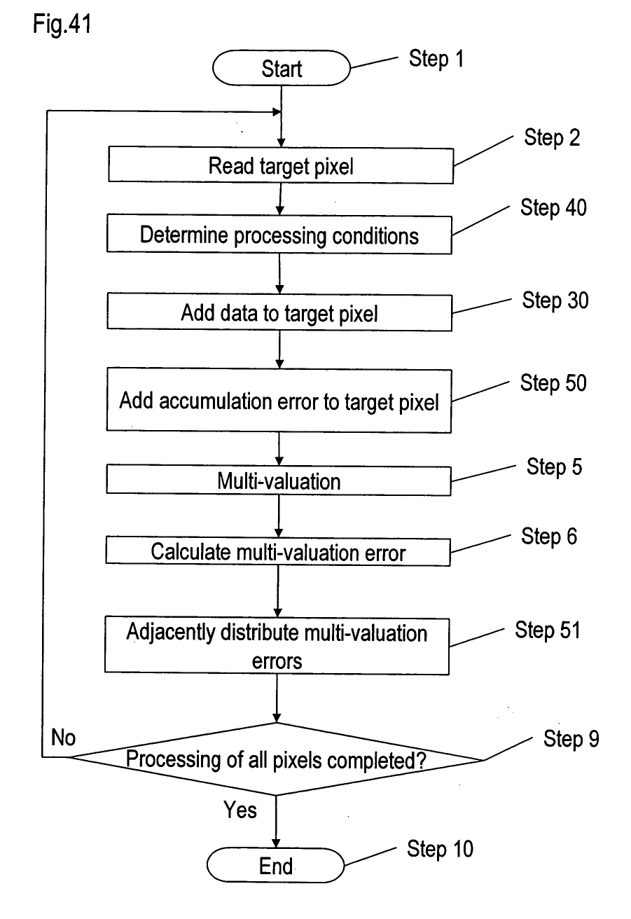

FIG. 41 is a flow chart of an image processing method in the twenty-fifth embodiment according to the present invention. The image processing method in the twenty-fifth embodiment is a method which is turned into software with the processing contents of the image processing apparatus in the seventh embodiment. The program according to this method will be executed by MPU system.

In the twenty-fifth embodiment, control of distribution coefficients depending on processing conditions in the twenty-third embodiment, shown in FIG. 41, is not performed but addition data to target pixel is controlled instead. This is materialized in Step 40 and Step 30. The data added in Step 30 is controlled by the processing condition determined in Step 40.

Since addition data to the target pixel is changed depending on the processing conditions, addition data according to the density level of input can be generated, and diffusion of dots can be improved on low density level and high density level.

### Twenty-Sixth Embodiment

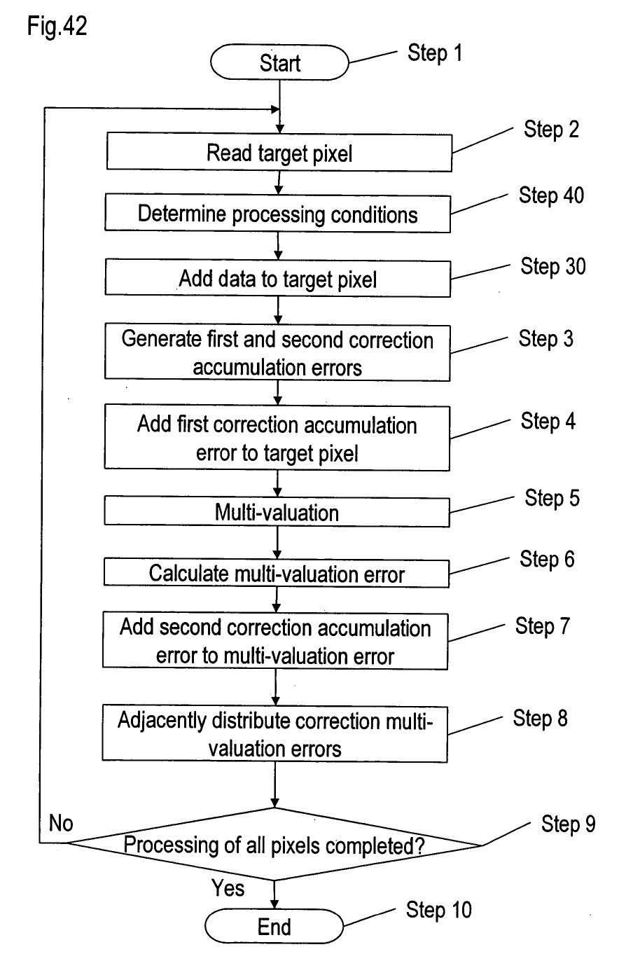

FIG. 42 is a flow chart of an image processing method in the twenty-sixth embodiment according to the present invention. The image processing method in the twenty-sixth embodiment is a method that is implemented as image processing program by software to carry out the processing corresponding to the function of image processing apparatus in the eighth embodiment. The program according to this method will be executed by MPU system.

In the twenty-sixth embodiment, Step 30 is added between Step 40 and Step 3 of the twenty-second embodiment, thereby the addition data to target pixel is controlled by the processing conditions as shown in FIG. 42. Therefore, addition data depending on the density level of input can be generated and diffusion of dots on low density level and high density level can be improved.

### Twenty-Seventh Embodiment

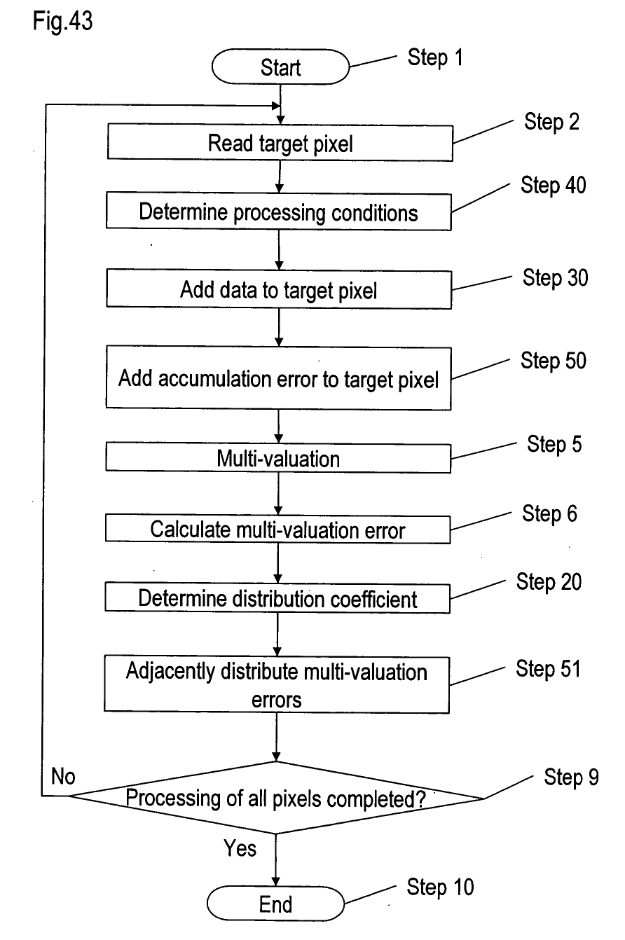

FIG. 43 is a flow chart of an image processing method in the twenty-seventh embodiment. The image processing method in the twenty-seventh embodiment is a method that is implemented as image processing program by software to carry out the processing corresponding to the function of image processing apparatus in the ninth embodiment. The program according to this method will be executed by MPU system.

In the twenty-seventh embodiment, Step 30 is added between Step 40 and Step 50 of the twenty-third embodiment, whereby the addition data to target pixel is controlled as shown in FIG. 43. Since addition data to the target pixel is changed depending on processing conditions, addition data according to the density level of input can be generated and diffusion of dots can be improved on low density level and high density level.

### Twenty-Eighth Embodiment

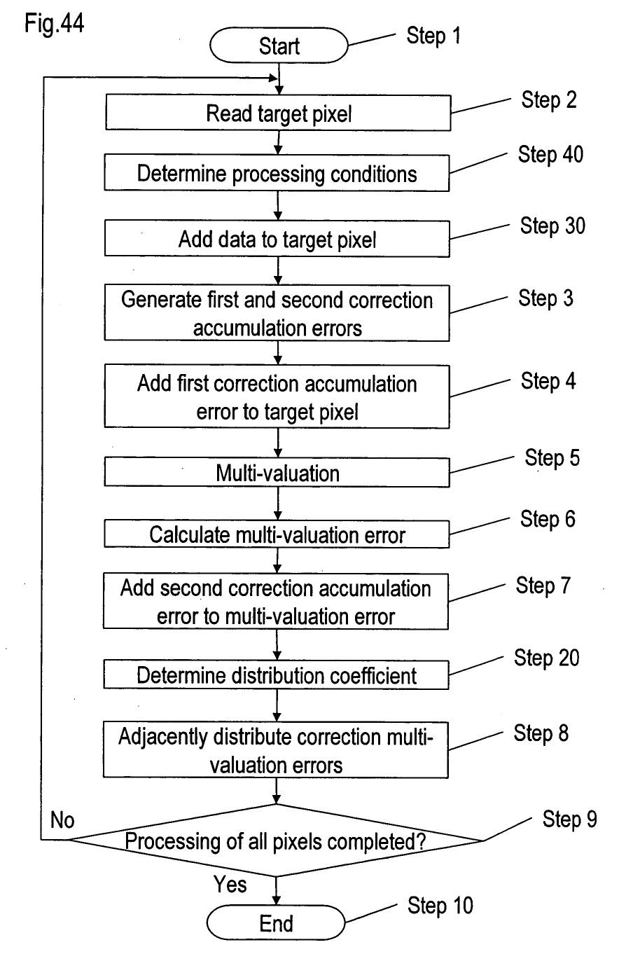

FIG. 44 is a flow chart of the image processing method in the twenty-eighth embodiment according to the present invention. The image processing method in the twenty-eighth embodiment is a method that is implemented as image processing program by software to carry out the processing corresponding to the function of image processing apparatus in the tenth embodiment. The program according to this method will be executed by MPU system.

Step 20 is added between Step 7 and Step 8 of the twenty-sixth embodiment, thereby controlling the generation of distribution coefficients. Since the distribution coefficients are changed depending on processing conditions, the occurrence of texture can be further kept down.

### Twenty-Ninth Embodiment

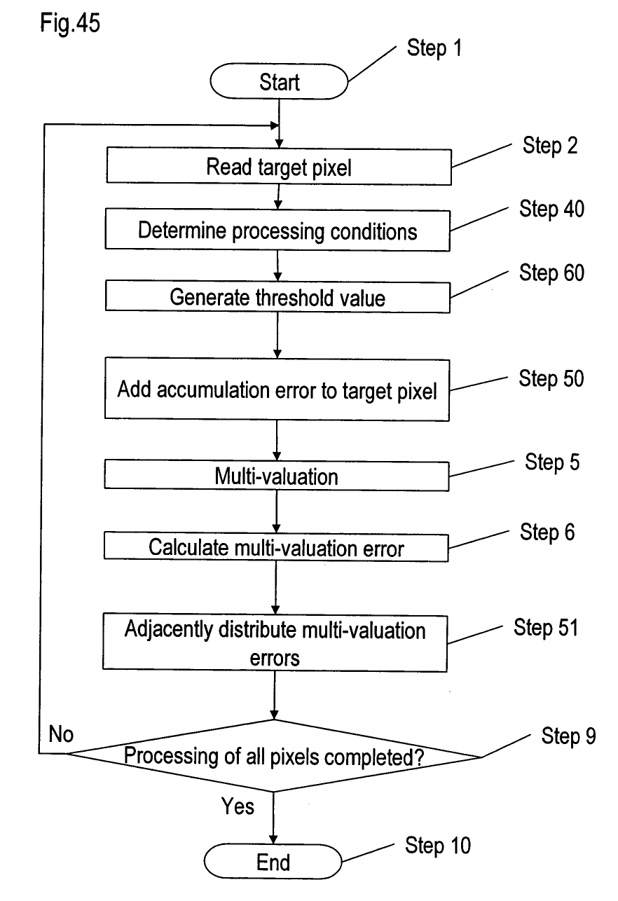

FIG. 45 is a flow chart of an image processing method in the twenty-ninth embodiment. The image processing method in the twenty-ninth embodiment is a method that is implemented as image processing program by software to carry out the processing corresponding to the function of image processing apparatus in the twenty-ninth embodiment. The program according to this method will be executed by MPU system.

The image processing method of the present invention, as shown in FIG. 45, starts (Step 1), and then the density level of the target pixel is read in Step 2. In the next step or Step 40, processing conditions are determined using only the density level of the target pixel. In Step 60, a plurality of threshold values for multi-valuation in Step 5 are generated. In Step 50, accumulation error is added to the density level of the target pixel to generate correction level. In Step 5, the correction level obtained is multi-valuated using a plurality of threshold values generated in Step 60. In Step 6, multi-valuation error or difference between correction level and multi-valued level is worked out. In Step 51, the multi-valuation error is distributed according to the distribution coefficients. And a distributed error out of the distributed errors is added to a accumulation error for the position adjacent to the target pixel to update the accumulation error. When it is judged that the above Step 2 to 8 are repeated for each pixel (Step 9), the processing of this image ends (Step 10).

Since the generation of the threshold value is controlled by processing conditions as described, the delay of dot can be kept down.

### Thirtieth Embodiment

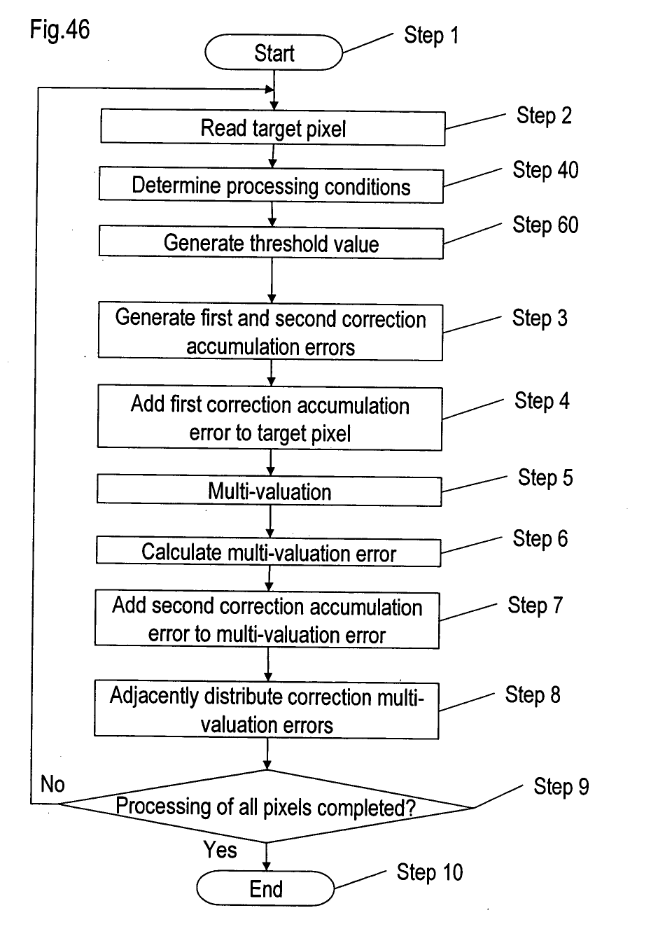

FIG. 46 is a flow chart of an image processing method in the thirtieth embodiment according to the present invention. The method in the thirtieth embodiment is a method that is implemented as image processing program by software to carry out the processing corresponding to the function of image processing apparatus in the twelfth embodiment. The program according to this method will be executed by MPU system.

The image processing method of the present invention as shown in FIG. 46 starts (Step 1), then the density level of the target pixel is read in Step 2. Then in Step 40, processing conditions are determined using the target pixel. In Step 60, threshold value for multi-valuation in Step 5 is generated according to the processing conditions. In Step 3, the accumulation error for the target pixel position is separated into first and second correction accumulation errors. When the accumulation error is separated, information as to whether another color dot is stricken or not is used as distribution ratio. Also in calculating first and second correction accumulation errors, only when accumulation error is a positive number not larger than a specific value, second correction accumulation error only may be generated. Then, depending on the processing conditions obtained in Step 40, separation of first and second correction accumulation errors is controlled. In Step 4, the first correction accumulation error is added to the density level of the target pixel to generate a correction level. In Step 5, the correction level obtained is multi-valuated using a plurality of threshold values generated in Step 60. In Step 6, the multi-valuation error, that is, the difference between the correction level and multi-valued level is calculated. In Step 7, the second correction accumulation error is added to the multi-valuation error obtained to generate a correction multi-valuation error. In Step 8, the correction multi-valuation error is distributed according to the distribution coefficients of the target pixel and added each distributed error to each accumulation error corresponding to the position adjacent to the target pixel. Thus the accumulation error is updated. When all pixels are processed (Step 9), the processing of this image ends (Step 10).

Since the generation of the threshold value is controlled by processing conditions as described, the delay of dot can be kept down. Furthermore, separation of first and second correction accumulation errors are controlled, and occurrence of unnecessary dots can be reduced.

### Thirty-First Embodiment

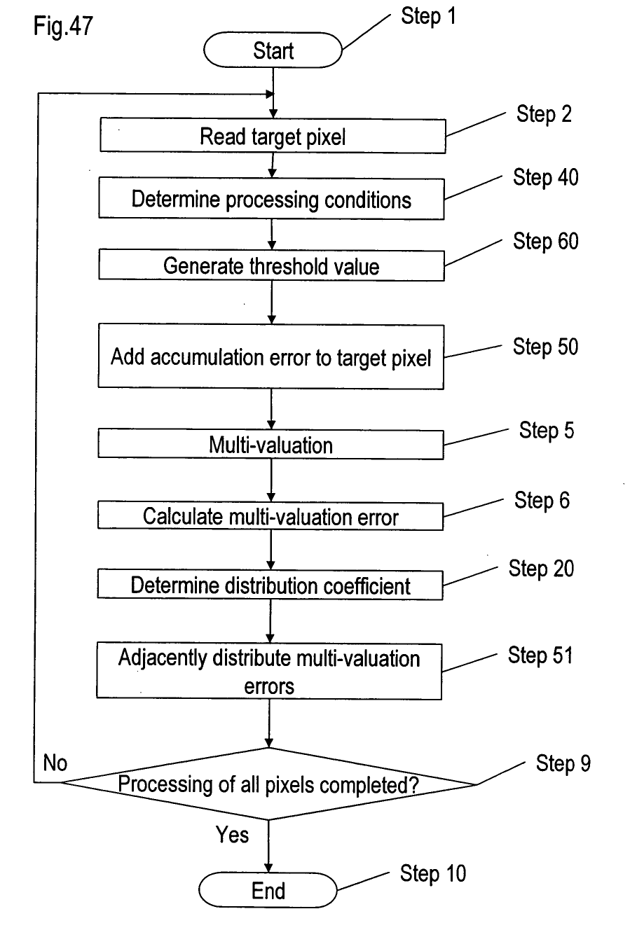

FIG. 47 is a flow chart of an image processing method in the thirty-first embodiment according to the present invention, a method that is implemented as image processing program by software to carry out the processing corresponding to the function of image processing apparatus in the thirty-first embodiment. The program according to this method will be executed by MPU system.

In the image processing method of the thirty-first embodiment, Step 20 is added between Step 6 and Step 51 of the twenty-ninth embodiment as shown in FIG. 47. In Step 20 the generation of the coefficients is controlled by the processing condition determined in Step 40. Since occurrence of distribution coefficients are controlled through processing conditions, the occurrence of texture can be further curbed.

### Thirty-Second Embodiment

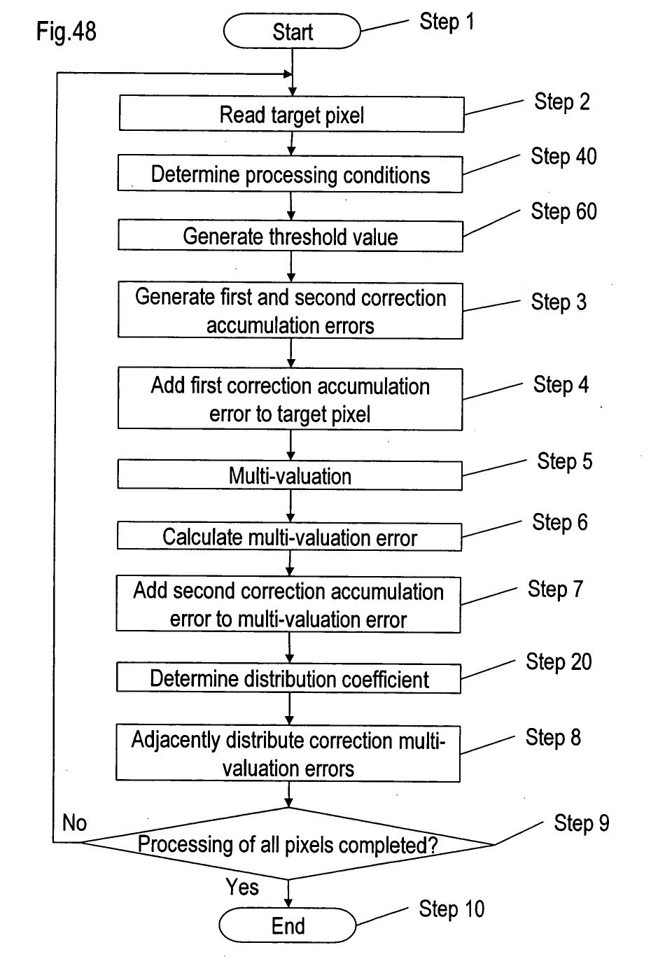

FIG. 48 is a flow chart of an image processing method in the thirty-second embodiment. The method in the thirty-second embodiment is a method that is implemented as image processing program by software to carry out the processing corresponding to the function of image processing apparatus in the fourteenth embodiment. The program according to this method will be executed by MPU system.

In the image processing method of the thirty-second embodiment, Step 20 is added between Step 7 and Step 8 of the thirtieth embodiment as shown in FIG. 48. In Step 20 the generation of the coefficients are controlled by the processing condition determined in Step 40. Since occurrence of distribution coefficients are controlled through processing conditions, the occurrence of texture can be further kept down. The program according to this method will be executed by MPU system.

### Thirty-Third Embodiment

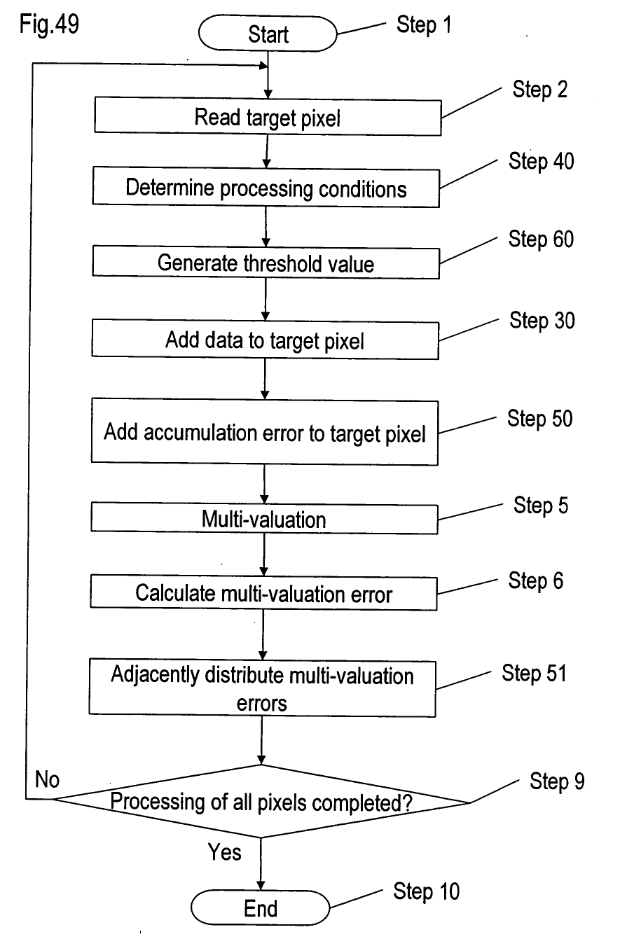

FIG. 49 is a flow chart of an image processing method in the thirty-third embodiment according to the present invention. The method in the thirty-third embodiment is a method that is implemented as image processing program by software to carry out the processing corresponding to the function of image processing apparatus in the fifteenth embodiment.

In the image processing method of the thirty-third embodiment, Step 30 is added between Step 60 and Step 50 of the twenty-ninth embodiment as shown in FIG. 49. The adding data obtained in Step 30 is controlled by the processing condition determined in Step 40. Since addition data to the target pixel is controlled through processing conditions, the diffusion of dot can be controlled minutely on the density level of target pixel.

### Thirty-Fourth Embodiment

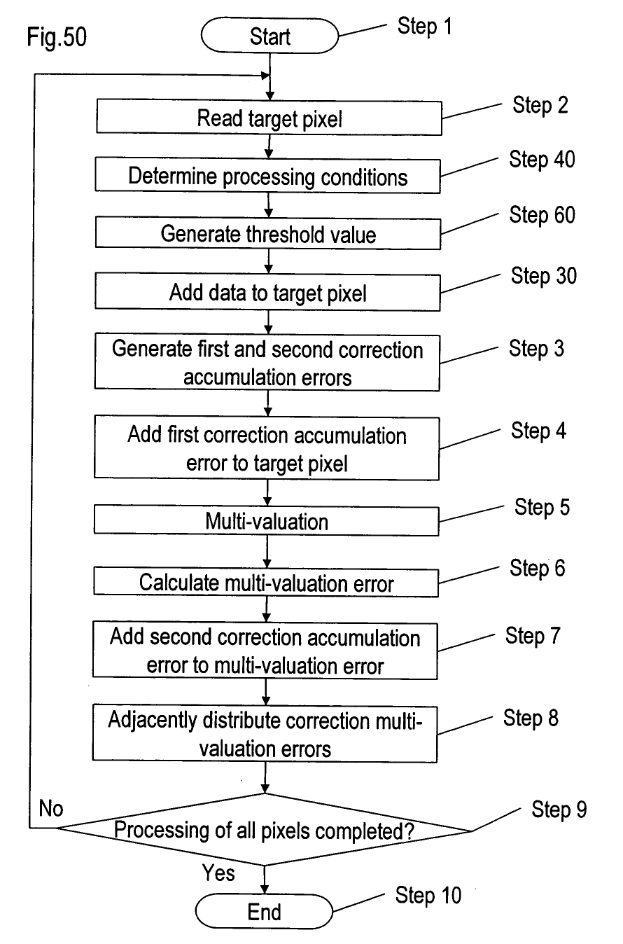

FIG. 50 is a flow chart of an image processing method in the thirty-fourth embodiment. The method in the thirty-fourth embodiment is a method that is implemented as image processing program by software to carry out the processing corresponding to the function of image processing apparatus in the sixteenth embodiment. The program according to this method will be executed by MPU system.

In the image processing method of the thirty-fourth embodiment, Step 30 is added between Step 60 and Step 3 of the thirteenth embodiment as shown in FIG. 50. The adding data obtained in Step 30 is controlled by the processing condition determined in Step 40. Since addition data to the target pixel is controlled depending on processing conditions, the diffusion of dots can be controlled minutely on the density level of target pixel.

### Thirty-Fifth Embodiment

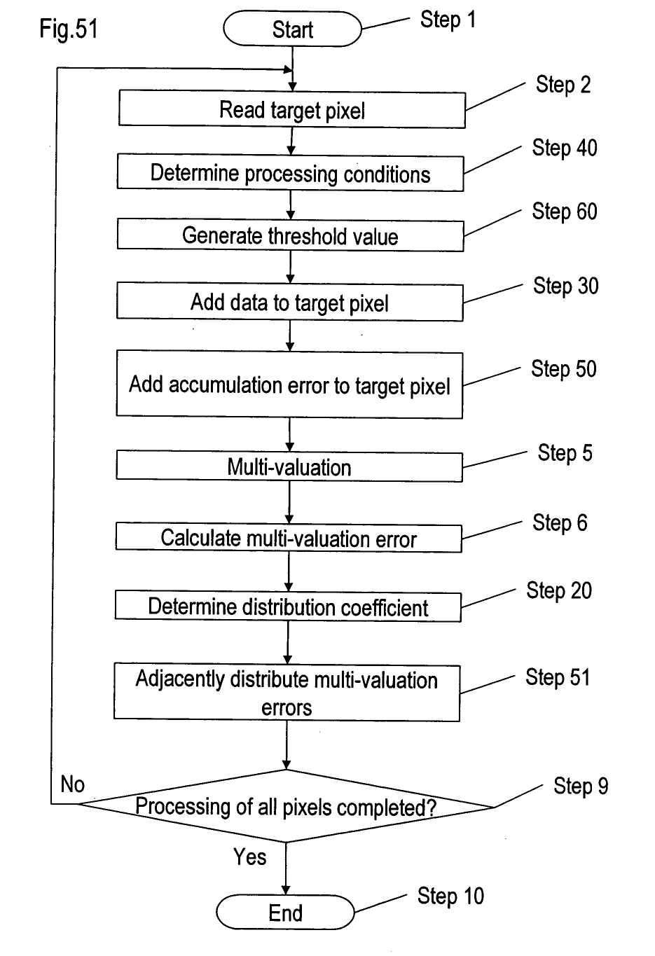

FIG. 51 is a flow chart of an image processing method in the thirty-fifth embodiment. The method in the thirty-fifth embodiment is a method that is implemented as image processing program by software to carry out the processing corresponding to the function of image processing apparatus in the seventeenth embodiment. The program according to this method will be executed by MPU system.

In the image processing method of the thirty-fifth embodiment, Step 20 is added between Step 6 and Step 51 of the thirty-third embodiment as shown in FIG. 51. In Step 20 the generation of the distribution coefficients is controlled by the processing condition determined in Step 40. Since the occurrence of distribution coefficients are controlled depending on processing conditions, occurrence of texture can be further curbed.

### Thirty-Sixth Embodiment

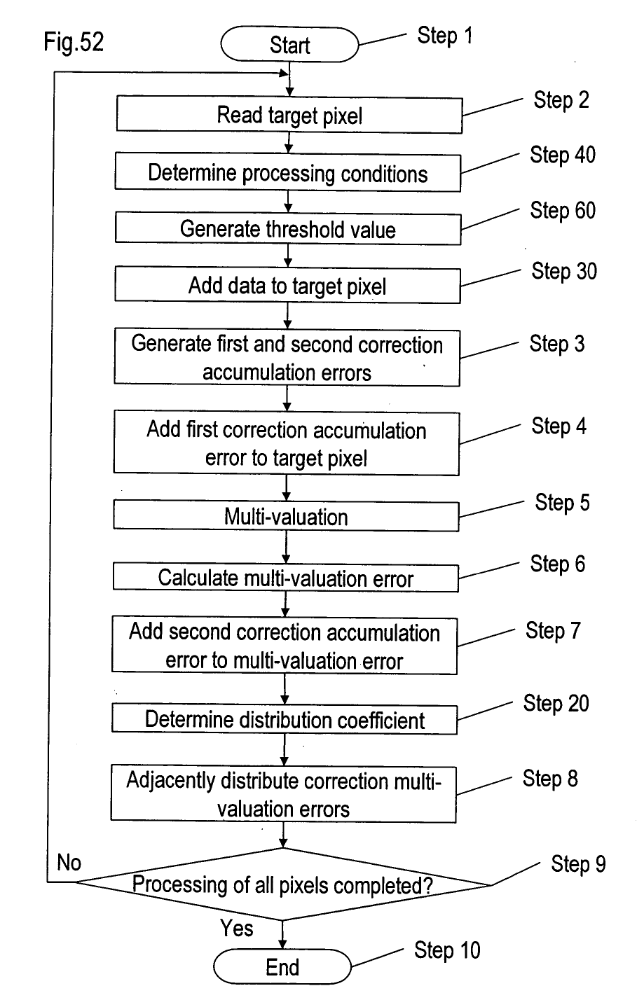

FIG. 52 is a flow chart of an image processing method in the thirty-sixth embodiment. The method in the thirty-sixth embodiment is a method that is implemented as image processing program by software to carry out the processing corresponding to the function of image processing apparatus in the eighteenth embodiment. The program according to this method will be executed by MPU system.

In the image processing method of the thirty-sixth embodiment, Step 20 is added between Step 7 and Step 8 of the thirty-fourth embodiment as shown in FIG. 52. In Step 20 the generation of the distribution coefficients is controlled by the processing condition determined in Step 40. Since the occurrence of distribution coefficients are controlled according to processing conditions, occurrence of texture can be further curbed.

In all multi-valuations of the present invention, a plurality of threshold values and correction level are compared. The present invention is not limited to this method. As an alternative to that, multi-valued data may be worked out using a lookup table. The table is referred to on the basis of correction level.

In the image processing apparatus in Embodiments according to the present invention, no synchronizing signal is shown. But the circuits may be synchronized as necessary to execute processing through pipeline.

It is also noted that as example of distribution coefficients, distribution coefficients shown in FIGS. 54C and 54B are used in embodiments according to the present invention. The present invention is not limited to that. As an alternative to that, distribution coefficients in FIG. 54D and (e) with different filter sizes may be used. Also, the present invention may be so configured that more than two distribution coefficients are switched.

In the processing condition determining circuit, that is, an embodiment of processing condition determining unit, processing conditions are determined using the target pixel and its adjacent pixels. Instead, using the target pixel alone, the processing conditions may be determined. In this case, the density level of the target pixel or the density level scope can be detected by combining a plurality of processing condition determining circuits B, and by information obtained, unit in the subsequent steps are controlled.

Also, the present invention is described using density level etc. taking recording systems as an example. As an alternative to that, a display system may be used. In that case, not density level but display systems such as RGB level or luminance level may be used.

In the Embodiments described, the present invention is applied to single image processing apparatus as central processing system. The present invention is not limited to that. For example, the present invention is applicable to an image processing system as diffusion processing system with an image output printer connected to a computer system such as image output printer.

According to the present invention, as set forth above, accumulation error for the target pixel is separated into first correction accumulation error and second correction accumulation error to control occurrence of dots. When another color dot is present, therefore, it is possible to see that the density level of the target pixel will not be larger than the original image. Through that, the overlapping of color dots can be curbed and dots disperse with good granularity. The present invention is also effective in keeping down diffusion of accumulation error and keep down occurrence of unnecessary dots.

Also, it is possible to keep down the occurrence of texture and improve the diffusion of dots by changing distribution coefficients of error at specific intervals and adding another data to data level on the target pixel.

Also, since it is possible to minutely control separation of accumulation error, interval of multi-valuation error distribution coefficients, distribution coefficients value of multi-valuation error, interval of addition density level at which is added the density level of the target pixel, quantity of addition density level, threshold value etc. by detecting a specific image area, image processing can be performed which is suitable for an area where it is desired that the granularity of image be enlarged or reduced. Through that, the picture quality will improve in character, line drawing area, highlight area, shadow area, and the continuity impression of grain in half tone area will improve and high picture quality can be obtained.

1. An image processing method for representing tone data sampled from an original image in pixels by multi-valued data, comprising the steps of:
separating an accumulation error for a position of a target pixel into a first correction accumulation error and a second correction accumulation error;
generating a correction level by adding the first correction accumulation error to a data level of the target pixel;
determining a multi-valued level of the correction level;
computing a multi-valuation error that is a difference between the correction level and the multi-valued level;
computing a correction multi-valuation error by adding the second correction accumulation error to the multi-valuation error;
computing an error distribution value for an unprocessed pixel around the target pixel from the correction multi-valuation error using a predetermined distribution coefficient; and
adding the error distribution value to an accumulation error for a position of the unprocessed pixel to update the accumulation error.

2-3. (canceled)

4. An image processing method for representing tone data sampled from an original image in pixels by multi-valued data, comprising the steps of:
determining processing conditions using a data level of a target pixel;
separating an accumulation error for a position of the target pixel into a first correction accumulation error and a second correction accumulation error;
generating a correction level by adding the first correction accumulation error to a data level of the target pixel;
determining a multi-valued level of the correction level;
computing a multi-valuation error that is a difference between the correction level and the multi-valued level;
computing a correction multi-valuation error by adding the second correction accumulation error to the multi-valuation error;
computing an error distribution value for an unprocessed pixel around the target pixel from the correction multi-valuation error using a predetermined distribution coefficient;
adding the error distribution value to an accumulation error for a position of the unprocessed pixel to update the accumulation error; and wherein
the separation into the first correction accumulation error and the second correction accumulation error is controlled using the processing conditions.

5-7. (canceled)

8. An image processing method for representing tone data sampled from an original image in pixels by multi-valued data, comprising the steps of:
determining processing conditions using a data level of a target pixel;
obtaining an input level of the target pixel by adding a predetermined data level for the target pixel;
separating an accumulation error for a position of the target pixel into a first correction accumulation error and a second correction accumulation error;
generating a correction level by adding the first correction accumulation error to the input level;
determining a multi-valued level of the correction level;
computing a multi-valuation error that is a difference between the correction level and the multi-valued level;
computing a correction multi-valuation error by adding the second correction accumulation error to the multi-valuation error;
computing an error distribution value for an unprocessed pixel around the target pixel from the correction multi-valuation error using a predetermined distribution coefficient;
adding the error distribution value to an accumulation error for a position of the unprocessed pixel to update the accumulation error; and wherein
at least one of the predetermined data level and the separation into the first correction accumulation error and the second correction accumulation error is controlled using the processing conditions.

9-16. (canceled)

17. An image processing method for representing tone data sampled from an original image in pixels by multi-valued data, comprising the steps of:
determining processing conditions using a data level of a target pixel;
obtaining an input level of the target pixel by adding a predetermined data level for the target pixel;
generating a correction level by adding an accumulation error for a position of the target pixel to the input level;
determining a multi-valued level of the correction level using a fluctuating threshold value;
computing a multi-valuation error that is a difference between the correction level and the multi-valued level;
computing an error distribution value for an unprocessed pixel around the target pixel from the multi-valuation error using a distribution coefficient that changes in a specific cycle;
adding the error distribution value to an accumulation error for a position of the unprocessed pixel to update the accumulation error; and wherein
the threshold value is generated on the basis of the processing conditions, and
at least one of the distribution coefficient and the predetermined data level is controlled using the processing conditions.

18. An image processing method for representing tone data sampled from an original image in pixels by multi-valued data, comprising the steps of:
determining processing conditions using a data level of a target pixel;
obtaining an input level of the target level by adding a predetermined data level for the target pixel;
separating an accumulation error for a position of the target pixel into a first correction accumulation error and a second correction accumulation error;
generating a correction level by adding the first correction accumulation error to the input level;
determining a multi-valued level of the correction level using a fluctuating threshold value;
computing a multi-valuation error that is a difference between the correction level and the multi-valued level;
computing a correction multi-valuation error by adding the second correction accumulation error to the multi-valuation error;
computing an error distribution value for an unprocessed pixel around the target pixel from the correction multi-valuation error using a distribution coefficient that changes in a specific cycle;
adding the error distribution value to an accumulation error for a position of the unprocessed pixel to update the accumulation error; and wherein
the threshold value is generated on the basis of the processing conditions, and
at least one of the distribution coefficient, the predetermined data level, and the separation into the first correction accumulation error and the second correction accumulation error is controlled using the processing conditions.

19. The image processing method of any one of claims 4, 8, 17 and 18 wherein the processing conditions are determined on the basis of results for detecting an area including a highlight area or a shadow area of at least one color data level.

20-23. (canceled)

24. The image processing method of claim 1, 4, 8, or 18 wherein the separation is controlled by multi-valued data for other color at the same pixel position.

25-26. (canceled)

27. The image processing method of claim 17 or 18 wherein the predetermined cycle of the distribution coefficient fluctuates according to the processing conditions.

28. The image processing method of claim 17 or 18 wherein the error distribution value of the distribution coefficient fluctuates according to the processing conditions.

29. The image processing method of claim 17 or 18 wherein a filter size of distribution coefficients fluctuates according to the processing conditions.

30. The image processing method of claim 18 wherein the distribution coefficient comes in two kinds, one for the second correction accumulation error and the other for the multi-valuation error.

31. The image processing method of claim 18 wherein the data level to be added to the input level is changed according to color.

32. The image processing method of any one of claims 8, 17 and 18 wherein the predetermined data level is added to only a specific data level of the original image on the basis of the processing conditions.

33. The image processing method of claim 32 wherein the specific data level is a high level that becomes highlighted when the number of colors is at least one color, or a shadow level that becomes a shadow when the number of colors is least one color.

34-37. (canceled)

38. The image processing method of claim 17 or 18 wherein in case a threshold value is generated on the basis of the processing conditions, a threshold value in one color is differentiated from a threshold value in another color.

39. An image processing apparatus comprising:
an error storing unit operable to store a multi-valuation error of a target pixel by relating the multi-valuation error to pixel positions around the target pixel when tone data sampled from an original image by pixels is multi-valuated;
an error re-distribution determining unit operable to separate an accumulation error for a position of the target pixel into a first correction accumulation error and a second correction accumulation error;
an input correction unit operable to add an input level that is the data level of the target pixel and the first correction accumulation error together;
a multi-valuation unit operable to determine a multi-valued level of a correction level outputted from the input correction unit;
a difference operation unit operable to find the multi-valuation error that is the difference between the correction level and the multi-valued level; and
an error distribution update unit operable to update an accumulation error by computing an error distribution value for an unprocessed pixel around the target pixel from the multi-valuation error and the second correction accumulation error using a distribution coefficient, and add the error distribution value to the accumulation error for a position of the unprocessed pixel, with the accumulation error being stored in the error storing unit.

40-41. (canceled)

42. An image processing apparatus comprising:
an error storing unit operable to store a multi-valuation error of a target pixel by relating the multi-valuation error to pixel positions around the target pixel when tone data sampled from an original image by pixels is multi-valuated;
a processing conditions determining unit operable to determine processing conditions using the data level of the target pixel;
an error re-distribution determining unit operable to separate an accumulation error for a position of the target pixel into a first correction accumulation error and a second correction accumulation error;
an input correction unit operable to add an input level that is the data level of the target pixel and the first correction accumulation error together;
a multi-valuation unit operable to determine a multi-valued level of a correction level outputted from the input correction unit;
a difference operation unit operable to find the multi-valuation error that is the difference between the correction level and the multi-valued level;
an error distribution update unit operable to update an accumulation error by computing an error distribution value for an unprocessed pixel around the target pixel from the multi-valuation error and the second correction accumulation error using a distribution coefficient, and add the error distribution value to the accumulation error for a position of the unprocessed pixel, with the accumulation error being stored in the error storing unit; and wherein
the separation into the first correction accumulation error and the second correction accumulation error is controlled using the processing conditions.

43-45. (canceled)

46. An image processing apparatus comprising:
an error storing unit operable to store a multi-valuation error of a target pixel by relating the multi-valuation error to pixel positions around the target pixel when tone data sampled from an original image by pixels is multi-valuated;
a processing conditions determining unit operable to determine processing conditions using the data level of the target pixel;
a data addition unit operable to add a predetermined data level to the data level of the original image to give an input level of the target pixel;
an error re-distribution determining unit operable to separate an accumulation error for a position of the target pixel into a first correction accumulation error and a second correction accumulation error;
an input correction unit operable to add the first correction accumulation error to the input level;
a multi-valuation unit operable to determine a multi-valued level of a correction level outputted from the input correction unit;
a difference operation unit operable to find the multi-valuation error that is the difference between the correction level and the multi-valued level;
an error distribution update unit operable to update an accumulation error by computing an error distribution value for an unprocessed pixel around the target pixel from the multi-valuation error and the second correction accumulation error using a distribution coefficient, and add the error distribution value to the accumulation error for a position of the unprocessed pixel, with the error distribution value being stored in the error storing unit; and wherein
at least one of the separation into the first correction accumulation error and the second correction accumulation error, and the predetermined data level to be added by the data addition unit is controlled using the processing conditions.

47-54. (canceled)

55. An image processing apparatus comprising:
an error storing unit operable to store a multi-valuation error of a target pixel by relating the multi-valuation error to pixel positions around the target pixel when tone data sampled from an original image by pixels is multi-valuated;
a processing conditions determining unit operable to determine processing conditions using the data level of the target pixel;
a data addition unit operable to add a predetermined data level to the data level of the original image to give an input level of the target pixel;
an input correction unit operable to add an accumulation error for a position of the target pixel to the input level;
a threshold value generating unit operable to generate a threshold value for multi-valuation using the processing conditions;
a multi-valuation unit operable to determine a multi-valued level of a correction level outputted from the input correction unit using the threshold value outputted from the threshold value generating unit;
a difference operation unit operable to find the multi-valuation error that is the difference between the correction level and the multi-valued level;
an error distribution update unit operable to update an accumulation error by computing an error distribution value for an unprocessed pixel around the target pixel from the multi-valuation error using a distribution coefficient, and add the error distribution value to the accumulation error for a position of the unprocessed pixel, with the accumulation error being stored in the error storing unit;
a distribution coefficient generating unit operable to generate the distribution coefficient used by the error distribution update unit while changing the distribution coefficient in a predetermined cycle; and wherein
at least one of the predetermined data level to be added by the data addition unit and the distribution coefficient is controlled using the processing conditions.

56. An image processing apparatus comprising:
an error storing unit operable to store a multi-valuation error of a target pixel by relating the multi-valuation error to pixel positions around the target pixel when tone data sampled from an original image by pixels is multi-valuated;
a processing conditions determining unit operable to determine processing conditions using the data level of the target pixel;
a data addition unit operable to add a predetermined data level to the data level of the original image to give an input level of the target pixel;
an error re-distribution determining unit operable to separate an accumulation error for a position of the target pixel into a first correction accumulation error and a second correction accumulation error;
an input correction unit operable to add the first correction accumulation error to the input level;
a threshold value generating unit operable to generate a threshold value for multi-valuation using the processing conditions;
a multi-valuation unit operable to determine a multi-valued level of a correction level outputted from the input correction unit using the threshold value outputted from the threshold value generating unit;
a difference operation unit operable to find the multi-valuation error that is the difference between the correction level and the multi-valued level;
an error distribution update unit operable to update an accumulation error by computing an error distribution value for an unprocessed pixel around the target pixel from the multi-valuation error using a distribution coefficient, and add the error distribution value to the accumulation error for a position of the unprocessed pixel, with the accumulation error being stored in the error storing unit;
a distribution coefficient generating unit operable to generate the distribution coefficient used by the error distribution update unit while changing the distribution coefficient in a predetermined cycle; and wherein
at least one of the separation into the first correction accumulation error and the second correction accumulation error, the predetermined data level to be added by the data addition unit and the distribution coefficient is controlled using the processing conditions.

57. The image processing apparatus of any one of claims 42, 46, and 56 wherein the processing conditions determining unit detects an area including a highlight area or a shadow area of at least one color data level, and determines the processing conditions on the basis of the detection results.

58-61. (canceled)

62. The image processing apparatus of any one of claims 39, 42, 46, and 56 wherein the error re-distribution determining unit uses multi-valued data in the separation for other color at the same pixel position.

63-64. (canceled)

65. The image processing apparatus of any one of claims 55 or 56 wherein the predetermined cycle of the distribution coefficient fluctuates according to the processing conditions.

66. The image processing apparatus of any one of claims 55 or 56 wherein the error distribution value of the distribution coefficient fluctuates according to the processing conditions.

67. The image processing apparatus of any one of claims 55 or 56 wherein a filter size of distribution coefficients fluctuates according to the processing conditions.

68. The image processing apparatus of claim 56 wherein the distribution coefficient to be outputted from the distribution coefficient generating unit comes in two kinds, one for the second correction accumulation error and the other for the multi-valuation error.

69. The image processing apparatus of any one of claims 46, 55 and 56 wherein the data addition unit changes the data level to be added according to color.

70. The image processing apparatus of any one of claims 46, 55 and 56 wherein the data addition unit adds the data level to only a specific data level of the original image on the basis of the processing conditions.

71. The image processing apparatus of claim 70 wherein the specific data level is a highlight level that indicates a highlight with regard to at least one color or a shadow level that indicates a shadow with regard to at least one color.

72-75. (canceled)

76. The image processing apparatus of claim 55 or 56 wherein in case a threshold value is generated on the basis of the processing conditions, the threshold value generating unit differentiates a threshold value in one color from a threshold value in another color.

77-152. (canceled)
